(19) United States
(12) Patent Application Publication
(10) Pub. No.: US 2026/0252905 A1
(43) Pub. Date: Aug. 27, 2026

(54) Method And Computing Device For Visualizing Artificial Intelligence Model

(71) Applicant: NOTA, INC., Daejeon (KR)

(72) Inventors: Shinkook CHOI, Daejeon (KR); Sangmin LEE, Daejeon (KR); Cheolbin PARK, Daejeon (KR); Seung Won KIM, Daejeon (KR); Chanha PARK, Daejeon (KR)

(73) Assignee: NOTA, INC., Daejeon (KR)

(21) Appl. No.: 19/540,391

(22) Filed: Feb. 13, 2026

(30) Foreign Application Priority Data
Feb. 20, 2025 (KR) 10-2025-0022595
Oct. 1, 2025 (KR) 10-2025-0143468

(51) Int. Cl. G06N 3/10; G06N 3/042

(52) U.S. Cl. CPC G06N 3/105; G06N 3/042

(57) ABSTRACT

In accordance with an embodiment of the present disclosure, a method for visualizing an artificial intelligence model, performed by a server, is disclosed. The method comprises: receiving an artificial intelligence model from a user terminal, generating an intermediate representation structure by abstracting the artificial intelligence model, converting the intermediate representation structure into structured text data for visualization of the artificial intelligence model using an attribute value included in the intermediate representation structure and transmitting the structured text data to the user terminal so that the user terminal renders a topology of a graph format for the artificial intelligence model.

### CROSS-REFERENCE TO RELATED APPLICATIONS

This application claims priority to the benefit of Korean Patent Application No. 10-2025-0143468 filed in the Korean Intellectual Property Office on 1 October, 2025, and Korean Patent Application No. 10-2025-0022595 filed in the Korean Intellectual Property Office on 20 February, 2025, the entire contents of which are incorporated herein by reference.

### TECHNICAL FIELD

This disclosure relates to artificial intelligence technology, and more particularly, to method and computing device for visualizing artificial intelligence model.

### BACKGROUND ART

With the development of deep learning technology, artificial intelligence models are being utilized in various fields. In particular, the artificial intelligence models show excellent performance in solving complex problems such as computer vision, Natural Language Processing (NLP), and voice recognition. The artificial intelligence model finds an optimal solution for a specific problem through large-scale data learning, and performance and accuracy thereof are continuously improving.

The artificial intelligence models are configured in a form of a computational graph in which numerous operations are performed sequentially or in parallel. In order to represent a series of processes of performing complex operations on input data and deriving a final result, the computational graph expresses respective operations by operators, and these operators may be connected to each other according to a flow of data.

An internal structure of the artificial intelligence model is formed of a combination of complex operators. For example, a Convolutional Neural Network (CNN) may be composed of a combination of a convolution operator, a pooling operator, and an activation function operator, and the like. Operators constituting the artificial intelligence model may process data and transmit a result of processing the data to a next operator according to a connection relationship between the operators. Types of such operators and the connection relationship of the operators may determine an overall operation of the artificial intelligence model.

As a processing speed of a processor increases, the scale of the artificial intelligence model increases and the number of operators increases exponentially, so that it has become very difficult to grasp an overall operation graph structure. Such a large-scale artificial intelligence model includes parameters amounting to billions. A vast amount of computing resources is required to train and perform inference on such a model. Use of computing resources may lead to high operating costs in a cloud environment, and may become a major constraint factor that makes deployment and utilization of the model difficult in an environment having limited resources such as an edge device.

During the development life cycle of the artificial intelligence model, developers may constantly generate new versions to improve performance of an existing model. This process may involve various modification tasks such as a structural change of adding or deleting a specific operator, application of pruning or quantization for model lightweighting, or fine-tuning through a hyperparameter change. Consequently, a plurality of model versions are derived, and clearly identifying and managing structural and functional differences between respective versions may become an important task.

The existing technology related to the artificial intelligence model mainly provides a function of showing a performance index (e.g., accuracy, loss rate) of the artificial intelligence model, visualizing an activation map of a specific operator or a layer, or schematically showing an overall structure of the artificial intelligence model.

Korean patent publication No. KR10-2021-0023401A can be considered prior art.

### SUMMARY OF THE INVENTION

The present disclosure has been devised in response to the above-described background art, and is intended to efficiently provide graph visualization of various artificial intelligence models.

The present disclosure is intended to enhance user experience through a user interface for visualization of the artificial intelligence model.

The technical problems of the present disclosure are not limited to the technical problems mentioned above, and other technical problems not mentioned herein will be clearly understood by those skilled in the art from the following description.

In an embodiment of the present disclosure, a method for visualizing an artificial intelligence model, performed by a server is disclosed. The method comprises: receiving an artificial intelligence model from a user terminal; generating an intermediate representation structure by abstracting the artificial intelligence model; converting the intermediate representation structure into structured text data for visualization of the artificial intelligence model using an attribute value included in the intermediate representation structure; and transmitting the structured text data to the user terminal so that the user terminal renders a topology of a graph format for the artificial intelligence model.

In an embodiment of the present disclosure, the method for visualizing an artificial intelligence model, performed by a server is disclosed. The method comprises: receiving an artificial intelligence model from a user terminal; generating an intermediate representation structure by abstracting the artificial intelligence model; converting the intermediate representation structure into structured text data for visualization of the artificial intelligence model, by changing a tensor included in the intermediate representation structure into an edge connecting nodes using an attribute value included in the intermediate representation structure; and transmitting the structured text data to the user terminal so that the user terminal renders a topology of a graph format for the artificial intelligence model.

In an embodiment of the present disclosure, the converting the intermediate representation structure into the structured text data includes: querying attribute values of the intermediate representation structure to extract an input of the artificial intelligence model, an output of the artificial intelligence model, nodes included in the artificial intelligence model, connection information between the nodes, and metadata included in the artificial intelligence model, from the intermediate representation structure; and generating the structured text data by arranging the extracted information according to a predefined text data structure.

In an embodiment of the present disclosure, the generating the intermediate representation structure includes: generating the intermediate representation structure by abstracting the artificial intelligence model to include framework-independent nodes and tensors representing outputs of the nodes.

In an embodiment of the present disclosure, the converting the intermediate representation structure into the structured text data includes: generating the structured text data by changing a tensor included in the intermediate representation structure into an edge connecting nodes.

In an embodiment of the present disclosure, the intermediate representation structure includes framework-independent nodes, a first tensor representing a parameter of the artificial intelligence model, and a second tensor representing an activation value of the nodes, and the converting the intermediate representation structure into the structured text data includes: creating an edge connecting the nodes using the second tensor and the nodes, and converting the intermediate representation structure into the structured text data using the first tensor, the nodes, and the edge.

In an embodiment of the present disclosure, the structured text data has a text structure in which each of a node representing a basic operation unit, a module representing a set of nodes, an edge connecting nodes, a tensor representing a parameter, and metadata representing quantization-related information is expressed as a pair of a key and a value.

In an embodiment of the present disclosure, the converting the intermediate representation structure into the structured text data includes: extracting node identification information, input tensor identification information, output tensor identification information, and operator type information from each of a plurality of nodes by traversing each of the plurality of nodes included in the intermediate representation structure in a direction from an input to an output of the artificial intelligence model; and generating the structured text data for each of the plurality of nodes by mapping the extracted information with a key of the structured text data using the extracted information as a value.

In an embodiment of the present disclosure, the structured text data is reconfigured to be expressed as nodes and edges connecting the nodes, as a first schema of the structured text data is changed to a second schema for graph rendering, and the topology of the graph format for the artificial intelligence model is rendered based on the reconfigured structured text data.

In an embodiment of the present disclosure, the generating the intermediate representation structure includes: generating a first intermediate representation structure by abstracting the artificial intelligence model; and generating a second intermediate representation structure by modifying some nodes of the first intermediate representation structure, and the converting the intermediate representation structure into the structured text data includes: obtaining a node performance change value for nodes modified in the second intermediate representation structure by performing inference using the first intermediate representation structure and inference using the second intermediate representation structure; and generating the structured text data including the node performance change value from the first intermediate representation structure or the second intermediate representation structure.

In an embodiment of the present disclosure, the method further comprises: in response to receiving a change request for the artificial intelligence model from the user terminal, identifying a target of the change request within the artificial intelligence model using information included in the change request among a node identification number, a node name, a node operator type, an edge identification number, and an edge name, and changing the intermediate representation structure of the artificial intelligence model according to the change request; changing the structured text data based on the changed intermediate representation structure; and transmitting the changed structured text data to the user terminal.

In an embodiment of the present disclosure, a method for visualizing an artificial intelligence model, performed by a user terminal, is disclosed. The method comprises: receiving structured text data corresponding to an artificial intelligence model from a server; extracting nodes and edges from the structured text data; reconfiguring the structured text data by changing a first schema of the structured text data into a second schema for graph rendering using the nodes and the edges; and rendering a topology of a graph format for the artificial intelligence model using the reconfigured structured text data.

In an embodiment of the present disclosure, the method further comprises: in response to receiving a user input including a change request for the rendered topology, re-rendering a changed topology corresponding to the change request without waiting for a response related to the change request from the server; and in response to receiving a change failure response from the server, rolling back the changed topology to a topology before the change.

In an embodiment of the present disclosure, the method further comprises: in response to receiving a user input including a change request for the rendered topology, re-rendering a changed topology corresponding to the change request without waiting for a response related to the change request from the server; and when receiving a change success response from the server, integrating metadata and a tensor included in changed structured text data into at least one of a node and an edge of the re-rendered changed topology using the changed structured text data included in the change success response.

In an embodiment of the present disclosure, the method further comprises: in response to receiving a user input including a change request for the rendered topology, transmitting change information related to the change request to the server and re-rendering a changed topology corresponding to the change request without waiting for a response related to the change request from the server, and wherein a changed artificial intelligence model corresponding to the re-rendered topology is generated, as the change information related to the change request is transmitted to the server.

In an embodiment of the present disclosure, the reconfiguring the structured text data includes: converting the first schema including nodes, edges, tensors, and metadata arranged separately into the second schema expressed by nodes and edges, by integrating tensors and metadata in the structured text data into at least one of nodes and edges.

In an embodiment of the present disclosure, the receiving the structured text data includes receiving first structured text data corresponding to a first artificial intelligence model and second structured text data corresponding to a second artificial intelligence model, and the rendering the topology of the graph format includes: identifying differential nodes representing a difference between a first topology of the first artificial intelligence model and a second topology of the second artificial intelligence model using identification information of nodes included in each of the first structured text data and the second structured text data; and re-rendering at least one topology of the first topology and the second topology using the differential nodes, wherein as a predefined visual attribute is applied to the differential nodes, the differential nodes are re-rendered to be visually distinguished from common nodes commonly existing in the first topology and the second topology.

In an embodiment of the present disclosure, the rendering the topology of the graph format for the artificial intelligence model includes: determining a display color corresponding to the node based on a node performance value or a node performance change value internalized in the node within the topology; and rendering the node within the topology in the determined display color.

In an embodiment of the present disclosure, the display color corresponding to the node is determined such that the node performance value or the node performance change value has a positive correlation with saturation or luminance on a color gradient.

In an embodiment of the present disclosure, the rendering the topology of the graph format for the artificial intelligence model includes: rendering the topology such that a first node and a second node are visually integrated by applying a common visual attribute to the first node and the second node belonging to a layer corresponding to each other within the topology based on layer identification information internalized in nodes within the topology; or rendering the topology such that edges of the first node and the second node are visually integrated by applying a common visual attribute to edges connected to each of the first node and the second node belonging to a layer corresponding to each other within the topology based on layer identification information internalized in nodes within the topology.

In an embodiment of the present disclosure, the method further comprises: receiving a user input including a change request for the rendered topology; determining a type of the change request based on the user input; and determining whether to interact with the server for re-rendering of the topology based on the type of the change request.

In an embodiment of the present disclosure, the determining whether to interact with the server includes: re-rendering a topology in which locations of the node and the edge are changed according to the change request without interaction with the server, when the type of the change request is determined as a first type in which nodes and edges are not changed, determining transmission information to be transmitted to the server based on an operator corresponding to a node to be created, when the type of the change request is determined as a second type including creation of a node, transmitting node identification information corresponding to a node to be deleted to the server, when the type of the change request is determined as a third type including deletion of a node, and transmitting identification information on a start node and an end node corresponding to an edge to be created to the server, when the type of the change request is determined as a fourth type including creation of an edge.

In an embodiment of the present disclosure, a server for visualizing an artificial intelligence model is disclosed. The server comprises: at least one processor, wherein the processor performs: receiving an artificial intelligence model from a user terminal; generating an intermediate representation structure by abstracting the artificial intelligence model; converting the intermediate representation structure into structured text data for visualization of the artificial intelligence model using an attribute value included in the intermediate representation structure; and transmitting the structured text data to the user terminal so that the user terminal renders a topology of a graph format for the artificial intelligence model.

In an embodiment of the present disclosure, a user terminal for visualizing an artificial intelligence model is disclosed. The user terminal comprises at least one processor, wherein the processor performs: receiving structured text data corresponding to an artificial intelligence model from a server; extracting nodes and edges from the structured text data; reconfiguring the structured text data by changing a first schema of the structured text data into a second schema for graph rendering using the nodes and the edges; and rendering a topology of a graph format for the artificial intelligence model using the reconfigured structured text data.

In an embodiment of the present disclosure, a method for providing a user interface (UI) for visualization of an artificial intelligence model, performed by a user terminal is disclosed. The method comprises: receiving an artificial intelligence model to be a target of visualization; rendering, on the user interface, a topology of a graph format that visually represents an abstracted structure of the artificial intelligence model, wherein the graph format includes a node representing an operation unit of the artificial intelligence model and an edge connecting nodes; displaying, on the user interface, a topology change option object having a correlation with a selected area when a user selection input selecting an area on the topology of the user interface is obtained; and re-rendering a topology in which a change is reflected, on the user interface, based on a user change input requesting the change on the topology change option object.

In an embodiment of the present disclosure, a change option displayed on the topology change option object is determined differently based on a location of the selected area.

In an embodiment of the present disclosure, when the selected area corresponds to a node area occupied by a node on the topology, the topology change option object indicates movement of a node object related to the node area, deletion of the node object, and creation of an edge object related to the node object, when the selected area corresponds to an edge area occupied by an edge on the topology, the topology change option object indicates deletion of an edge object related to the edge area, and when the selected area corresponds to a residual area not occupied by both the node and the edge on the topology, the topology change option object indicates creation of a new node object.

In an embodiment of the present disclosure, when the user change input changing a node is obtained on the topology change option object, a target node object to be a target of the change, a target edge object connecting the target node object, and a neighbor node object connected to the target node object through the target edge are recognized together as targets of a topology change.

In an embodiment of the present disclosure, the re-rendering a topology in which a change is reflected, on the user interface includes: displaying a new node object at a location related to the selected area and displaying a new node option object requesting an additional input related to the new node object, when the user change input creating a new node is obtained on the topology change option object; and re-rendering, on the user interface, a topology changed to include the new node object and/or at least one target edge object connecting the new node object with neighbor node objects of the new node object, in response to receiving the additional input requesting creation of a target edge object related to the new node object on the new node option object.

In an embodiment of the present disclosure, the re-rendering, on the user interface, the topology changed to include the new node object and/or the target edge objects connecting the new node object with the neighbor node objects includes: re-rendering, on the user interface, a highlighted topology such that the new node object and the neighbor node objects are distinguished from other node objects on the changed topology.

In an embodiment of the present disclosure, the user selection input includes a first selection input and a second selection input different from the first selection input, wherein when the user selection input is the first selection input, the topology change option object is displayed on the user interface, and wherein when the user selection input is the second selection input, at least one of an attribute and metadata of a node corresponding to the second selection input is displayed.

In an embodiment of the present disclosure, the re-rendering a topology in which a change is reflected, on the user interface includes: deleting a node object related to the selected area and replacing first edge objects related to the deleted node object with a second edge object connecting neighbor node objects related to the deleted node object, when the user change input deleting a node object is obtained on the topology change option object; and re-rendering, on the user interface, a topology in which the deleted node object and the second edge object are reflected.

In an embodiment of the present disclosure, the re-rendering a topology in which a change is reflected, on the user interface includes: deleting an edge object related to the selected area and moving at least one of node objects and edge objects on the topology based on a location of the deleted edge object, when the user change input deleting an edge object is obtained on the topology change option object; and re-rendering, on the user interface, a topology in which the deleted edge object and the moved object are reflected.

In an embodiment of the present disclosure, the user interface includes: a first area displaying the topology of the graph format; a second area including a search input object for receiving a search input within the topology, a display option object for determining a display manner of components within the topology, and an exposure option object for determining exposure or hiding of the components within the topology; and a third area displaying at least one of an attribute and metadata internalized in a node within the topology and allowing a modification input for at least one of the attribute and the metadata.

In an embodiment of the present disclosure, the user interface displays a display manner selection window for determining at least one of a first node display manner distinguishably displaying nodes according to structural features of the nodes within the topology and a second node display manner distinguishably displaying the nodes according to performance of the nodes within the topology, when a user input on a display manner selection activation object for determining a display manner of the nodes within the topology is received.

In an embodiment of the present disclosure, the method further comprises: receiving user input information identifying hardware on which the artificial intelligence model is to be executed; and displaying an unsupported node object not supported by the hardware or an inefficient node object causing performance degradation when executed on the hardware, among node objects included in the topology, on the topology to be distinguishable from other node objects.

In an embodiment of the present disclosure, the method further comprises: receiving a user input selecting the unsupported node object or the inefficient node object; displaying a list of replaceable candidate nodes recommended to replace the unsupported node object or the inefficient node object; and re-rendering a topology in which the unsupported node object or the inefficient node object is changed to a replacement node object, in response to receiving a user input determining a replacement node in the list of replaceable candidate nodes, and wherein, as change information including the unsupported node object or the inefficient node object, and the replacement node object is transmitted to a server, the artificial intelligence model is converted in a manner that an unsupported node or an inefficient node is changed to the replacement node.

In an embodiment of the present disclosure, the list of replaceable candidate nodes displays: identification information of a replaceable candidate node; a similarity between an original node to be a target of replacement and the replaceable candidate node; and performance information of the replaceable candidate node.

In an embodiment of the present disclosure, the method further comprises: re-rendering the topology such that the selected node and a plurality of sub-nodes constituting the node are displayed together in a state where a connection structure between the selected node and a neighbor node is maintained, in response to a user input selecting an area of a node in the rendered topology on the user interface.

In an embodiment of the present disclosure, the re-rendering a topology in which a change is reflected, on the user interface includes: determining whether to interact with a server for re-rendering of the topology based on a change type determined according to the user change input.

In an embodiment of the present disclosure, a non-transitory computer-readable storage medium storing a computer program is disclosed. The computer program, when executed by a user terminal, causes the user terminal to perform a method for providing a user interface (UI) for visualization of an artificial intelligence model. The method comprises: receiving an artificial intelligence model to be a target of visualization; rendering, on the user interface, a topology of a graph format that visually represents an abstracted structure of the artificial intelligence model, wherein the graph format includes a node representing an operation unit of the artificial intelligence model and an edge connecting nodes; displaying, on the user interface, a topology change option object having a correlation with a selected area when a user selection input selecting an area on the topology of the user interface is obtained; and re-rendering a topology in which a change is reflected, on the user interface, based on a user change input requesting the change on the topology change option object.

In an embodiment of the present disclosure, user terminal providing a user interface (UI) for visualization of an artificial intelligence model is disclosed. The user terminal comprises: at least one processor, wherein the processor performs: receiving an artificial intelligence model to be a target of visualization; rendering, on the user interface, a topology of a graph format that visually represents an abstracted structure of the artificial intelligence model, wherein the graph format includes a node representing an operation unit of the artificial intelligence model and an edge connecting nodes; displaying, on the user interface, a topology change option object having a correlation with a selected area when a user selection input selecting an area on the topology of the user interface is obtained; and re-rendering a topology in which a change is reflected, on the user interface, based on a user change input requesting the change on the topology change option object.

In an embodiment of the present disclosure, method for providing a user interface (UI) for visualization of an artificial intelligence model, performed by a user terminal, is disclosed. The method comprises: receiving a first artificial intelligence model and a second artificial intelligence model to be targets of visualization; generating a first topology of a graph format that visually represents an abstracted structure of the first artificial intelligence model and generating a second topology of a graph format that visually represents an abstracted structure of the second artificial intelligence model, wherein the graph format includes a node representing an operation unit of an artificial intelligence model and an edge connecting nodes; and rendering the first topology and the second topology to be visually comparable on the user interface by rendering the first topology on a first area of the user interface and rendering the second topology on a second area of the user interface.

In an embodiment of the present disclosure, a method for providing a user interface (UI) for visualization of an artificial intelligence model, performed by a user terminal is disclosed. The method comprises: receiving a first artificial intelligence model to be a target of visualization; generating a second artificial intelligence model derived from the first artificial intelligence model; generating a first topology of a graph format that visually represents an abstracted structure of the first artificial intelligence model and generating a second topology of a graph format that visually represents an abstracted structure of the second artificial intelligence model, wherein the graph format includes a node representing an operation unit of an artificial intelligence model and an edge connecting nodes; and rendering the first topology and the second topology to be visually comparable on the user interface by rendering the first topology on a first area of the user interface and rendering the second topology on a second area of the user interface, wherein the rendering the first topology and the second topology to be visually comparable on the user interface includes: identifying a differential node representing a difference between the first artificial intelligence model and the second artificial intelligence model; and rendering the first topology and the second topology to be visually comparable on the user interface in a manner that the differential node is displayed to be visually distinguished from common nodes commonly existing in the first topology and the second topology by applying a predefined visual attribute to the differential node.

In an embodiment of the present disclosure, wherein the rendering the first topology and the second topology to be visually comparable on the user interface includes: generating a virtual model structure by traversing the first artificial intelligence model and/or the second artificial intelligence model and reconfiguring a differential node representing a difference between the first artificial intelligence model and the second artificial intelligence model and a connection relationship of the differential node.

In an embodiment of the present disclosure, the rendering the first topology and the second topology to be visually comparable on the user interface includes: identifying a differential node representing a difference between the first artificial intelligence model and the second artificial intelligence model by comparing the first topology of the first artificial intelligence model and the second topology of the second artificial intelligence model; and rendering the first topology and the second topology to be visually comparable on the user interface in a manner that the differential node is displayed to be visually distinguished from common nodes commonly existing in the first topology and the second topology by applying a predefined visual attribute to the differential node.

In an embodiment of the present disclosure, wherein the identifying the differential node includes: identifying a first differential node existing in the first artificial intelligence model but deleted in the second artificial intelligence model and a second differential node not existing in the first artificial intelligence model but added in the second artificial intelligence model, by comparing the first topology of the first artificial intelligence model and the second topology of the second artificial intelligence model.

In an embodiment of the present disclosure, the rendering the first topology and the second topology to be visually comparable on the user interface includes: identifying a first differential node existing in the first artificial intelligence model but deleted in the second artificial intelligence model and a second differential node not existing in the first artificial intelligence model but added in the second artificial intelligence model, by comparing the first topology of the first artificial intelligence model and the second topology of the second artificial intelligence model; and rendering the first topology and the second topology to be visually comparable on the user interface in a manner of applying a first visual attribute to the first differential node, applying a second visual attribute to the second differential node, and applying a third visual attribute to a common node commonly included in the first artificial intelligence model and the second artificial intelligence model, wherein at least one of a color and a shape is different among the first visual attribute, the second visual attribute, and the third visual attribute.

In an embodiment of the present disclosure, wherein the identifying the differential node includes: generating a comparison result between identification information of nodes included in the first artificial intelligence model and identification information of nodes included in the second artificial intelligence model by traversing the nodes of the first artificial intelligence model and the nodes of the second artificial intelligence model; and identifying the differential node representing a difference between the first artificial intelligence model and the second artificial intelligence model based on the comparison result.

In an embodiment of the present disclosure, the rendering the first topology and the second topology to be visually comparable on the user interface includes: generating a comparison result between identification information of nodes included in the first artificial intelligence model and identification information of nodes included in the second artificial intelligence model by traversing the nodes of the first artificial intelligence model and the nodes of the second artificial intelligence model; identifying a differential node representing a difference between the first artificial intelligence model and the second artificial intelligence model based on the comparison result; and reconfiguring at least one of the first topology and the second topology using the differential node.

In an embodiment of the present disclosure, the second artificial intelligence model of the second topology is a derived model generated based on a user change input for the first topology of the first artificial intelligence model which is an original model on the user interface, and the rendering the first topology and the second topology to be visually comparable on the user interface includes: reconfiguring the second topology by adding a first node deleted due to the user change input and a first edge related to the first node onto the second topology; and rendering the reconfigured second topology and the first topology to be visually comparable on the user interface by applying a visual attribute for identifying deletion to the first node.

In an embodiment of the present disclosure, the rendering the reconfigured second topology and the first topology to be visually comparable on the user interface includes: rendering the reconfigured second topology and the first topology to be visually comparable on the user interface in a manner that a display location of the first node on the first topology corresponds to a display location of the first node on the reconfigured second topology and a visual attribute of the first node on the first topology and a visual attribute of the first node on the reconfigured second topology are displayed to be different from each other.

In an embodiment of the present disclosure, the second artificial intelligence model of the second topology is a derived model generated based on a user change input for the first topology of the first artificial intelligence model which is an original model on the user interface, and the rendering the first topology and the second topology to be visually comparable on the user interface includes: reconfiguring the second topology by adding a first node deleted due to the user change input and a first edge related to the first node onto the second topology; and rendering the reconfigured second topology and the first topology to be visually comparable on the user interface by applying a first visual attribute for identifying deletion to the first node, applying a second visual attribute for identifying addition to a second node added due to the user change input, and applying a third visual attribute to a common node commonly existing in the first artificial intelligence model and the second artificial intelligence model, wherein at least one of a color and a shape is different among the first visual attribute, the second visual attribute, and the third visual attribute.

In an embodiment of the present disclosure, the rendering the first topology and the second topology to be visually comparable on the user interface includes: a first comparison step of determining whether a corresponding node exists in the first artificial intelligence model for each of nodes of the second artificial intelligence model by traversing the nodes of the second artificial intelligence model; adding a common node, for which the corresponding node of the first artificial intelligence model exists among the nodes of the second artificial intelligence model, to a virtual model structure based on a result of the first comparison step, and adding a second differential node, for which the corresponding node of the first artificial intelligence model does not exist among the nodes of the second artificial intelligence model, with a second visual attribute to the virtual model structure; a second comparison step of identifying a first differential node, for which a corresponding node does not exist in the second artificial intelligence model among the nodes of the first artificial intelligence model, by traversing the nodes of the first artificial intelligence model; identifying a neighbor common node connected to an output of the identified first differential node in the first artificial intelligence model, adding the first differential node with a first visual attribute to a location adjacent to the neighbor common node in the virtual model structure so as to maintain a connection relationship of the first topology, and generating a differential edge connecting the first differential node and the neighbor common node in the virtual model structure; and rendering the first topology and the second topology to be visually comparable on the user interface based on a completed virtual model structure.

In an embodiment of the present disclosure, the second artificial intelligence model of the second topology is a derived model generated based on a user change input for the first topology of the first artificial intelligence model which is an original model on the user interface, and the rendering the first topology and the second topology to be visually comparable on the user interface includes: rendering the first topology and the second topology to be visually comparable on the user interface in a manner that a first node to which a first visual attribute for identifying deletion is applied is displayed on the first topology by applying the first visual attribute to the first node deleted due to the user change input, and a second node to which a second visual attribute for identifying addition is applied is displayed on the second topology by applying the second visual attribute to the second node added due to the user change input.

In an embodiment of the present disclosure, the method further comprises: displaying a topology change option object having a correlation with a selected area on the user interface, when a user selection input selecting an area on the first topology rendered on the user interface is obtained; reconfiguring the first topology so that a change is reflected, based on a user change input requesting change on the topology change option object; determining a node to change a visual attribute in the second topology by comparing the reconfigured first topology and the second topology; and re-rendering the reconfigured first topology and the second topology in which the change of the visual attribute is reflected, on the user interface.

In an embodiment of the present disclosure, the method further comprises: transmitting change information related to the user change input to a server, wherein a changed first artificial intelligence model corresponding to the re-rendered first topology is generated, as the change information related to the user change input is transmitted to the server.

In an embodiment of the present disclosure, the user interface outputs one scroll operation among a first scroll operation scrolling the first topology, a second scroll operation scrolling the second topology, and a third scroll operation scrolling both the first topology and the second topology, based on a start location of a user scroll input on the user interface; or the user interface outputs one scroll operation among the first scroll operation scrolling the first topology, the second scroll operation scrolling the second topology, and the third scroll operation scrolling both the first topology and the second topology, based on a user selection input on whether to bind topologies on the user interface.

In an embodiment of the present disclosure, the user interface: outputs a first scroll operation scrolling the first topology rendered on the first area when detecting that a user scroll input starts on the first area of the user interface, outputs a first scroll operation scrolling the second topology rendered on the second area when detecting that a user scroll input starts on the second area of the user interface, and outputs a third scroll operation scrolling together the first topology rendered on the first area and the second topology rendered on the second area when detecting that a user scroll input starts on a third area between the first area and the second area of the user interface.

In an embodiment of the present disclosure, the user interface: outputs a fourth scroll operation automatically scrolling the second topology on the second area such that a target node corresponding to a third node among nodes of the second topology is displayed at one location of the second area, in response to a user selection input selecting the third node on the first topology of the user interface.

In an embodiment of the present disclosure, the user interface includes: a first area displaying the first topology; a second area displaying the second topology; and a search area including a search input object for receiving a search input within the topologies, and wherein the user interface performs an automatic scroll operation such that each of a node of the first topology and a node of the second topology corresponding to a search result according to the search input is displayed to be highlighted at predefined locations of the first area and the second area.

In an embodiment of the present disclosure, the method further comprises: determining a rendering manner of the first topology and the second topology based on one view mode selected by a user among a plurality of predefined view modes, wherein the rendering the first topology and the second topology to be visually comparable on the user interface includes: when the rendering manner is determined as a first view mode, displaying a first differential node existing in the first artificial intelligence model but not existing in the second artificial intelligence model with a first visual attribute on the first topology, and displaying a second differential node not existing in the first artificial intelligence model but existing in the second artificial intelligence model with a second visual attribute on the second topology; when the rendering manner is determined as a second view mode, displaying the first differential node with the first visual attribute and the second differential node with the second visual attribute on the second topology such that differential nodes are visualized to be integrated on the second topology; and when the rendering manner is determined as a third view mode, matching visual layouts of common nodes by readjusting at least one node location of at least one topology of the first topology and the second topology such that the common nodes of the first topology and the second topology are arranged at locations corresponding to each other.

In an embodiment of the present disclosure, the second artificial intelligence model is a derived model in which a part of the first artificial intelligence model is changed, and the method further comprises: displaying at least one of a similarity between the first artificial intelligence model and the second artificial intelligence model, the number of added nodes, and the number of deleted nodes based on a result of comparing node identifiers and edge identifiers of the first artificial intelligence model with node identifiers and edge identifiers of the second artificial intelligence model.

In an embodiment of the present disclosure, the differential node includes at least one of: a node representing a structural difference between the first artificial intelligence model and the second artificial intelligence model; and a node having a different attribute among nodes corresponding to each other in the first artificial intelligence model and the second artificial intelligence model. The differential node is identified by considering a history modified in a process of generating the second artificial intelligence model.

In an embodiment of the present disclosure, a non-transitory computer-readable storage medium storing a computer program is disclosed. The computer program, when executed by a user terminal, causes the user terminal to perform a method for providing a user interface (UI) for visualization of an artificial intelligence model, the method comprising: receiving a first artificial intelligence model and a second artificial intelligence model to be targets of visualization; generating a first topology of a graph format that visually represents an abstracted structure of the first artificial intelligence model and generating a second topology of a graph format that visually represents an abstracted structure of the second artificial intelligence model, wherein the graph format includes a node representing an operation unit of an artificial intelligence model and an edge connecting nodes; and rendering the first topology and the second topology to be visually comparable on the user interface by rendering the first topology on a first area of the user interface and rendering the second topology on a second area of the user interface.

In an embodiment of the present disclosure, a user terminal providing a user interface (UI) for visualization of an artificial intelligence model is disclosed. The user terminal comprises: at least one processor, wherein the processor performs: receiving a first artificial intelligence model and a second artificial intelligence model to be targets of visualization; generating a first topology of a graph format that visually represents an abstracted structure of the first artificial intelligence model and generating a second topology of a graph format that visually represents an abstracted structure of the second artificial intelligence model, wherein the graph format includes a node representing an operation unit of an artificial intelligence model and an edge connecting nodes; and rendering the first topology and the second topology to be visually comparable on the user interface by rendering the first topology on a first area of the user interface and rendering the second topology on a second area of the user interface.

In an embodiment of the present disclosure, a non-transitory computer-readable storage medium storing a computer program is disclosed. The computer program, when executed by a user terminal, causes the user terminal to perform a method for providing a user interface (UI) for visualization of an artificial intelligence model, the method comprising: receiving a first artificial intelligence model to be a target of visualization; generating a second artificial intelligence model derived from the first artificial intelligence model; generating a first topology of a graph format that visually represents an abstracted structure of the first artificial intelligence model and generating a second topology of a graph format that visually represents an abstracted structure of the second artificial intelligence model, wherein the graph format includes a node representing an operation unit of an artificial intelligence model and an edge connecting nodes; and rendering the first topology and the second topology to be visually comparable on the user interface by rendering the first topology on a first area of the user interface and rendering the second topology on a second area of the user interface. Wherein the rendering the first topology and the second topology to be visually comparable on the user interface includes: identifying a differential node representing a difference between the first artificial intelligence model and the second artificial intelligence model; and rendering the first topology and the second topology to be visually comparable on the user interface in a manner that the differential node is displayed to be visually distinguished from common nodes commonly existing in the first topology and the second topology by applying a predefined visual attribute to the differential node.

In an embodiment of the present disclosure, a user terminal providing a user interface (UI) for visualization of an artificial intelligence model is disclosed. The user terminal comprises at least one processor, wherein the processor performs: receiving a first artificial intelligence model to be a target of visualization; generating a second artificial intelligence model derived from the first artificial intelligence model; generating a first topology of a graph format that visually represents an abstracted structure of the first artificial intelligence model and generating a second topology of a graph format that visually represents an abstracted structure of the second artificial intelligence model, wherein the graph format includes a node representing an operation unit of an artificial intelligence model and an edge connecting nodes; and rendering the first topology and the second topology to be visually comparable on the user interface by rendering the first topology on a first area of the user interface and rendering the second topology on a second area of the user interface. Wherein the rendering the first topology and the second topology to be visually comparable on the user interface includes: identifying a differential node representing a difference between the first artificial intelligence model and the second artificial intelligence model; and rendering the first topology and the second topology to be visually comparable on the user interface in a manner that the differential node is displayed to be visually distinguished from common nodes commonly existing in the first topology and the second topology by applying a predefined visual attribute to the differential node.

A technique according to an embodiment of the present disclosure may efficiently provide graph visualization of various artificial intelligence models.

The present disclosure may enhance user experience through a user interface (UI) for visualization of the artificial intelligence model.

### BRIEF DESCRIPTION OF THE DRAWINGS

Various aspects will now be described with reference to the drawings, wherein like reference numerals are used to refer to like elements throughout. In the following description, for purposes of explanation, numerous specific details are set forth in order to provide a thorough understanding of one or more aspects. However, it will be evident that such aspect(s) may be practiced without these specific details. In other instances, well-known structures and devices are shown in block diagram form to facilitate describing one or more aspects.

FIG. 1 schematically illustrates a block configuration diagram of a computing device according to an embodiment of the present disclosure.

FIG. 2 illustrates an exemplary structure of an artificial intelligence model according to an embodiment of the present disclosure.

FIG. 3 illustrates an exemplary method for visualization of an artificial intelligence model according to an embodiment of the present disclosure.

FIG. 4 illustrates an exemplary method for visualization of an artificial intelligence model according to an embodiment of the present disclosure.

FIG. 5 illustrates an exemplary method for visualization of an artificial intelligence model according to an embodiment of the present disclosure.

FIG. 6 illustrates an exemplary method for visualization of an artificial intelligence model according to an embodiment of the present disclosure.

FIG. 7 exemplarily illustrates topology re-rendering of a user interface according to a user change input according to an embodiment of the present disclosure.

FIG. 8 exemplarily illustrates topology re-rendering of a user interface according to a user change input according to an embodiment of the present disclosure.

FIG. 9 exemplarily illustrates topology re-rendering of a user interface according to a user change input according to an embodiment of the present disclosure.

FIG. 10 illustrates an exemplary method for providing a user interface for visualization of an artificial intelligence model according to an embodiment of the present disclosure.

FIG. 11 illustrates an exemplary user interface for comparing a plurality of artificial intelligence models according to an embodiment of the present disclosure.

FIG. 12 illustrates an exemplary user interface providing a comparison result of a plurality of artificial intelligence models according to an embodiment of the present disclosure.

FIG. 13 illustrates an exemplary user interface providing a comparison result of a plurality of artificial intelligence models according to an embodiment of the present disclosure.

FIG. 14 illustrates an exemplary user interface in which a sub-node for a node of an artificial intelligence model is displayed according to an embodiment of the present disclosure.

FIG. 15 exemplarily illustrates a user interface for visualization of an artificial intelligence model according to an embodiment of the present disclosure.

FIG. 16 exemplarily illustrates a user interface for determining a display manner related to a node of an artificial intelligence model according to an embodiment of the present disclosure.

FIG. 17 exemplarily illustrates a user interface for determining a display manner related to a node of an artificial intelligence model according to an embodiment of the present disclosure.

FIG. 18 is a diagram illustrated for understanding a color change related to a node of an artificial intelligence model according to an embodiment of the present disclosure.

FIG. 19 exemplarily illustrates a user interface visualizing an artificial intelligence model using layer identification information for nodes of the artificial intelligence model according to an embodiment of the present disclosure.

FIG. 20 exemplarily illustrates a user interface for converting an operator using platform information on which an artificial intelligence model is to be executed according to an embodiment of the present disclosure.

FIG. 21 exemplarily illustrates a user interface for converting an operator using platform information on which an artificial intelligence model is to be executed according to an embodiment of the present disclosure.

FIG. 22 illustrates an exemplary user interface rendering topologies in a comparable manner according to a view mode according to an embodiment of the present disclosure.

FIG. 23 presents an exemplary methodology for performing comparison rendering according to an embodiment of the present disclosure.

FIG. 24 presents an exemplary methodology for performing comparison rendering according to an embodiment of the present disclosure.

FIG. 25 is a schematic diagram of an exemplary computing environment of a computing device according to an embodiment of the present disclosure.

### DETAILED DESCRIPTION

Various exemplary embodiments will now be described with reference to drawings. In this specification, various descriptions are presented to provide appreciation of the present disclosure. However, it will be apparent that these embodiments may be implemented without the specific descriptions set forth herein.

In this specification, a "Component" refers to a computer-related entity, hardware, firmware, software, and a combination of the software and the hardware, or execution of the software. For example, the component may be a processing process executed on a processor, the processor, an object, an execution thread, a program, and/or a computer, but is not limited thereto. One or more components may reside within the processor and/or a thread of execution. The component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “or” and “and/or” used in this specification designates and includes all available combinations of one or more items among enumerated related items.

Further, it should be appreciated that the term "comprise / include" and/or "comprising / including" means presence of corresponding features and/or components. However, it should be appreciated that the term "comprises / includes" and/or "comprising / including" means that presence or addition of one or more other features, components, and/or a group thereof is not excluded. Further, when not separately specified or it is not clear in terms of the context that a singular form is indicated, it should be construed that the singular form generally means “one or more” in this specification and the claims.

And, the term “at least one of A or B” should be interpreted to mean “a case including only A”, “a case including only B”, and “a case in which A and B are combined”.

In the present disclosure terms represented by N-th such as first, second, or third are used for distinguishing at least one entity. For example, entities expressed as first and second may be the same as each other or different from each other.

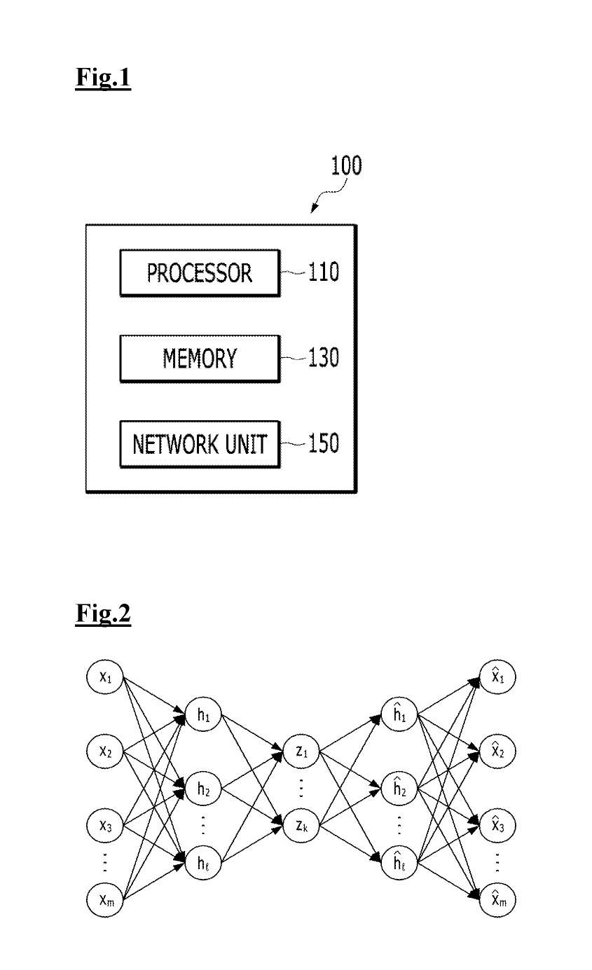

In the present disclosure, an artificial intelligence model may refer to a program or a set of functions designed as a mathematical and statistical structure to learn patterns from data and to automatically perform tasks such as prediction, classification, generation, and/or inference for a given input. The artificial intelligence model may be constructed by modeling a relationship between input and output in the form of a function. Operators and layers of the artificial intelligence model in the present disclosure may be used interchangeably according to an implementation aspect. Specific examples of the artificial intelligence model will be described later with reference to FIG. 2.

In the present disclosure, an intermediate representation structure may refer to a standardized representation format used at an intermediate stage for optimizing a computation graph or structure of a model for a specific execution environment or platform. In the present disclosure, the intermediate representation structure may refer to a temporary data structure for an artificial intelligence model, used to visualize and/or optimize the artificial intelligence model. In the present disclosure, the intermediate representation structure may refer to a data representation format of an intermediate stage generated as a result of abstraction that extracts and processes key features of the artificial intelligence model. The intermediate representation structure may include attribute values for determining an input, an output, a node, a connection relationship of nodes, and metadata of the artificial intelligence model.

For example, the intermediate representation structure may include a plurality of nodes and edges connecting the nodes. The intermediate representation structure of the present disclosure may include a graph corresponding to an artificial intelligence model, modules representing layers (or operators) defined dependently on a framework, and nodes representing atomic operators as minimum units constituting the modules. In an embodiment, the intermediate representation structure may be configured such that all nodes within the intermediate representation structure (or constituting the artificial intelligence model) are included in any one module. In an embodiment, the intermediate representation structure may be configured such that all nodes within the intermediate representation structure are included in one or more modules. In an embodiment, the intermediate representation structure in the present disclosure may take a form of a graph. For example, the graph related to the intermediate representation structure in the present disclosure may refer to a result of abstracting the artificial intelligence model based on a connection relationship of modules, nodes, and tensors. The intermediate representation structure of the present disclosure may refer to an intermediate structure or a temporary structure for modification to enable execution of the artificial intelligence model in various frameworks and/or various platforms. The intermediate representation structure of the present disclosure may include a graph structure. The intermediate representation structure may be generated such that nodes independent of the framework and modules, which are sets of nodes, have a hierarchical structure or dependency relationship. The intermediate representation structure of the present disclosure may be configured to include nodes corresponding to framework-independent atomic operators, modules dependent on the framework, and tensors connecting nodes and/or connecting modules. A tensor is a data structure used to represent inputs, outputs, weights, intermediate calculation values, and/or quantization values of an artificial intelligence model. For example, a tensor may have an array structure in a multidimensional form. For example, a tensor may store reference information for transformation or optimization of an artificial intelligence model. For example, a tensor may be stored in an edge connecting nodes, and/or may be located in an edge connecting modules. For example, a tensor may be located in an input to a module or a node, and/or may be located in an output from a module or a node.

In the present disclosure, the intermediate representation structure may refer to a logical structure for expressing a function of the artificial intelligence model. The intermediate representation structure in the present disclosure may include a combination of nodes corresponding to atomic operators of a minimum unit universally applicable to a plurality of frameworks. For example, when frameworks of artificial intelligence models performing the same operation are different, different modules may be included in the intermediate representation structure, and even if the frameworks of the artificial intelligence models performing the same operation are different, the same node may be included in the intermediate representation structure.

Abstraction in the present disclosure may be used to intend a manner of expressing an internal configuration of the artificial intelligence model as a more simplified intermediate representation structure. For example, abstraction may refer to a manner for expressing the artificial intelligence model as a concept of a logical architecture from a physical or code-based entity. For example, abstraction may include conversion of the artificial intelligence model into an intermediate representation structure formed of nodes (e.g., only nodes) or a combination of nodes and edges, conversion into an intermediate representation structure formed of operators, and/or conversion into a hierarchical intermediate representation structure of nodes and modules. As a result of abstraction on the received artificial intelligence model, the intermediate representation structure in the present disclosure may be generated.

Topology in the present disclosure may refer to a data structure defining an arrangement and a connection relationship of nodes constituting a structure of the artificial intelligence model. For example, the topology may express how nodes and edges of the artificial intelligence model are configured in a graph format.

Performance of the artificial intelligence model in the present disclosure may encompass accuracy, efficiency, resource usage, inference speed, a degree of model lightweighting, latency in inference, and a Signal-to-Noise Ratio (SNR) of the artificial intelligence model. In an embodiment, the performance may encompass performance of the model itself and/or performance when the model is executed on a platform (e.g., memory usage, latency, model accuracy, and/or fan usage).

In an embodiment, a performance change value of the artificial intelligence model may represent a degree of change in performance for the artificial intelligence model or a node within the model as a result of model conversion, model change, and/or model comparison. The SNR may be an example of the performance change value. For example, the SNR related to the performance change may be used when comparing before and after change or optimization of the artificial intelligence model.

In the present disclosure, a platform may include hardware on which an artificial intelligence model is executed and/or a compiler that connects the artificial intelligence model to the hardware. In one embodiment, the platform may include hardware. In one embodiment, the platform may include a compiler. In one embodiment, the platform may represent a combination of hardware and compiler. In one embodiment, the platform may be referred to as an execution environment, a deployment target, a system configuration, a runtime environment, and/or an inference platform in which the artificial intelligence model can be executed.

The user interface in the present disclosure may represent a Graphical User Interface (GUI).

FIG. 1 schematically illustrates a block configuration diagram of a computing device according to an embodiment of the present disclosure.

A configuration of the computing device 100 illustrated in FIG. 1 is only an example illustrated through simplification. In an exemplary embodiment of the present disclosure, the computing device 100 may include other components for performing a computing configuration of the computing device 100 and only some of the disclosed components may constitute the computing device 100.

The computing device 100 according to some embodiments of the present disclosure may be a device for visualizing an artificial intelligence model. The computing device 100 may be used in a sense encompassing a server and a user terminal.

A server according to an embodiment of the present disclosure may convert an artificial intelligence model into an intermediate representation structure by abstracting the artificial intelligence model, and/or perform operations for various conversions (e.g., performance conversion) on the intermediate representation structure. A server according to some embodiments of the present disclosure may be a device for converting an artificial intelligence model for performance optimization of the artificial intelligence model. The server may communicate with a user terminal for visualization of the artificial intelligence model, and for example, the server may generate structured text data and transmit the structured text data to the user terminal so that the user terminal renders a topology of a graph format for the artificial intelligence model. The server may include, for example, any type of computer system or computer device such as a microprocessor, a mainframe computer, a digital processor, a portable device, a device controller, a web server, an application server, or a database server, and the like.

In an embodiment, the user terminal may correspond to a user device that receives data resources generated in the server, performs additional information processing, and provides a user interface.

The user device may include, but is not limited to, a personal computer, notebook, mobile terminal, smart phone, tablet PC, or other device owned by the user.

The computing device 100 may include a processor 110, a memory 130, and a network unit 150.

The processor 110 may be composed of one or more cores and may include a processor for performing operations related to data processing, such as a central processing unit (CPU), a general-purpose graphics processing unit (GPGPU), a digital signal processor (DSP), a tensor processing unit (TPU), or a neural processing unit (NPU). The processor 110 may perform data processing according to an embodiment of the present disclosure, by reading a computer program stored in the memory 130. In other words, a computer program stored in a computer-readable storage medium (e.g., the memory 130) may cause one or more processors (e.g., the processor 110) to perform operations, in accordance with an embodiment of the present disclosure. In addition, the processor 110 may implement any component for performing data processing, according to an embodiment of the present disclosure.

According to an exemplary embodiment of the present disclosure, the processor 110 may also perform a computation for learning a neural network. For example, the processor 110 may perform calculations for learning the neural network, which include processing of input data for learning in deep learning (DL), extracting a feature in the input data, calculating an error, updating a weight of the neural network using backpropagation, and the like. At least one of the CPU, GPGPU, DSP, TPU, and NPU of the processor 110 may process learning of a network function. For example, both the CPU and the GPGPU may process the learning of the network function and data classification using the network function. Further, in an exemplary embodiment of the present disclosure, processors of the plurality of computing devices may be used together to process the learning of the network function and the data classification using the network function.

The processor 110 may generally control the overall operation of the computing device 100. For example, the processor 110 may perform the steps included in the flowchart which will be described below. By processing signals, data, or information that are input or output through the components included in the computing device 100 or by driving the application program stored in the memory 130, the processor 110 may provide or process appropriate information or functions for the user.

In an embodiment, the computing device 100 may include a System on Chip (SoC). For example, the computing device 100 may include a single chip on which the processor 110, the memory 130, and the network unit 150 shown in FIG. 1 are all mounted. In this case, the SoC may further include any modules for implementing the operations of the computing device 100, such as an I/O interface, a Power Management IC (PMIC), a security module, etc. Meanwhile, it will be apparent to one of ordinary skill in the art that the SoC can be referred to as a processor. Therefore, in such an embodiment, the operations performed by the processor 110 in the present disclosure should be interpreted as being performable by the SoC.

In an embodiment of the present disclosure, the memory 130 may store any type of information generated or determined by the processor 110 and/or any type of information received by the network unit 150. In an embodiment, a memory 130 may store information related to visualization of the artificial intelligence model, information on the artificial intelligence model, information on a platform (e.g., a hardware and/or a compiler), information on the intermediate representation structure, and information on the structured text, and the like.

In an embodiment of the present disclosure, the memory 130 may mean any type of storage medium, and include, for example, at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and/or an optical disk. The computing device 100 may operate in connection with a web storage performing a storing function of the memory 130 on the Internet. The memory 130 may include an embedded memory mounted inside the processor 110 and/or a memory mounted outside the processor 110 within the computing device 100. The above description of the memory is just an example and the memory 130 used in the present disclosure is not limited thereto. The memory 130 may be operated by the processor 110.

According to an embodiment of the present disclosure, the network unit 150 may implement any type of wired or wireless communication network capable of transmitting and receiving various types of data and signals. The technologies described in the present specification may be implemented not only through the networks mentioned above, but also through other types of networks.

In an embodiment, the computing device 100 (e.g., the user terminal) may further include an input unit and an output unit. The input unit may receive an input (e.g., a model file, model information, training data and/or trained model, etc.) necessary for outputting information for visualization of the artificial intelligence model from a user. The input unit may include a camera or a video input unit for inputting a video signal, a microphone or an audio input unit for inputting an audio signal, and a user input unit (e.g., a keyboard, a touch key, a mechanical key, and/or a push key, etc.) for receiving information from the user.

The term user input in the present disclosure may refer to any form of input from the user related to a request of the user performed within the user interface (or within the user terminal) and information provided by the user, and the like.

The output unit according to an embodiment of the present disclosure is for generating an output related to sight, hearing, or touch, and the like, and may include at least one of a display unit, a sound output unit, a haptic module, and a light output unit. The display unit may implement a touch screen by forming a mutual layer structure with a touch sensor or being formed integrally. Such a touch screen may function as a user input unit providing an input interface between the user terminal and the user, and simultaneously provide an output interface between the user terminal and the user. For example, the display unit may include at least one of a Liquid Crystal Display (LCD), a Thin Film Transistor-Liquid Crystal Display (TFT LCD), an Organic Light-Emitting Diode (OLED), a flexible display, a 3D display, and an e-ink display. In addition, the display unit displays (outputs and/or displays) data processed in the user terminal.

FIG. 2 illustrates an exemplary structure of an artificial intelligence model according to an embodiment of the present disclosure.

Throughout the present disclosure, the artificial intelligence model, the artificial intelligence based model, the operation model, the machine learning model, the deep learning model, the neural network, the network function, and the neural network may be used interchangeably to refer to the same concept.

The neural network may be generally constituted by an aggregate of calculation units which are mutually connected to each other, which may be called “node”. The nodes may also be called neurons. The neural network is configured to include one or more nodes. The nodes (or neurons) constituting the neural networks may be mutually connected to each other by one or more links. The node in FIG. 2 is used to mean a neuron within the artificial intelligence model (i.e., a neural network model), and the node in the intermediate representation structure is used to represent an atomic operator. The node in the intermediate representation structure is used to constitute a module and may have a different meaning from the node corresponding to a neuron in a neural network. A set of nodes in FIG. 2 may represent a layer or an operator, whereas the node in the intermediate representation structure corresponds to an atomic operator that cannot be decomposed.

In the neural network, one or more nodes connected through the link may relatively form a relationship between an input node and an output node. Concepts of the input node and the output node are relative and a predetermined node which has the relationship of the output node with respect to one node may have the relationship of the input node in the relationship with another node and vice versa. As described above, the relationship of the output node to the input node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable, and the weight may be varied by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form the input node and output node relationship in the neural network. A characteristic of the neural network may be determined according to the number of nodes, the number of links, correlations between the nodes and the links, and values of the weights granted to the respective links. For example, when the same number of nodes and links exist and two neural networks in which the weight values of the links are different from each other exist, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed from the initial input node up to the corresponding node. However, definition of the layer is predetermined for description and the order of the layer in the neural network may be defined by a method different from the aforementioned method. For example, the layers of the nodes may be defined by the distance from a final output node.

In an exemplary embodiment of the present disclosure, the set of the neurons or the nodes may be defined as the expression “layer”.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean not the initial input node and the final output node but the nodes constituting the neural network.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes increases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes decreases from the input layer to the hidden layer. The neural network according to still yet another exemplary embodiment of the present disclosure may be a neural network of a type in which the neural networks are combined.

The deep neural network (DNN) may mean a neural network including a plurality of hidden layers other than the input layer and the output layer. When the deep neural network is used, the latent structures of data may be identified. The deep neural network may include convolutional neural network (CNN), recurrent neural network (RNN), auto encoder, generative adversarial networks (GAN), restricted Boltzmann machine (RBM), deep belief network (DBN), Q network, U network, Siamese network, etc. The description of the deep neural network described above is just an example and the present disclosure is not limited thereto.

The artificial intelligence based model of the present disclosure may be expressed by a network structure of an arbitrary structure described above, including the input layer, the hidden layer, and the output layer.

The neural network which may be used in the artificial intelligence based model of the present disclosure may be learned in at least one scheme of supervised learning, unsupervised learning, semi supervised learning, or reinforcement learning, federated learning for distributed deep learning, and incremental learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data.

As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

According to an embodiment of the present disclosure, a computer-readable medium storing a data structure is disclosed. The above-described data structure may be stored in the memory 130 of the present disclosure, executed by the processor 110, and transmitted or received by the network unit 150.

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection relationship between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an effectively designed data structure, a computing device may perform operations while using the resources of the computing device to a minimum. Specifically, the computing device may increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for learning the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for learning the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called “node”. The nodes may also be called neurons. The neural network is configured to include one or more nodes.

The data structure may include data input into the neural network. The data structure including the data input into the neural network may be stored in the computer readable medium. The data input to the neural network may include learning data input in a neural network learning process and/or input data input to a neural network in which learning is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight may be varied by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network learning process and/or a weight in which neural network learning is completed. The weight which varies in the neural network learning process may include a weight at a time when a learning cycle starts and/or a weight that varies during the learning cycle. The weight in which the neural network learning is completed may include a weight in which the learning cycle is completed. Accordingly, the data structure including the weight of the neural network may include a data structure including the weight which varies in the neural network learning process and/or the weight in which neural network learning is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, R-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of learning cycle iterations, weight initialization (for example, setting a range of weight values to be subjected to weight initialization), and Hidden Unit number (e.g., the number of hidden layers and the number of nodes in the hidden layer). The data structure is just an example, and the present disclosure is not limited thereto.

An artificial intelligence-based model according to an embodiment of the present disclosure may include a Large Language Model (LLM). In the present disclosure, a Large Language Model may refer to an artificial intelligence-based model trained using a vast amount of training data to perform Natural Language Processing. A Large Language Model may include a transformer, an encoder-type model of a transformer, and/or a decoder- type model of a transformer. An encoder- type model of a transformer may correspond to an artificial intelligence model that uses the encoder structure of a transformer. A decoder- type model of a transformer may correspond to an artificial intelligence model that uses the decoder structure of a transformer. As an example, the artificial intelligence-based model of the present disclosure may include a GPT-family Large Language Model, a Bidirectional Encoder Representations from Transformers (BERT)-family Large Language Model, and the like.

In an embodiment, a transformer may be composed of an encoder that encodes input data and a decoder that decodes the encoded data. A transformer may have a structure that takes a series of input data as input and outputs a series of output data through encoding and decoding steps. In an embodiment, the series of input data may be processed into a form that a transformer can compute. The process of processing the series of input data into a computable form for the transformer may include a tokenizing process and an embedding process. The tokenizing process may refer to a process of dividing a series of input data into tokens of a certain unit. For example, the certain unit may include a word unit. The embedding process may refer to a process of converting at least one token, tokenized from the series of input data, into an embedding vector.

In an embodiment, a transformer can obtain an embedding vector to be input into an encoder by summing a token embedding vector, which embeds at least one token corresponding to a series of input data, a segment embedding vector that distinguishes the sentence containing the token for each token, and a position embedding vector that reflects the position of the token. Encoder-type models and decoder-type models of a transformer may also perform the same method to obtain an embedding vector.

In an embodiment, for a transformer to encode and decode a series of input data, the encoder and decoder within the transformer may utilize an attention algorithm. The attention algorithm may refer to an algorithm that, for a given Query, calculates a similarity by applying a softmax function to an attention score obtained by matrix-multiplying the Query with a Key, and then calculates an attention value for the Query by matrix-multiplying the calculated similarity with a Value.

In an embodiment, a self-attention algorithm may refer to an attention algorithm that uses a Query, Key, and Value generated by respectively multiplying the same embedding vector by a query weight, a key weight, and a value weight. A cross-attention algorithm may refer to an attention algorithm that uses a Query generated by multiplying a first embedding vector by a query weight, and a Key and a Value generated by respectively multiplying a second embedding vector by a key weight and a value weight. The query weight, key weight, and value weight may be trainable parameters that are updated through the learning process of the Large Language Model.

In an embodiment, the encoder of a transformer may include an embedding layer, a self-attention layer that applies a self-attention algorithm to an embedding vector, a normalization layer, and a Feed Forward Neural Network (FFN). Furthermore, the encoder may have a form in which N unit structures, each comprising a self-attention layer, a normalization layer, and a feed-forward neural network, are connected. The decoder of a transformer may include an embedding layer, a masked self-attention layer, a normalization layer, a cross-attention layer that applies a cross-attention algorithm, and a feed-forward neural network. Furthermore, the decoder may have a form in which N unit structures, each comprising a masked self-attention layer, a normalization layer, a cross-attention layer, and a feed-forward neural network, are connected. The masked self-attention layer may correspond to a layer that calculates an attention value for each of the sequences in which words are sequentially included, for a plurality of words included in a series of input data.

A transformer may include not only an encoder and a decoder but also additional components such as a linear layer, a softmax layer, etc. Encoder-family models and decoder-family models of a transformer may also respectively include not only an encoder and a decoder but also the aforementioned additional components. A method for constructing a transformer using an attention algorithm may include the method disclosed in Vaswani et al., "Attention Is All You Need," 2017 NIPS, which is incorporated herein by reference.

In an embodiment, an attention layer such as a self-attention layer, a masked self-attention layer, or a cross-attention layer may correspond to a multi-head attention layer that includes a plurality of attention layers in parallel. The multi-head attention layer can concatenate the attention values output from each of the plurality of attention layers, and matrix-multiply the concatenated matrix with an output weight to output an output attention value. The output attention value output from the multi-head attention layer may have the same size as the attention value output from a single attention layer.

In an embodiment, a transformer may be trained through a Masked Language Model (MLM) process, a Next Sentence Prediction (NSP) process, and the like. The MLM process may refer to a learning process that predicts a masked word through a series of training data in which some words are masked. The NSP process may refer to a learning process that determines whether two sentences are connected in a series of training data that includes two arbitrary sentences.

In an embodiment, a Large Language Model can process not only natural language text but also various data formats such as image data, audio data, and video data. A Large Language Model can embed data to convert data with various formats into a series of computable data. A Large Language Model can process additional data that represents the relative positional relationship or topological relationship between a series of input data. Alternatively, a series of input data can be embedded by additionally reflecting vectors that represent the relative positional relationship or topological relationship between the input data. As an example, the relative positional relationship between a series of input data may include, but is not limited to, the word order within a natural language sentence, the relative positional relationship of each divided image, the time sequence of a divided audio waveform, etc. The process of adding information that represents the relative positional or topological relationship between a series of input data may be referred to as positional encoding.

An example of a Large Language Model that processes image data (Vision Transformer, ViT) is disclosed in Dosovitskiy, et al., "AN IMAGE IS WORTH 16X16 WORDS: TRANSFORMERS FOR IMAGE RECOGNITION AT SCALE," and this document is incorporated herein by reference.

An artificial intelligence model according to an embodiment of the present disclosure may include a multi-modal Large Language Model. A multi-modal Large Language Model may refer to a Large Language Model that can understand and process the relationship between mutually different data formats, such as natural language text data, image data, audio data, and video data. A multi-modal language model may include a plurality of encoders that encode input data corresponding to each data format. The multi-modal language model can be trained, through training data that includes data of mutually different formats, to calculate the similarity between embedding vectors encoded from the encoder of each data format, such that the similarity for the same pairs is calculated to be higher, and the similarity for different pairs is calculated to be lower.

An example of a multi-modal Large Language Model that understands and processes the relationship between image data and natural language text data (Contrastive Language-Image Pre-training, CLIP) is disclosed in Alec Radford, et al., "LEARNING TRANSFERABLE VISUAL MODELS FROM NATURAL LANGUAGE SUPERVISION," and this document is incorporated herein by reference.

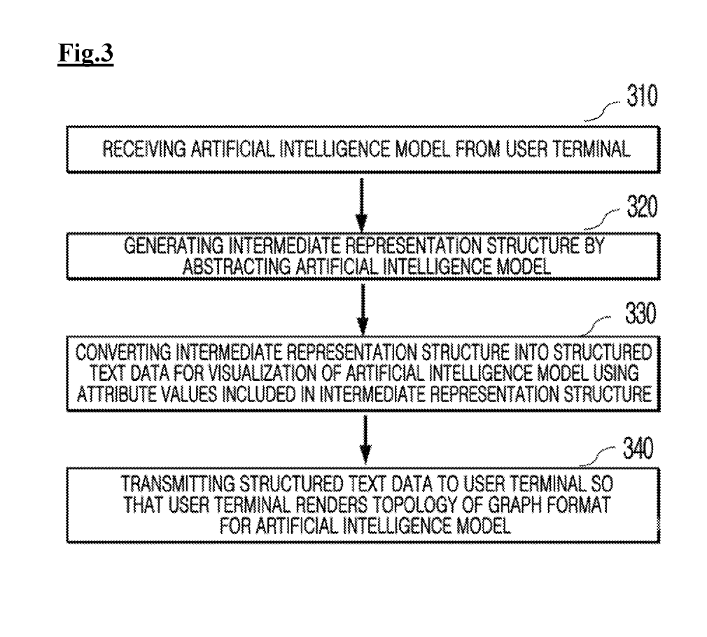

FIG. 3 illustrates an exemplary method for visualization of an artificial intelligence model according to an embodiment of the present disclosure.

Steps in FIG. 3 are illustrated as being performed by the computing device 100 (e.g., a server). According to an implementation aspect, some of entities in FIG. 3 may be operated by interacting with the server outside the server.

In an embodiment, the computing device (e.g., the server) 100 may receive an artificial intelligence model from a user terminal (310).

For example, the artificial intelligence model may refer to an artificial intelligence model to be a target of visualization. The computing device 100 may receive information identifying the artificial intelligence model or a file of the artificial intelligence model.

In an embodiment, the computing device 100 may generate an intermediate representation structure corresponding to the artificial intelligence model by abstracting the artificial intelligence model (320).

The intermediate representation structure may perform a role of a blueprint for rendering a result to be visualized in a user interface according to an embodiment of the present disclosure. The computing device 100 may load the intermediate representation structure corresponding to the artificial intelligence model through an internal component or communication with an external server. For example, the computing device 100 may call an Application Programming Interface (API) providing the intermediate representation structure, and the intermediate representation structure corresponding to the artificial intelligence model may be generated by an internal or external component of the computing device 100 according to the call. For example, the intermediate representation structure may refer to a graph structure expressed by nodes and edges. For example, the intermediate representation structure may be formed of a hierarchical structure of framework-independent nodes and framework-dependent modules (a set of nodes). For example, the intermediate representation structure may include a combination of nodes corresponding to atomic operators of a minimum unit universally applicable to a plurality of frameworks.

The computing device 100 may read a file of the artificial intelligence model stored in various framework formats (e.g.: ONNX, PyTorch, or TensorFlow) and load the file into the memory 130. For example, the computing device 100 may generate a graph structure, by converting information constituting the artificial intelligence model (operator type, attribute, and connection relationship, etc.) into a data form that the computing device 100 can process, using a parser suitable for each format. For example, the computing device 100 may extract nodes (e.g., operators) constituting the artificial intelligence model, attributes thereof and connection relationships thereof by traversing the graph structure (e.g., by using a graph search algorithm such as Depth First Search (DFS) and Breadth First Search (BFS), etc.).

For example, the computing device 100 may identify a basic operation unit (e.g., an atomic operator that cannot be decomposed any further) within the artificial intelligence model by traversing the graph structure, and extract attributes and connection relationships thereof. The computing device 100 may generate an intermediate representation structure of a graph format using the identified nodes and connection relationships thereof.

For example, the computing device 100 may combine the identified nodes into module units, which are upper concepts of the nodes, using a hierarchical structure of a framework of the artificial intelligence model. The computing device 100 may generate an intermediate representation structure of a graph format using the identified nodes and modules and connection relationships thereof.

For example, the computing device 100 may generate the intermediate representation structure by abstracting the artificial intelligence model to include framework-independent (e.g., universal) nodes and tensors representing outputs of the nodes.

As a non-limiting example, the intermediate representation structure may include parameters (e.g., weight, bias, and/or kernel, etc.), activations (or activation values), and nodes of the artificial intelligence model. As a non-limiting example, the intermediate representation structure may be a graph structure including nodes, modules composed of one or more nodes, and tensors expressing an input of a module, an output of a module, a weight input to a module, and an activation input to a module on the intermediate representation structure. Information included in such an intermediate representation structure may be used when converted into structured text data.

In an embodiment, the computing device 100 may convert the intermediate representation structure into structured text data for visualization of the artificial intelligence model using attribute values included in the intermediate representation structure (330).

The computing device 100 may extract information stored in the intermediate representation structure and generate structured text data for visualization of the artificial intelligence model using the extracted information.

When generating the intermediate representation structure, the computing device 100 may store an attribute or an attribute value defining structural characteristics of a component (e.g., a node) of the artificial intelligence model, in a module and/or a tensor of the intermediate representation structure. For example, the attribute may be defined as a parameter defining structural characteristics for the component of the artificial intelligence model. For example, the attribute may include an input of the artificial intelligence model, an output, node-related information, and/or connection information of nodes.

The computing device 100 may query attribute values of the intermediate representation structure to extract an input of the artificial intelligence model, an output of the artificial intelligence model, nodes included in the artificial intelligence model, connection information between the nodes, and metadata included in the artificial intelligence model from the intermediate representation structure. For example, the computing device 100 may determine related information or overall information for generating structured text using the attribute values stored in the intermediate representation structure. The metadata may be defined as information expressing additional descriptions such as quantization information and/or performance for components (e.g., nodes) of the artificial intelligence model. In an additional example, the metadata is stored in the intermediate representation structure (e.g., node, module, and/or tensor), and the computing device 100 may extract the metadata on the intermediate representation structure and generate the structured text using the metadata.

The computing device 100 may convert the intermediate representation structure into a structured text data structure. The computing device 100 may generate the structured text data by arranging the extracted information according to a predefined text data structure. In this specification, the term converting and transforming can be used interchangeably.

For example, the structured text data is a data structure of a form easy to handle in a rendering process in the user terminal, and may take a structure of a JSON (JavaScript Object Notation) file form. For example, the computing device 100 may query attribute values of the intermediate representation structure to extract nodes, connection relationships of nodes, metadata (e.g., information on how to quantize the model), an input and an output of the artificial intelligence model, and convert the extracted information into a preset text template. The computing device 100 may generate a schema for rendering in the user terminal by configuring a predefined JSON template (e.g., a template composed of graph, modules, in_ports, out_ports, nodes, edges, tensors, and/or metadata) from the intermediate representation structure. The computing device 100 may generate information on performance related to the artificial intelligence model (e.g., performance per node or a performance change value) through execution for the artificial intelligence model (e.g., simulation on the intermediate representation structure or direct execution for the artificial intelligence model), and generate the structured text data by using the information on performance together with the attribute value extracted from the intermediate representation structure.

For example, the structured text data may refer to a data format used for the server to organize information of the artificial intelligence model according to a predetermined rule (or structure) and transmit the organized information to the user terminal. Since the structured text data is text-based data, it can operate independently on various media or platforms, and since it is structured, a machine can easily interpret and process it. A representative example of the structured text data may be a file of a JSON format.

The computing device 100 may generate an edge not included in the intermediate representation structure by changing a tensor included in the intermediate representation structure into an edge connecting nodes. The structured text data may be generated using the edge. For example, the intermediate representation structure may include framework-independent nodes, a first tensor representing a parameter of the artificial intelligence model, and a second tensor representing an activation value of the nodes. The computing device 100 may create an edge connecting the nodes using the second tensor and the nodes, and then convert the intermediate representation structure into the structured text data using the first tensor, the nodes, and the edge. For example, the tensor may include a weight and an activation, etc., and the computing device 100 may generate the structured text data by changing a specific tensor among tensors of the intermediate representation structure into an edge. For example, the computing device 100 may identify a tensor representing an activation among tensors of the intermediate representation structure and generate the structured text data by changing the identified tensor into an edge.

In an embodiment, the structured text data may include a node representing a basic (or atomic) operation unit of the artificial intelligence model, a module representing a set of nodes, an edge connecting nodes, a tensor representing a parameter, and/or metadata representing quantization-related information. For example, the structured text data may have a text structure (e.g., a plain text structure) in which each of included information is expressed as a pair of a key and a value. The structured text data may have a JSON data structure expressed as a pair of a key and a value.

In an embodiment, when generating the structured text data, the computing device 100 may traverse each of a plurality of nodes included in the intermediate representation structure to extract information to be included in the structured text data from each node. For example, the computing device 100 may extract node identification information, input tensor identification information, output tensor identification information, and operator type information from each of the plurality of nodes by traversing each of the plurality of nodes included in the intermediate representation structure in a direction from an input to an output of the artificial intelligence model. The structured text data may be generated using such extracted information. For example, the computing device 100 may generate the structured text data for each of the plurality of nodes within the intermediate representation structure by mapping the extracted information with a key of the structured text data using the extracted information as a value.

A technique according to an embodiment of the present disclosure may convert a specific tensor on the intermediate representation structure into an edge in order to include an edge not existing on the intermediate representation structure in the structured text data. Accordingly, since a data structure easy to process in the user terminal can be generated in advance by the server when performing visualization (e.g., rendering) of the artificial intelligence model in the user terminal, unnecessary data communication amount with the server may be reduced in a visualization process of the artificial intelligence model in the user terminal, and furthermore, limited computing resources of the user terminal may be efficiently utilized. Accordingly, efficiency of resource use of the user terminal may be increased in the visualization process of the artificial intelligence model, and unnecessary data communication between the server and the user may be reduced.

In an embodiment, the computing device 100 (e.g., the server) may obtain a performance value (e.g., accuracy and/or latency) and/or a performance change value (e.g., SNR) related to the artificial intelligence model by executing the artificial intelligence model, and include the received performance value and/or performance change value in the metadata. The computing device 100 may convert the structured text data from the intermediate representation structure using the metadata including information related to performance and the attribute value stored in the intermediate representation structure. The computing device 100 may allow performance related to the artificial intelligence model to be efficiently visualized in a rendering process of the user terminal by storing the performance value and/or the performance change value of the executed artificial intelligence model in the structured text data (e.g., a first schema).

In an embodiment, the computing device 100 may perform a change, modification, and/or optimization (e.g., graph optimization, compression, and/or quantization, etc.) for the artificial intelligence model on the intermediate representation structure. Accordingly, a modified intermediate representation structure for the intermediate representation structure corresponding to the artificial intelligence model may be generated. For example, the computing device 100 may generate a modified intermediate representation structure by changing a configuration of nodes and/or modules included in the intermediate representation structure using a model optimization tool including at least one of a compressor for lightweighting of the model, a graph optimizer for increasing execution efficiency of the model, and a quantizer for reducing at least one of a size and an operation amount of the model. By applying the model optimization tool to the intermediate representation structure, a change, conversion, and/or optimization operation on the intermediate representation structure may be performed, and an artificial intelligence model to which optimization is applied may be generated by performing converting on the intermediate representation structure to which such an operation is applied according to a framework.

In an embodiment, the computing device 100 may generate a node performance change value quantitatively representing a performance change for modified nodes within the modified intermediate representation structure (e.g., a performance change compared to a node before modification) by performing an inference operation using the intermediate representation structure and performing an inference operation using the modified intermediate representation structure. The node performance change value may be generated by comparing performance of the node before modification and performance of the node after modification. The computing device 100 may include such a node performance change value in the structured text data when converting the structured text data. For example, the computing device 100 may generate an expected inference simulation result for a case where the artificial intelligence model taking input data as an input is executed on a platform, without executing the artificial intelligence model on the platform, using the platform (e.g., a hardware and/or a compiler) on which the artificial intelligence model is to be executed, the input data to be used in a simulation process of the artificial intelligence model, and the intermediate representation structure. Simulation using the intermediate representation structure may be performed based on preprocessing of a manner of removing modules (e.g., a group of nodes) within the intermediate representation structure and maintaining nodes (e.g., an atomic operator), for example. For example, simulation using the intermediate representation structure may be performed based on preprocessing of a manner that a single node is included in a single module within the intermediate representation structure.

In an embodiment, the computing device 100 may receive a modification request for the artificial intelligence model. For example, the user terminal may receive a modification request (or a change request) for the model on a user interface representing the visualized artificial intelligence model and transmit the received modification request to the server. In the present disclosure, the modification request and the change request may be used interchangeably. When there is a modification request for the artificial intelligence model, the computing device 100 may identify a target of model modification using information received from the user terminal, modify the identified modification target, and regenerate the structured text data based on the modified artificial intelligence model and/or the modified intermediate representation structure. As the regenerated structured text data is transmitted to the user terminal, the modification request may be synchronized in both the server and the user terminal, and a result in which the modification request is reflected may be output on the user interface.

In an embodiment, in response to receiving a change request for the artificial intelligence model from the user terminal, the computing device 100 may identify information included in the change request among a node identification number, a node name, a node operator type, an edge identification number, and an edge name from the change request. Using the identified information, the computing device 100 may identify a target of the change request within the artificial intelligence model and change the intermediate representation structure of the artificial intelligence model according to the change request. The computing device 100 may change the structured text data based on the changed intermediate representation structure. The changed structured text data is transmitted to the user terminal so that efficient synchronization between a re-rendering result of a topology of a graph format by the user terminal and the intermediate representation structure stored in the server may be achieved.

The computing device 100 may transmit the structured text data to the user terminal so that the user terminal renders a topology of a graph format for the artificial intelligence model (340).

In an embodiment, when the structured text data is transmitted to the user terminal, the structured text data may be reconfigured to be expressed as nodes and edges connecting the nodes, as a first schema of the structured text data is changed to a second schema for graph rendering. The topology of the graph format for the artificial intelligence model may be rendered based on the reconfigured structured text data.

The topology in the present disclosure may represent a logical structure expressing an arrangement and a connection relationship of nodes (e.g., operators) constituting the artificial intelligence model. The topology may represent a result expressing which node is connected to which other node. The topology may represent a visualization result for a structure of the artificial intelligence model. The topology may refer to a structural diagram of the artificial intelligence model.

The schema in the present disclosure may represent a rule defining in what format and with what rule data such as structured text data is configured. In the above embodiment, the first schema is a schema for data transmission, and may define a rule or a structure for efficiently transmitting data from the server to the user terminal. The second schema is a schema for rendering, and may define a rule or a structure for the user terminal to efficiently visualize (e.g., render) the artificial intelligence model. For example, the first schema may represent a structure in which nodes, edges, metadata, etc. are separated and stored in respective lists, and the second schema may represent a structure in which additional information such as metadata is integrated and stored in related nodes and edges.

In an embodiment, the computing device 100 may transmit the structured text data to the user terminal so that the user terminal can change a schema of the structured text data generated according to the first schema into the second schema.

In an embodiment, when receiving an artificial intelligence model having a single input multi destination structure, the computing device 100 may generate a plurality of edges by branching respective edges corresponding to multiple outputs from one edge information. By displaying an index for each of the plurality of edges, management for these edges may be achieved.

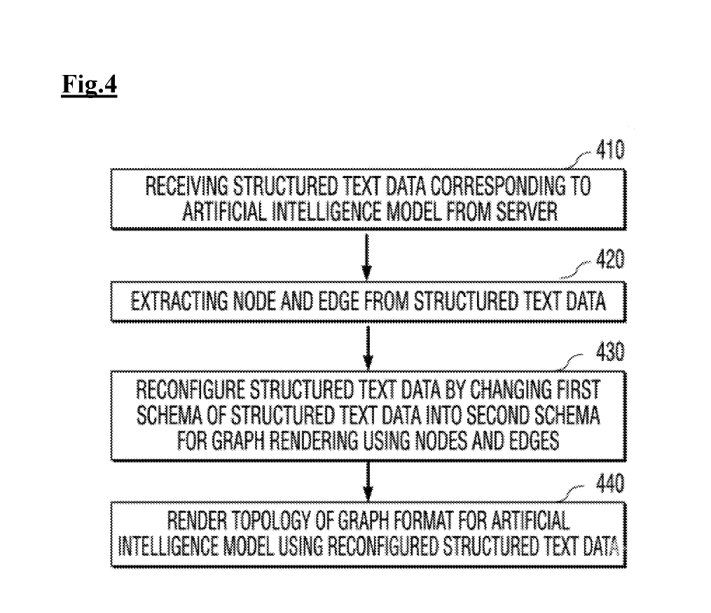

FIG. 4 illustrates an exemplary method for visualization of an artificial intelligence model according to an embodiment of the present disclosure.

Steps in FIG. 4 are illustrated as being performed by the computing device 100 (e.g., a user terminal). According to an implementation aspect, some of entities in FIG. 4 may be operated by interacting with a computing device outside the user terminal.

In an embodiment, the computing device (e.g., the user terminal) 100 may receive structured text data corresponding to an artificial intelligence model from a server (410). A detailed description of the structured text data will be replaced with the above description.

In an embodiment, the computing device 100 may extract nodes and edges from the structured text data (420).

For example, the computing device 100 may extract information on nodes and edges on structured text data having a format in which data is classified according to a classification criterion. Such information on nodes and edges may be utilized in a schema change process of the structured text data. Such information on nodes and edges may be utilized in a reconfiguration process of the structured text data.

In an embodiment, the computing device 100 may reconfigure the structured text data by changing a first schema of the structured text data into a second schema for graph rendering using the nodes and the edges (430).

In the step of reconfiguring the structured text data, the computing device 100 may convert the first schema including nodes, edges, tensors, and metadata arranged separately into the second schema expressed by the nodes and the edges by integrating tensors and metadata in the structured text data into at least one of the nodes and the edges. Reconfiguration of the structured text data may represent an operation of changing a schema of structured text into a different schema.

In a JSON file, components of the artificial intelligence model may be listed according to classifications such as sub-graph, modules, in_ports, out_ports, nodes, edges, and tensors, metadata, and the like. The JSON file may have a form in which a connection structure of operators of the artificial intelligence model cannot be intuitively grasped in a process where the user terminal renders a graph topology of the artificial intelligence model. Accordingly, the computing device 100 may reconfigure information of the JSON file into module, node, and edge according to the second schema to render a graph. In such a reconfiguration process, tensors and metadata, etc. included in the JSON file may be modified to be included in module, node, and edge. Accordingly, an operation of integrating the first schema (e.g., a backend schema) of a form divided into several components to facilitate model modification in the user terminal into the second schema for rendering a graph may be performed.

In an embodiment, the computing device 100 may render a topology of a graph format for the artificial intelligence model using the reconfigured structured text data (440).

The computing device 100 may generate or render a topology based on the second schema reconfigured with only modules, nodes, and edges, and generate detailed information (e.g., metadata and attribute) corresponding to the topology.

The graph or the graph structure in the present disclosure may refer to a graph obtained by abstracting the artificial intelligence model into a structure of nodes and edges based on a connection relationship including nodes and tensors. The graph or the graph structure may refer to a graph obtained by rendering the artificial intelligence model into a structure of nodes and edges based on a connection relationship including modules, nodes, and tensors.

Rendering in the present disclosure may refer to a process of converting a topology representing a logical connection structural diagram of the artificial intelligence model into a visual graph image and displaying it on a user interface. Such rendering may refer to a computing process of generating a digital image by assigning specific visual attributes (e.g., location, color, and shape, etc.) to abstract data. For example, the computing device 100 may read the structured text data received from the server and interpret information such as nodes, edges, and metadata contained therein. Then, the computing device 100 may reconfigure the interpreted data into a format (e.g., the second schema) that a visualization library of the computing device 100 can understand. For example, a manner of integrating separated metadata into a corresponding node object may be used in the reconfiguration process. Then, the computing device 100 may calculate coordinates on a screen of a user interface at which each node and edge in the reconfigured structured text data are to be arranged, and determine a display manner (e.g., color), shape, and size for rendering for the nodes and edges. Here, a different display manner (e.g., color) may be determined according to a metadata (e.g., SNR) value. Then, according to the calculated visual attributes, the computing device 100 may call a graphics API to fill pixels on the screen of the user interface to render a final graph image and output it.

In an embodiment, the computing device 100 may receive a user input including a change request for at least a part (e.g., nodes and edges, etc.) of the rendered topology. The computing device 100 may re-render a changed topology corresponding to the change request without waiting for a response related to the change request, from the server. For example, the computing device 100 may transmit information related to the change request to the server and re-render the changed topology corresponding to the change request before receiving a response (e.g., modified structured text data) from the server.

In response to receiving a change failure response from the server, the computing device 100 may roll back the changed topology (i.e., the re-rendered topology) to a topology before the change (i.e., before re-rendering).

In response to receiving a change success response from the server, the computing device 100 may integrate metadata and a tensor included in changed structured text included in the change success response into at least one of a node and an edge of the re-rendered changed topology, using the changed structured text data included in the change success response. That is, the computing device 100 may reconfigure the changed structured text data into the second schema. That is, when receiving a change success response from the server after re-rendering without waiting for a response of the server for the user change request, the computing device 100 may update detailed information (e.g., metadata and tensor, etc.) internalized in the node and edge using information included in the change success response. Also, as change information related to the change request is transmitted to the server, a changed artificial intelligence model or a changed intermediate representation structure corresponding to the re-rendered topology may be generated by the server.

In this manner, synchronization between the artificial intelligence model and/or the intermediate representation structure stored in the server and the topology rendered by the computing device 100 may be achieved. In this manner, as a result in which a user's change request is immediately reflected is output, rapidity of interaction with the user in the computing device 100 (i.e., the user terminal) may be secured.

In an embodiment, the computing device 100 may implement comparison rendering for a plurality of topologies. The computing device 100 may perform comparison rendering in a manner of corresponding locations of nodes and/or edges belonging to corresponding layers to each other based on a hierarchical structure of artificial intelligence models corresponding to the plurality of topologies. For example, the computing device 100 may receive first structured text data corresponding to a first artificial intelligence model and second structured text data corresponding to a second artificial intelligence model. The computing device 100 may identify differential nodes representing a difference between a first topology of the first artificial intelligence model and a second topology of the second artificial intelligence model using identification information of nodes included in each of the first structured text data and the second structured text data. The computing device 100 may re-render at least one topology of the first topology and the second topology using the differential nodes. In a re-rendering process, by applying a predefined visual attribute to the differential nodes, the computing device 100 may allow the differential nodes to be re-rendered to be visually distinguished from common nodes commonly existing in the first topology and the second topology.

When structures of two artificial intelligence models are compared, the differential node may refer to a node that exists only in any one model and represents a structural difference between the two models. The differential node may be used as a visualization unit representing which operator (e.g., node) is added or deleted between two versions of models or between two models. The differential node may be defined as a term encompassing nodes not commonly existing in a plurality of models, identified in a process of comparing topologies of the plurality of artificial intelligence models. For example, a first differential node may represent a node existing in the first artificial intelligence model serving as a reference but not existing in the second artificial intelligence model serving as a comparison target. For example, a second differential node may represent a node not existing in the first artificial intelligence model but existing in the second artificial intelligence model. For example, when a modified artificial intelligence model exists according to modification, conversion, and/or optimization of an original artificial intelligence model, the differential node may be used to compare a structural difference between the original artificial intelligence model and the modified artificial intelligence model.

In an embodiment, the computing device 100 may receive a user input including a change request for the rendered topology, and determine a type of the change request based on the received user input. The computing device 100 may determine whether to interact with the server for re-rendering of the topology and/or an interaction manner with the server based on the type of the change request. A correlation may exist between the type of the change request and presence or absence of interaction with the server. A correlation may exist between the type of the change request and the interaction manner with the server.

More specifically, when the type of the change request is determined as a first type in which nodes and edges are not changed, the computing device 100 may determine to re-render a topology in which locations of nodes and edges are changed according to the change request without interaction with the server. For example, when a change request in which nodes are maintained and connection relationships between nodes are not changed, such as a size change and location movement of nodes and/or edges, is received, the computing device 100 may self-perform re-rendering corresponding to the change request without interaction with the server. Self-re-rendering of the computing device 100 may refer to changing location states of nodes and/or edges on the user interface without communication with the server. When receiving a user input for refresh from the user after such re-rendering is performed, the computing device 100 may output a rendering result before re-rendering on the user interface by rolling back a result of re-rendering.

When the type of the change request is determined as a second type including creation of a node (e.g., creation of a new node), the computing device 100 may determine transmission information to be transmitted to the server based on an operator corresponding to a node to be created. What information is to be transmitted to the server may be mapped to each of operators. For example, in a case of a convolution operator, a fact that values related to padding and stride should be transmitted to the server together may be mapped to the convolution operator. For example, some information may be generated internally in the server without being transmitted to the server.

When the type of the change request is determined as a third type including deletion of a node, the computing device 100 may transmit node identification information (e.g., node ID) corresponding to a node to be deleted to the server. In this case, as only the node ID is transmitted, synchronization between the server and the user terminal may be achieved in a form of efficiently using communication resources.

When the type of the change request is determined as a fourth type including creation of an edge, the computing device 100 may transmit identification information on a start node and an end node corresponding to an edge to be created to the server. For example, the computing device 100 may transmit information on a start node and an end node connected with an edge to the server so that the server can connect the edge between nodes on the intermediate representation structure.

When the type of the change request is determined as a fifth type changing an attribute value and/or metadata of a node, for a padding change, the computing device 100 may transmit a changed value (e.g., node ID and changed padding value) to the server. When the type of the change request is determined as a fifth type changing an attribute value and/or metadata of a node, for a padding change, implementation where the computing device 100 transmits not only the changed value but also all information related to the node (e.g., stride value, kernel value, etc.) to the server may also be possible.

In an embodiment, the computing device 100 may determine a visual attribute of a rendered node according to performance of the node in a rendering process. For example, a node color may be dynamically determined according to metadata internalized in the node in the rendering process. For example, a node color may be dynamically determined according to an SNR score internalized in the node in the rendering process. By determining a display color corresponding to the node based on a node performance value or a node performance change value internalized in the node within the topology, and rendering the node within the topology in the determined display color, the computing device 100 may allow performance information or performance change information of nodes to be intuitively checked within a rendering result. For example, the computing device 100 may determine the display color corresponding to the node such that the node performance value or the node performance change value has a positive correlation with saturation or luminance on a color gradient. In this manner, performance of nodes can be efficiently checked or displayed on the rendered topology through distinction between luminance or saturation, and accordingly, user experience may be enhanced.

In an embodiment, the computing device 100 may assign an edge of the same color or give the same visual attribute to nodes of the same layer in the rendering process. For example, the computing device 100 may render the topology such that a first node and a second node are visually integrated by applying a common visual attribute to the first node and the second node belonging to a layer corresponding to each other within the topology based on layer identification information internalized in nodes within the topology. As nodes belonging to the same layer are rendered in the same display manner using layer identification information corresponding to the nodes, a technical effect that an internal structure of the artificial intelligence model can be more intuitively checked may be achieved. As another example, the computing device 100 may render the topology such that edges of the first node and the second node are visually integrated by applying a common visual attribute to edges connected to each of the first node and the second node belonging to a layer corresponding to each other within the topology based on layer identification information internalized in nodes within the topology. By unifying a display manner using layer identification information for not only nodes but also edges related to the nodes using layer identification information corresponding to the node, a technical effect that an internal structure of the artificial intelligence model can be more intuitively checked may be achieved.

As illustrated in FIGS. 3 and 4, a technique according to an embodiment of the present disclosure can achieve visualization (e.g., rendering) for a structure of an artificial intelligence model in a manner of efficiently using computing resources and network resources through interaction between a server and a user terminal, and furthermore, efficient synchronization between data stored in the server (e.g., intermediate representation structure) and data rendered in the user terminal (e.g., reconfigured structured text data) can be implemented in such a visualization process.

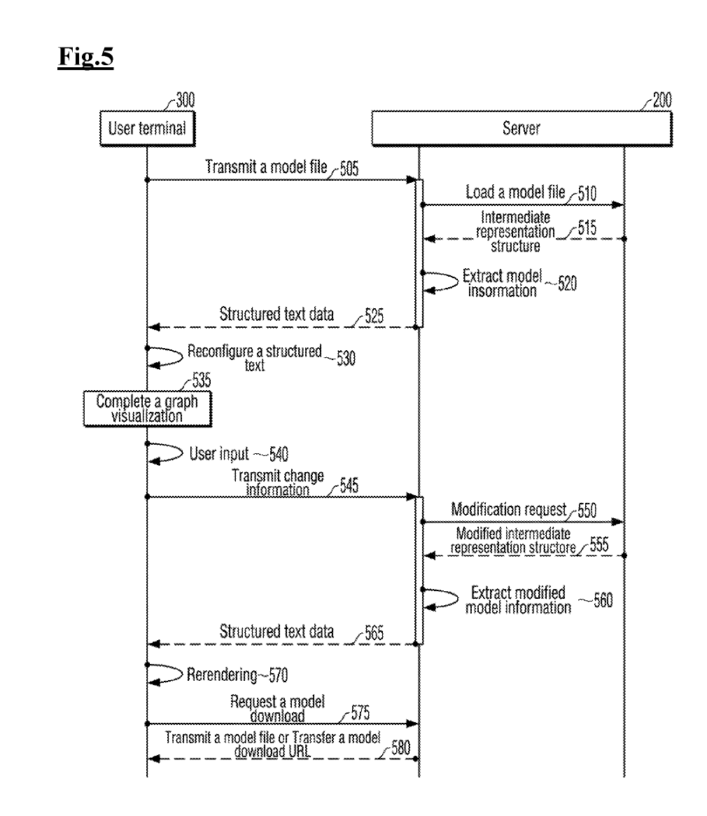

FIG. 5 illustrates an exemplary method for visualization of an artificial intelligence model according to an embodiment of the present disclosure.

FIG. 5 exemplarily shows interaction between the user terminal 300 and the server 200 for implementing visualization of an artificial intelligence model. The user terminal 300 and the server 200 may be included within the scope of the computing device 100 described above. The server 200 may receive an artificial intelligence model from the user terminal 300, generate an intermediate representation structure through abstraction, perform conversion of structured text data, and transmit the structured text data to the user terminal 300. The user terminal 300 interacts with the server 200, and may render a topology of a graph format based on the received structured text data and transmit a user input to the server 200.

The user terminal 300 may transmit an artificial intelligence model file for visualization to the server 200 (505). For example, the user terminal 300 may transmit an artificial intelligence model file such as ONNX and Torch, etc. to the server. For example, step 505 may correspond to a visualization request step.

The server 200 may load the model file (510). The server 200 may load the received artificial intelligence model file and generate or obtain an intermediate representation structure corresponding to the loaded model file. The server 200 may parse the received artificial intelligence model file and load it into a memory, thereby preparing loaded data in an analyzable state. For example, the server 200 may load the artificial intelligence model file received from the user terminal 300 and identify and/or analyze the loaded artificial intelligence model file. Through an operation inside the server 200 or communication with an entity existing outside the server 200, the intermediate representation structure may be generated and/or loaded. For example, the server 200 may call an API for obtaining an intermediate representation structure corresponding to the received artificial intelligence model in step 510.

The server 200 may generate or obtain an intermediate representation structure corresponding to the received model file (515). For example, step 515 may be performed by an entity outside or inside the server managing and creating the intermediate representation structure. An intermediate representation structure may be included in a response from the entity outside or inside the server. For example, the response may have one file form (e.g., a Python object of the intermediate representation structure). For example, the server 200 may convert the artificial intelligence model file received in step 505 into a corresponding intermediate representation structure and return a conversion result (515). For example, the server 200 may abstract the artificial intelligence model to generate an intermediate representation structure expressed by framework-independent nodes and framework-dependent modules (a set of nodes).

The server 200 may extract artificial intelligence model information using the return result (520). For example, the server 200 may extract attribute values on the intermediate representation structure corresponding to the artificial intelligence model using the return result. The server 200 may extract information stored in the intermediate representation structure. For example, the server 200 may extract information such as nodes, tensors, and/or metadata required for visualization (e.g., required for reconfiguration of the intermediate representation structure) using attribute values included in the intermediate representation structure.

Specifically, the server 200 may iterate through each component (e.g., node, tensor, module, etc.) hierarchically stored in the intermediate representation structure and extract information necessary for generation of structured text data. For example, the server 200 may traverse a set of nodes included in the intermediate representation structure, bring a corresponding node object for each node ID, and then extract information necessary for visualization from attributes possessed by the object and store it in a temporary dictionary. Accordingly, a unique identifier of a node, a name of a node, an identifier of a tensor entering the node (to be utilized as an input edge later), an identifier of a tensor output from the node (to be utilized as an output edge later), and a type of operation performed by the node may be extracted. For example, extracted information may be mapped to a key of structured text data. Such an extraction manner may be repeatedly performed in a corresponding manner for all other components constituting the intermediate representation structure, such as modules, tensors, and/or metadata as well as nodes. Accordingly, a JSON file can be generated as information on components in the intermediate representation structure is converted and mapped to each key. Thereby, data of an intermediate representation structure form used inside the server 200 can be converted into structured text data easy for communication and visualization.

In this specification, iterating and traversing can be interchangeably used.

The server 200 may generate structured text data using the extracted information (525). For example, the server 200 may perform conversion of a file format (e.g., conversion from a Python object to a JSON form) to visualize the artificial intelligence model. The server 200 may change information included in the intermediate representation structure into a format easy to handle in the user terminal 300. The server 200 queries attribute values of the Python object (e.g., intermediate representation structure) to extract an input and an output of the artificial intelligence model, nodes, connection relationships of nodes, and/or metadata (e.g., information on how to quantize the model), and arranges the extracted information according to a preset JSON template (e.g., a format of graph, modules, in_ports, out_ports, nodes, edges, tensors, and metadata), thereby generating a schema for rendering of the user terminal. For example, the intermediate representation structure is a data structure not including edges and expresses this only with tensors, but since the plain text (e.g., the JSON format) is a structure including edges, a task of converting information stored in a tensor within the intermediate representation structure into an edge of structured text data may be performed. The structured text data may refer to a result generated by the server 200 by arranging extracted model information according to a predefined text data structure (e.g., the first schema) so that the user terminal 300 can render it. Step 525 may correspond to an exchange process of visualization information between the server 200 and the user terminal 300.

The user terminal 300 may reconfigure the structured text data (530). For example, step 530 may correspond to, for example, a rendering preparation step or a schema conversion process of the user terminal 300. The user terminal 300 may generate reconfigured structured text data by changing a schema of the structured text data. The user terminal 300 may represent a process of converting received structured text data into a format (e.g., the second schema) suitable for a rendering library. For example, tensors and metadata, etc., which were separated in the structured text data of the first schema, may be integrated into nodes and edges in the structured text data of the second schema. For example, since components of the artificial intelligence model are listed according to a classification system such as sub-graph, modules, in_ports, out_ports, nodes, edges, tensors, and metadata, etc. in a JSON file, such structured text data has a form in which a connection structure of operators of the artificial intelligence model cannot be intuitively grasped. Accordingly, the user terminal 300 may reconfigure information of the JSON file with only module, node, and edges to efficiently render a topology of a graph format. In such a reconfiguration process, tensors and metadata, etc. included in the JSON file may be modified to be included in module, node, and edge. Accordingly, the user terminal 300 may integrate or change the first schema (e.g., backend schema) into the second schema for rendering a graph to facilitate rendering of the user terminal 300 and subsequent modification of the artificial intelligence model.

The user terminal 300 may complete graph visualization into a topology of a graph format (535). For example, step 535 may correspond to an output step of a visualization result. For example, step 535 may correspond to a rendering process of the user terminal. The user terminal 300 may render a topology of a graph format for the artificial intelligence model using the reconfigured structured text data and visually present it to a user. For example, the user terminal 300 may render a topology (e.g., a model structural diagram) based on a schema (e.g., the second schema) reconfigured with only module, node, and edges, and generate detailed information (e.g., metadata and attribute) corresponding to the topology. Such detailed information may be displayed in relation to the rendered topology according to a user input in a rendering result.

Like this, steps 505 to 535 in FIG. 5 exemplarily show features where visualization (e.g., rendering) of the artificial intelligence model is performed through interaction between the server 200 and the user terminal 300 according to a model visualization request. Steps 540 to 570 in FIG. 5 to be described later exemplarily show interaction between the user terminal 300 and the server 200 performed as a user input (e.g., a change (modification) input) is received on the rendered topology. For example, steps 540 to 570 may represent interactive editing steps of the artificial intelligence model.

The user terminal 300 may receive a user input on the rendered topology (540). The user terminal 300 may receive an input of a model modification request (e.g., a topology change request through visual interaction of a user) from the user. According to interaction between the user terminal 300 and the user on the rendered topology, an event related to a change of the rendered topology and/or a change of the artificial intelligence model accordingly may be generated. On the rendered topology, user inputs related to node deletion, node addition, edge addition, edge deletion, node change, and/or edge change may be received. For example, the user terminal 300 may detect a user input selecting (e.g., right-clicking a mouse, etc.) a specific area (e.g., a node, an edge, or an empty space) on the rendered topology. In response to this, the user terminal 300 may display a topology change option object (e.g., a context menu) having a correlation with the selected area. A user input requesting a specific change such as node deletion and edge creation may be additionally obtained through the topology change option object.

The user terminal 300 may determine a type of the change request based on the user input, and determine whether to interact with the server 200 and/or information to transmit for interaction according to the determined type. In a case of a simple node location change where a connection structure of nodes and edges is not changed, it is determined that interaction with the server 200 is unnecessary, and re-rendering (570) may be immediately performed within the user terminal 300 without a request to the server 200. When a structural change of the artificial intelligence model occurs, such as creation, deletion, and attribute change of nodes and/or edges, it is determined that interaction with the server 200 is necessary, and a change information transmission step (545) to the server 200 may be performed for interaction with the server 200.

The user terminal 300 may transmit change information to the server 200 (545). Step 545 may correspond to a communication step of the change request between the user terminal 300 and the server 200. The user terminal 300 may identify information necessary for change of the intermediate representation structure and generation of changed structured text data, and transmit it to the server 200 for topology change according to the user input. For example, the user terminal 300 may perform re-rendering (570) on the user interface according to the user input and asynchronously transmit the change information to the server 200. Transmitted information may vary according to a change type. For example, the user terminal 300 may transmit an ID of a node to be deleted upon node deletion and transmit IDs of a start node and an end node upon edge creation.

The server 200 may perform backend model modification and data regeneration according to the change request. The server 200 may request modification for the intermediate representation structure based on the change information (550). Such a request (550) may be performed through communication between internal entities of the server 200 or communication between entities outside the server 200 and the server 200. For example, the server 200 may call an API of an entity of the server 200 for the received change request and modify the intermediate representation structure using a called result.

The server 200 may obtain or generate a modified intermediate representation structure according to the change request (555). The server 200 may receive the change information (e.g., the change request) (550) from the user terminal 300, call an API, and modify the intermediate representation structure (e.g., Python object). An entity in the server 200 returns the modified intermediate representation structure (555), and the server 200 may generate a new intermediate representation structure (i.e., the modified intermediate representation structure of step 555) in which changes are reflected from the modified object. In this manner, since the server 200 can generate an artificial intelligence model in which changes are reflected, synchronization between the artificial intelligence model at the server 200 side and the rendered topology at the user terminal 300 side can be implemented.

The server 200 may extract modified model information from the modified intermediate representation structure (560). Step 560 may be implemented in a manner corresponding to step 520. For example, the server 200 may extract information (e.g., attribute values) from the modified intermediate representation structure (555) which is a return result. The server 200 may extract information such as nodes, tensors, and/or metadata necessary for reconfiguration of the intermediate representation structure using attribute values included in the intermediate representation structure.

The server 200 may regenerate structured text data in which the change information is reflected and transmit the regenerated structured text data to the user terminal 300 (565). Step 565 may be implemented in a manner corresponding to step 525.

The user terminal 300 may perform re-rendering of the topology of the graph format (570). The user terminal 300 may perform immediate (or prompt) re-rendering. For example, immediately after the user input (540), the user terminal 300 may immediately reflect requested changes on the user interface and perform re-rendering (570) of the topology of the graph format without waiting for a response (e.g., response in step 565) of the server 200. This can provide fast visual feedback to the user. The user terminal 300 may perform change processing in a different manner according to a result included in the response (565) from the server 200 after re-rendering (570). For example, when the response (565) from the server 200 includes a change success (or a success response), the user terminal 300 may integrate or update detailed information (e.g., new node ID generated in the server 200 and/or changed metadata, etc.) of the already re-rendered topology using the structured text data received from the server 200. For example, when the response (565) from the server 200 includes a change failure (or a failure response), the user terminal 300 may perform a roll-back returning the re-rendered topology to a state before modification.

Accordingly, since a technique according to an embodiment of the present disclosure implements an optimistic update manner in which a UI immediately reflects changes without waiting for a response of the server 200 when a user directly manipulates a topology on a GUI, a technical effect that immediate and seamless visual feedback can be provided to the user may be achieved. This reduces cognitive load of the user, and maximizes workflow in a repetitive model modification and experiment process, thereby greatly improving productivity.

In addition, since a technique according to an embodiment of the present disclosure implements an asynchronous synchronization mechanism of integrating detailed information upon change success or rolling back to a previous state upon change failure according to a final response from the server 200 after immediate re-rendering of the user terminal 300, a technical effect that responsiveness is provided to the user and simultaneously a state of a final model is guaranteed to always match a valid state verified in the server 200 may be achieved. Accordingly, an effect of securing integrity of data and stability of the entire system by fundamentally blocking reflection of potential errors or abnormal states on the UI to an actual model may be derived.

In addition, in a technique according to an embodiment of the present disclosure, instead of directly modifying complex codes, since it is allowed for a user to directly select and modify familiar graphic elements such as nodes and edges on a visually rendered topology, a technical effect that a barrier of expert knowledge on modeling can be significantly lowered may be achieved. A technique according to an embodiment of the present disclosure may achieve a technical effect of increasing accessibility to AI model development and promoting collaboration by shifting a task of modifying an internal structure of an AI model from code-centric to visual-centric.

In addition, logic for changing a structure of an actual artificial intelligence model in a technique according to an embodiment of the present disclosure may be centrally processed in the server 200. Accordingly, even if a user attempts a logically impossible connection on the UI, a technical effect that generation of an AI model of a valid structure is always guaranteed since the server 200 verifies and processes this may be achieved. This may lead to preventing errors that may occur in a complex model modification process and guaranteeing quality and reliability of a modified model.

The user terminal 300 may receive a model download request from the user and transmit the received download request to the server 200 (575). The server 200 may transmit a model file or transmit a link (e.g., URL) for model download to the user terminal 300. For example, when the user terminal 300 requests download (575) to save a modified artificial intelligence model completed through visualization and modification as an actual file, the server 200 may transmit (580) a corresponding model file or a download link corresponding to the intermediate representation structure stored in the server 200 to the user terminal in response to this.

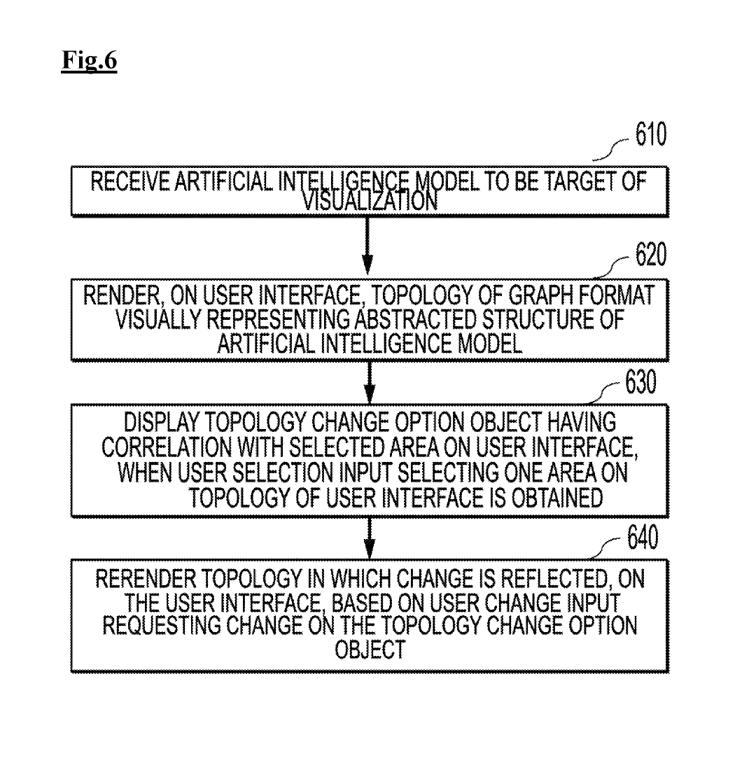

FIG. 6 illustrates an exemplary method for visualization of an artificial intelligence model according to an embodiment of the present disclosure.

Steps illustrated in FIG. 6 are exemplary steps, and additional steps may be included or some of steps in FIG. 6 may be omitted or replaced according to an implementation aspect. For example, the computing device 100 in FIG. 6 may correspond to a user terminal.

In an embodiment, the computing device 100 may receive an artificial intelligence model to be a target of visualization (610).

For example, the computing device 100 may receive structured text data in which an intermediate representation structure is reconfigured into a first schema from the server 200. For example, the artificial intelligence model received by the computing device 100 (e.g., the user terminal) in FIG. 6 may correspond to the structured text data transmitted from the server 200. In step 610, the computing device 100 may receive information related to an AI model to be a target of analysis and visualization.

In an embodiment, the computing device 100 may render a topology of a graph format that visually represents an abstracted structure of the artificial intelligence model on the user interface (620).

For example, the computing device 100 may generate a visualization expression corresponding to the artificial intelligence model by abstracting the artificial intelligence model using the received structured text data. This may represent a process of converting and displaying an abstracted AI model structure (e.g., an intermediate representation structure) into a graphic form that a user can perceive. Based on the received model-related data, the computing device 100 may render a topology of a graph format composed of nodes (operation units) and edges (data flows) on the user interface. For example, the computing device 100 may visually express a basic architecture of the AI model, that is, a connection relationship of nodes and edges. The computing device 100 may render an unsupported node not supported by a specific platform (e.g., hardware) or an inefficient node causing performance degradation when executed, to be visually distinguishable from other nodes (e.g., displaying with a warning color or an icon). When comparing two models, the computing device 100 may identify a differential node existing only in one model, and render the differential node to be clearly distinguished from common nodes by applying a predefined visual attribute, such as green for an added node and red for a deleted node. The differential node in the present disclosure may be used in a sense encompassing not only added and deleted nodes but also optimized (e.g., pruning, quantization, operator type change, operator fusion, etc.) nodes. As another embodiment, the computing device 100 may dynamically vary and render a color of a node such that saturation or luminance of a color gradient is proportional to a size of a performance value based on a node performance value (e.g., SNR score) included in metadata of the node.

In an embodiment, when a user selection input selecting one area on the topology of the user interface is obtained, the computing device 100 may display a topology change option object having a correlation with the selected area on the user interface (630).

The computing device 100 may perform interaction with a user on the rendered topology to grasp a change intention corresponding to a user input and generate a re-rendering result according to the change intention. For example, the computing device 100 may provide a context-aware editing tool on the user interface in response to the user input.

For example, a correlation may exist between a location of the user input (e.g., a selection area) on the rendered topology and a topology change option. A topology change option may be mapped and managed for each of areas on the rendered topology. The computing device 100 may display a topology change option object (e.g.: a context menu for change) containing executable change options according to a location of an area corresponding to the user's selection input on the rendered topology. Display of such a topology change option object may be performed on the computing device 100 without interaction with the server 200.

In an embodiment, a rendering result on the user interface may be classified into a plurality of areas, and a corresponding topology change option object may be assigned to each of the plurality of areas. For example, when the user's selection input selects a specific node area within the user interface, the topology change option object may display options such as movement of the node, deletion, or creation of an edge starting from the node. As another example, when the user's selection input selects a specific edge area within the user interface, the topology change option object may display a deletion option of the edge. As another example, when the user's selection input selects a residual area (empty space) without nodes or edges within the user interface, the topology change option object may display a new node creation option (e.g., a new node creation at the selected location). Like this, different objects including different contents related to a change of the topology may be output according to a location selected by the user on the user interface.

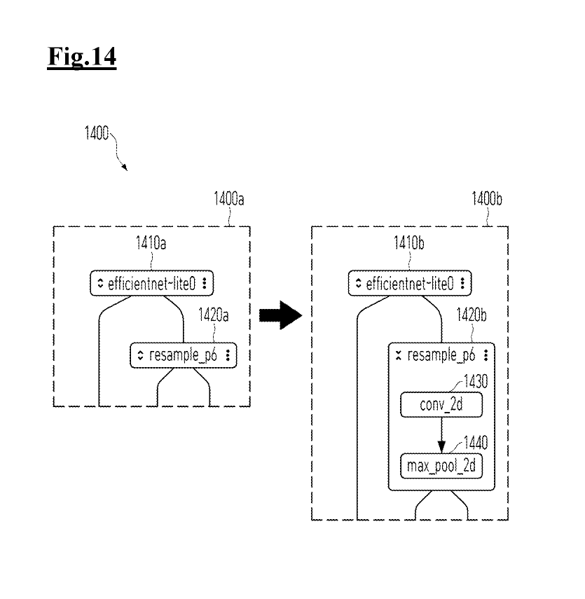

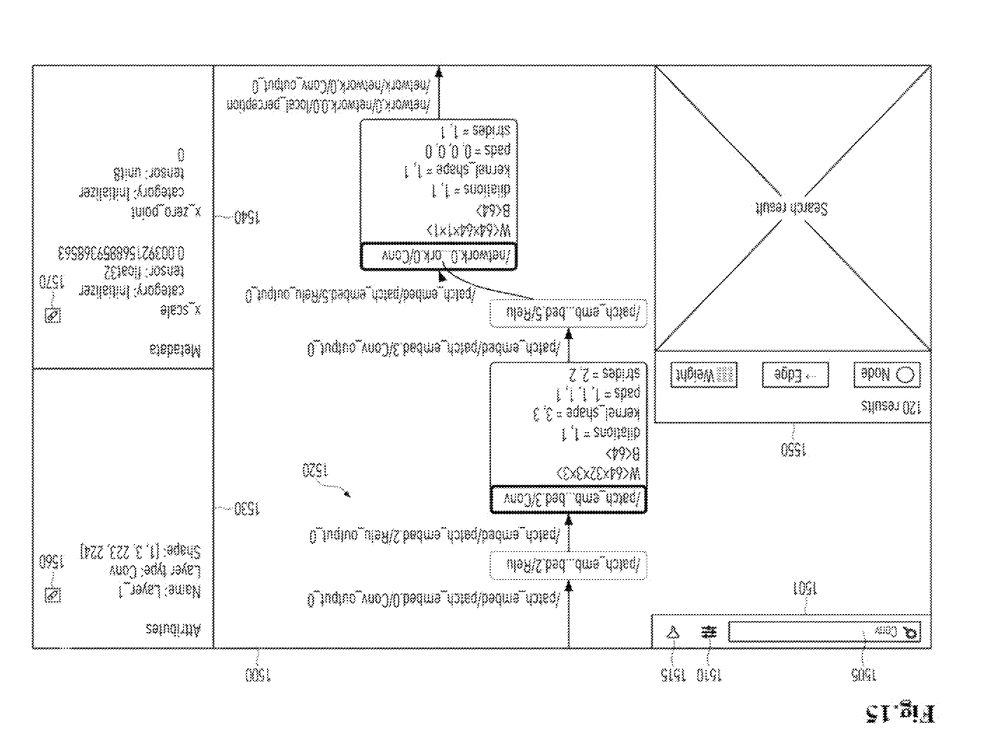

In an additional embodiment, implementation of displaying a different topology change option object according to a type of the user selection input may also be possible. For example, when the user's selection input is a first selection input such as a mouse right-click, the topology change option object may be displayed, and when it is a second selection input such as a left-click, a detailed information window displaying an attribute and/or metadata of the corresponding node may be displayed. For example, in response to a user input selecting one area of a node in the rendered topology (e.g., an additional information display input), the computing device 100 may re-render the topology such that the selected node and a plurality of sub-nodes constituting the node are displayed together in a state where a connection structure between the selected node and a neighbor node is maintained. A specific example of this feature will be described later in FIG. 14.

The change in the present disclosure may be used in a sense encompassing not only changing a structure of the artificial intelligence model but also optimization (e.g., compression and graph optimization, etc.) and quantization of the artificial intelligence model.

In an embodiment, the computing device 100 may re-render a topology in which a change is reflected, on the user interface, based on a user change input requesting the change on the topology change option object (640).

In an embodiment, when a user change input requesting a structural change such as node deletion or creation is received on the topology change option object, the computing device 100 may re-render the topology according to the user change input. For example, the computing device 100 may reflect changes on the user interface without waiting for a response of the server 200 and vary additional operations according to the response of the server 200 depending on contents of the response of the server 200. For example, when receiving a change success response from the server 200 after immediate re-rendering, the computing device 100 may confirm a final state of the re-rendered topology by integrating detailed information (e.g., ID of a newly created node) transmitted from the server 200 into the already re-rendered topology. For example, when receiving a change failure response from the server 200 after immediate rendering, the computing device 100 may perform a roll-back canceling changes reflected on the user interface and returning to a topology state before the change. For example, when the user's change request input is a simple node location movement or simple edge location movement unnecessary for interaction with the server 200, the computing device 100 may perform re-rendering only within the user interface of the computing device 100 without a request to the server 200 and end a re-rendering process.

In an embodiment, in a process where the computing device 100 performs re-rendering in response to the user change input, nodes before and after a node to be changed and related edges may be considered together. For example, when the user change input changing a node is obtained on the topology change option object, a target node object to be a target of the change, a target edge object connecting the target node object, and a neighbor node object connected to the target node object through the target edge may be recognized together as targets of a topology change. For example, the computing device 100 may transmit information on the recognized objects to the server 200. As another example, the computing device 100 may transmit only information on the target node object to the server 200, and the server 200 may additionally recognize a target edge object connecting the target node object and a neighbor node object connected to the target node object through the target edge using the transmitted information, and change or regenerate a corresponding intermediate representation structure and/or structured text data.

In an embodiment, when the user change input creating a new node is obtained on the topology change option object, the computing device 100 may display a new node object at a location related to the selected area and display a new node option object requesting an additional input related to the new node object. For example, the new node option object may include a first option object for moving the new node object, a second option object for creating an edge related to the new node object, and/or a third option object for deleting the new node object or deleting another node. In response to receiving the additional input requesting creation of a target edge object related to the new node object on the new node option object, the computing device 100 may re-render a topology changed to include the new node object and target edge objects connecting the new node object with neighbor node objects of the new node object on the user interface.

In an embodiment, when the user change input on the topology change option object includes new node creation, if a target node to be a target of creation is determined, a target edge connecting the target node and neighbor nodes may be automatically generated by the computing device 100. For example, the computing device 100 may automatically identify neighbor nodes connected to the target node using location information within the topology of the target node to be created, and automatically generate and render a target edge connecting the identified neighbor nodes and the target node.

In an additional embodiment, when a new node is created or determined, the target edge may be automatically generated through a manner of automatically recognizing neighbor node(s) of the new node.

In an embodiment, when the new node object is rendered, re-rendering of the topology may be implemented in a manner of highlighting a connection result between the new node object and neighbor node objects. For example, the computing device 100 may re-render a highlighted topology on the user interface such that the new node object and the neighbor node objects are distinguished from other node objects on the changed topology. For example, a manner of distinguishably displaying colors of node objects, distinguishably displaying shapes of node objects, or adding distinguishable text information to related node objects may be considered.

In an embodiment, when the user change input deleting a node object is obtained on the topology change option object, the computing device 100 may delete a node object related to the selected area and replace first edge objects related to the deleted node object with a second edge object connecting neighbor node objects related to the deleted node object. Accordingly, edges related to the deleted node may be set to be connected to neighbor nodes instead of the deleted node. The computing device 100 may implement automatic connection of edges according to node deletion by re-rendering a topology in which the deleted node object and the second edge object are reflected, on the user interface.

In an embodiment, when the user change input deleting an edge object is obtained on the topology change option object, the computing device 100 may delete an edge object related to the selected area and move at least one of node objects and edge objects on the topology based on a location of the deleted edge object. Accordingly, location rearrangement of the rendered topology according to the deleted edge may be achieved. The computing device 100 may reconfigure a topology in which edge deletion is reflected by re-rendering a topology in which the deleted edge object and the moved object are reflected, on the user interface.

As described above in previous drawings, the computing device 100 determines whether to interact with the server for re-rendering of the topology based on a change type determined according to the user change input determined according to interaction with the user, and by performing interaction with the server 200 according to such determination, efficient synchronization between backend data stored in the server 200 and frontend data output on the user interface may be implemented.

A technique according to an embodiment of the present disclosure may implement context-aware interaction that selectively provides only modification options related to a corresponding selection area on the user interface when a user selects a specific area on the topology. For example, contents of the topology change option object displayed when selecting a node and when selecting an empty space may be different. Such a technical feature does not expose unnecessary or invalid options to the user, thereby reducing cognitive load of the user and achieving a technical effect of preventing manipulation mistakes in a complex GUI environment. Through a technique according to an embodiment of the present disclosure, since the user can focus only on tasks executable in a current context, a technical effect that user convenience and accuracy of tasks can be greatly increased may be derived.

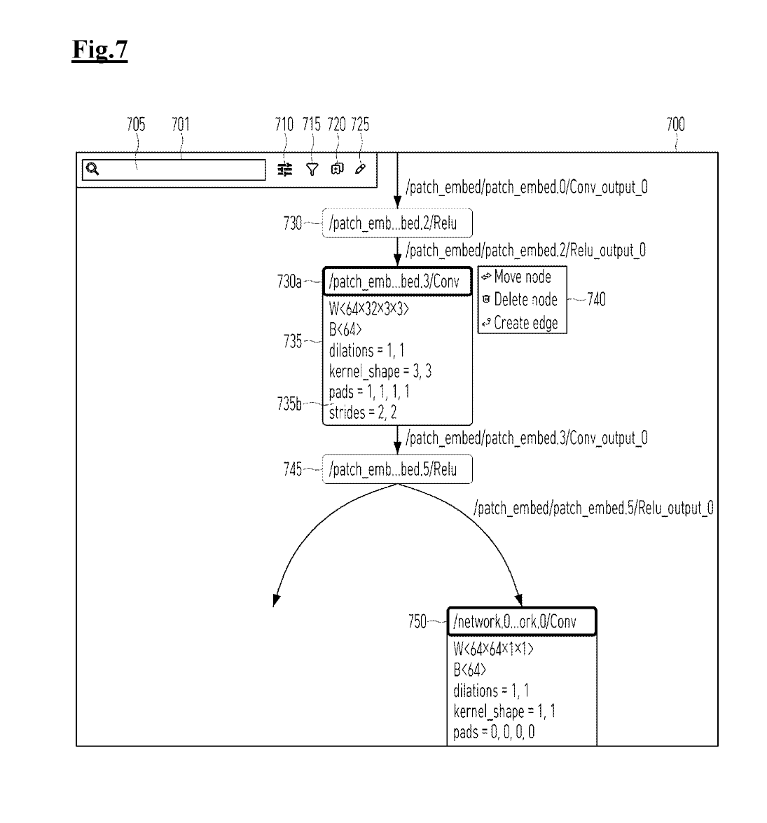

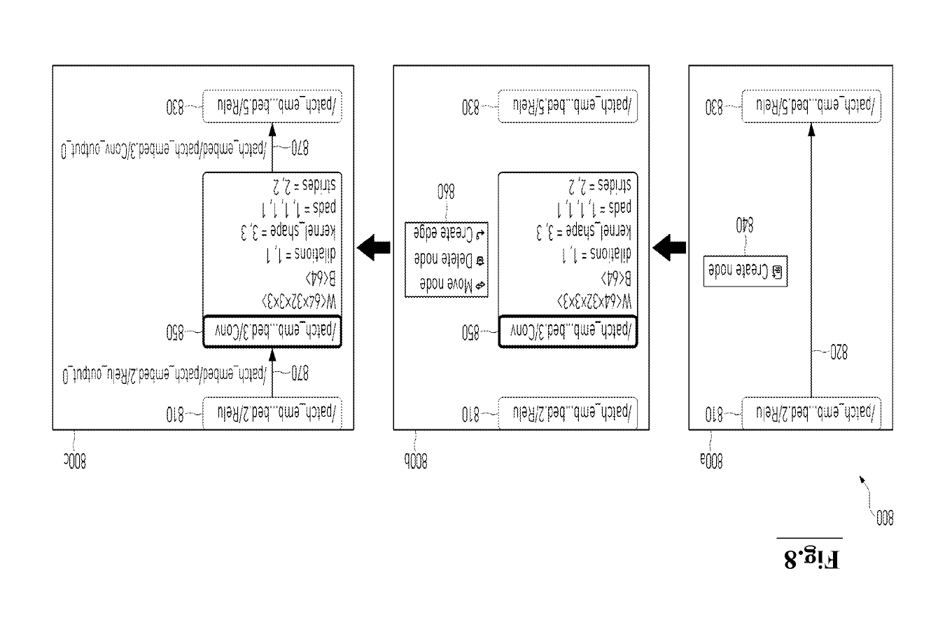

FIG. 7 exemplarily illustrates topology re-rendering of a user interface according to a user change input according to an embodiment of the present disclosure.

In a user interface 700 illustrated in FIG. 7, a plurality of objects 705 to 750 are exemplarily expressed. Objects described below may correspond to UI objects. The computing device 100 in FIG. 7 may correspond to a user terminal.

The user interface 700 may include a first area displaying a topology of a graph format, a second area including a search input object 705 for receiving a search input within the topology, a display option object 710 for determining a display manner of components within the topology, and an exposure option object 715 for determining exposure or hiding of the components within the topology, and a third area displaying at least one of an attribute and metadata internalized in a node within the topology and allowing a modification input for at least one of the attribute and the metadata. As a non-limiting example, the second area including the search input object 705, the display option object 710, and the exposure option object 715 may occupy one area of an upper portion or an upper left portion of the user interface 700, the third area may occupy a right area of the user interface 700, and the first area displaying the topology may generally occupy remaining areas of the user interface 700.

The user interface 700 may include a toolbar object 701 allowing a search within the rendered topology, providing viewing options, and providing exposure option filters. For example, the toolbar object 701 may include the search input object 705 receiving a search input for searching whether a specific expression exists within the topology. Screen movement to a node and/or an edge corresponding to a search result within the rendered topology may be automatically performed according to a result searched on the search input object 705. The node and/or the edge corresponding to the search result may be highlighted in a form different from objects not corresponding to the search result. For example, the toolbar object 701 may include the display option object 710. The display option object 710 may be used to set information to be displayed and information not to be displayed within the user interface 700. For example, when the display option object 710 is selected, a user selection option object allowing selection on whether to display an edge index, whether to display a tensor or an edge, and/or whether to display a weight may be output on the user interface 700. For example, the toolbar object 701 may include the exposure option object 715. The exposure option object 715 may be used to determine data to filter on the user interface 700. When a user selection input on the exposure option object 715 is received, a user selection option object allowing selection on whether to filter specific metadata, for example can be output as an exposure option.

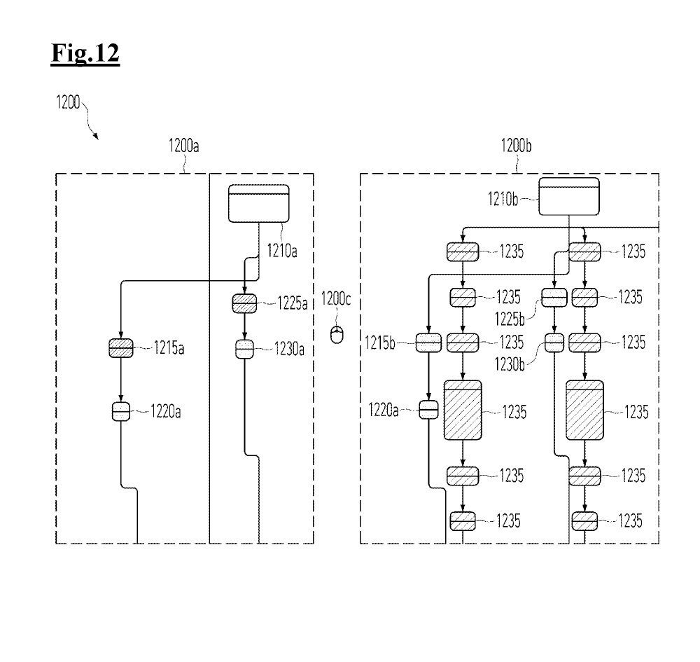

The toolbar object 701 may further include a model comparison mode activation object 720 for activating a model comparison mode. When a user selection input on the model comparison mode activation object 720 is received, a currently rendered topology may be output on the first area of the user interface 700, and an input area for allowing an input for a new artificial intelligence model may be displayed on the user interface 700. A detailed description thereof will be described later in FIG. 11.

The toolbar object 701 may further include a model editing mode activation object 725 for activating a model editing mode. When a user selection input on the model editing mode activation object 725 is received, the user interface 700 may allow receiving a user input for model change or model modification according to an embodiment of the present disclosure. For example, before receiving the user selection input on the model editing mode activation object 725, when a specific area of the rendered topology is selected, information (e.g., metadata and attribute, etc.) on the selected area may be output. When receiving the user selection input on the model editing mode activation object 725, if a specific area or a residual area of the rendered topology is selected, a topology change option object related to the corresponding area (e.g., having a correlation with the selected area) may be output on the user interface 700.

In an embodiment, the user interface 700 may be configured to enable search formula-based search (or search keywords-based search) through the search input object 705. For example, the computing device 100 may be configured to filter internal components, e.g., a specific operation or node, of the artificial intelligence model through the user interface 700. The search formula may include a combination of a plurality of predefined keys and values such as op_type, kernel_size, and params, and logical operators (e.g., AND, OR). A key used in the search formula may be defined as an identifier generalizing a unique attribute of each element constituting the artificial intelligence model. This may include a structure key (e.g.: op_type, kernel_size) representing a type of operation or structural characteristics, a tensor key (e.g.: input_shape, dtype) representing a form or type of data input/output to/from an operation, and a parameter key (e.g.: params, flops) related to performance such as trainable weights or operation amount. Specifically, a user can accurately identify only desired nodes by simultaneously designating an operation type and a kernel size like 'op_type: Conv AND kernel_size: [3,3]', or by setting the number of parameters and an activation function as conditions like 'params > 10000 AND activation: ReLU'. The user interface 700 may output a rendered topology. The rendered topology may represent a graph visualized result for the artificial intelligence model. The rendered topology may be expressed by a plurality of nodes 730, 735, 745, and 750 and edges connecting the nodes as in the example of FIG. 7. The topology may be composed of a plurality of nodes representing operation units of the artificial intelligence model and edges connecting them.

In an embodiment, the computing device 100 may group nodes such that the nodes are distinguishably displayed according to operation characteristics or attributes of the nodes. For example, the nodes 730 and 745 may represent a Rectified Linear Unit (ReLU) operator. ReLU is an activation function widely used in deep learning models, and functions to increase expressive power of a model by performing non-linear transformation that outputs 0 if an input value is less than 0 and outputs the input value as it is if it is greater than 0. The nodes 730 and 745 may configure a topology on the user interface 700 in a form of displaying identification information on the nodes. The nodes 735 and 750 may represent a Convolution operator. A convolution operation is an operation mainly used in computer vision models, and performs a function of extracting a feature map by applying a trainable filter (e.g., kernel) to input data (e.g., an image). In the user interface 700 of FIG. 7, the node 735 may be provided in a form of displaying attribute information 735a defining detailed operations of an operation such as kernel_shape and strides, etc. together with identification information 735b of the node. The computing device 100 may vary display information on a node on the user interface 700 according to operation characteristics of nodes. The nodes 730 and 745 and the nodes 735 and 750 of FIG. 7 are grouped with corresponding nodes, and the user interface 700 may display the nodes in a manner that groups are distinguished from each other.

According to an embodiment of the present disclosure, the user interface 700 may edit a structure of the artificial intelligence model based on interaction between the rendered topology and the user. Editing, changing, and modifying in the present disclosure may be used interchangeably according to an implementation aspect.

In an embodiment, when a user selection input selecting one area on the user interface 700 is obtained, the computing device 100 may display a topology change option object having a correlation with the selected area on the user interface 700. The correlation may refer to a logical association relationship for selectively providing only valid editing options applicable to a corresponding element according to a type and/or a location of a graphic element selected by the user on the user interface 700. A correlation may exist between a location of the user input on the user interface 700 and editing options output on the user interface 700. That is, a correlation may exist between a type and/or a location of the user input on the user interface 700 and editing options output on the user interface 700. When the type and/or the location of the user input on the user interface 700 is different, editing options of different contents may be output. Based on such a correlation, a technical effect that the user interface 700 filters unnecessary or invalid options in advance and intelligently presents only editing options most consistent with the user's intention may be achieved. In addition, such a topology change option object 740 may perform a role of assisting the user to edit a complex topology structure more intuitively and efficiently.

As illustrated in FIG. 7, when a user selection input selecting a node area occupied by a Conv node 735 is received from the user, the computing device 100 may recognize that the user selection input represents a context of a node based on a location of the selected area and a type of a related UI object. When receiving a user selection input (e.g., mouse click and touch input) selecting a node area occupied by a specific node 735 on the topology from the user, the computing device 100 may display a topology change option object 740 having a correlation with the selected area. Since the selected area is detected as a node area, the topology change option object 740 may include change options such as movement of a node object (Move node), deletion of a node object (Delete node), and creation of an edge object related to a node object (Create edge). Thereafter, when receiving a user change input selecting a specific option (e.g., Delete node) on the topology change option object 740 from the user, the computing device 100 may re-render a topology in which a change is reflected, such as deleting a corresponding node and reconnecting related edges based on the user change input. This process may include, for example, replacing first edge objects related to the deleted node object with a second edge object connecting neighbor node objects.

For example, when the user input selects a movement option of a node object, the corresponding node may be moved to a desired location on the topology in a drag-and-drop manner by re-rendering. In this example, re-rendering may be performed by the computing device 100 without communication with the server, and if an input related to refresh is received from the user, the moved node may be returned to an original location. For example, when the user input requests deletion of a node object, the computing device 100 may perform re-rendering of deleting the selected node object and creating a new edge directly connecting neighbor nodes by automatically recognizing a connection point broken due to deletion of the corresponding node. For example, when a user input selects an edge and requests deletion, the corresponding edge is deleted and the topology is re-rendered accordingly. For example, re-rendering in which a new node object is created through a user selection input such as a mouse right-click in an empty residual area in a topology graph may be implemented. The created new node object may be connected with a new edge through an additional input of selecting another neighbor node object that the user wants to connect, and a topology in which such changes are reflected may be re-rendered.

When an input selecting an edge area occupied by an edge object connecting two nodes (e.g., 730 and 735) is received from the user, the computing device 100 may recognize a context for the user's selection as an edge based on a location of the selected area and/or a type of a UI object. In this case, according to a correlation with the edge, the topology change option object 740 may preferentially or solely display an option specialized for an edge, such as deletion of an edge object.

In addition, when a user input selecting a residual area (e.g., a background portion of FIG. 7) not occupied by both a node and an edge on the topology is received from the user, the computing device 100 may recognize a context of the selected area as an empty space. According to a correlation with the recognized context, the user interface 700 may display a creation option of a new node object for adding a new element to the corresponding space through the topology change option object 740.

FIG. 8 exemplarily illustrates topology re-rendering of a user interface 800 according to a user change input according to an embodiment of the present disclosure.

FIG. 8 exemplarily illustrates a process of creating a new node object step by step (800a, 800b and 800c) among topology change methods according to an embodiment of the present disclosure. The computing device 100 in FIG. 8 may correspond to a user terminal.

Referring to reference numeral 800a of FIG. 8, a part of a topology including a first node 810 and a second node 830 and an edge 820 connecting them is rendered on the user interface 800. A user selection input selecting a residual area between the first node 810 and the second node 830, which is not occupied by another node or another edge, may be received from a user. In response to this, the computing device 100 may display a topology change option object 840 including an option indicating creation of a new node object (Create node) on the user interface 800 based on a correlation with the selected area.

When a user change input selecting a Create node option on the topology change option object 840 is received from the user, the computing device 100 may re-render a topology in which a change is reflected as shown in reference numeral 800b of FIG. 8. Specifically, the re-rendering step may display a new node object 850 (e.g., a node representing a Conv operator) at a location related to the selected area. Along with creation of the new node object 850, the computing device 100 may display a new node option object 860 capable of requesting an additional change related to the new node object 850. The new node option object 860 may include, for example, an option for moving a location of the new node object 850 (Move node), an option for deleting the corresponding object 850 (Delete node), and an option for creating an edge object related to the corresponding object 850 (Create edge).

When receiving an additional input requesting creation of a target edge object such as Create edge on the new node option object 860 from the user, the computing device 100 may re-render a changed topology as shown in reference numeral 800c of FIG. 8. The re-rendering step may change and display the topology to include target edge objects 870 which connect the new node object 850 with neighbor node objects of the new node object 850, that are, the first node 810 and the second node 830. In addition, the re-rendering step may apply a highlight display (e.g., red border display) such that the created new node object 850 and neighbor node objects 810 and 830 connected thereto are visually distinguished from other node objects within the topology on the changed topology. This may lead to a technical effect of improving usability of the user interface 800 by enabling the user to clearly recognize a range (e.g., a scope) of topology change.

Text displayed around the edge object 870 in the user interface 800 may represent, for example, data flowing between two nodes, that is, an identifier of a tensor. For example, the upper edge object 870 may indicate that it is a first (0-indexed) output of the node 810 having a name of '/patch_emb_bed.2/Relu'. Such a tensor identifier may generally consist of a combination of identification information of a source node generating data and an index identifying an output of the corresponding node. Some operators (e.g., nodes) of the artificial intelligence model may have multiple outputs, and in such a situation, the tensor identifier may indicate which output of a corresponding node it is. Accordingly, a path of data can be clearly specified even within a topology of a complex structure.

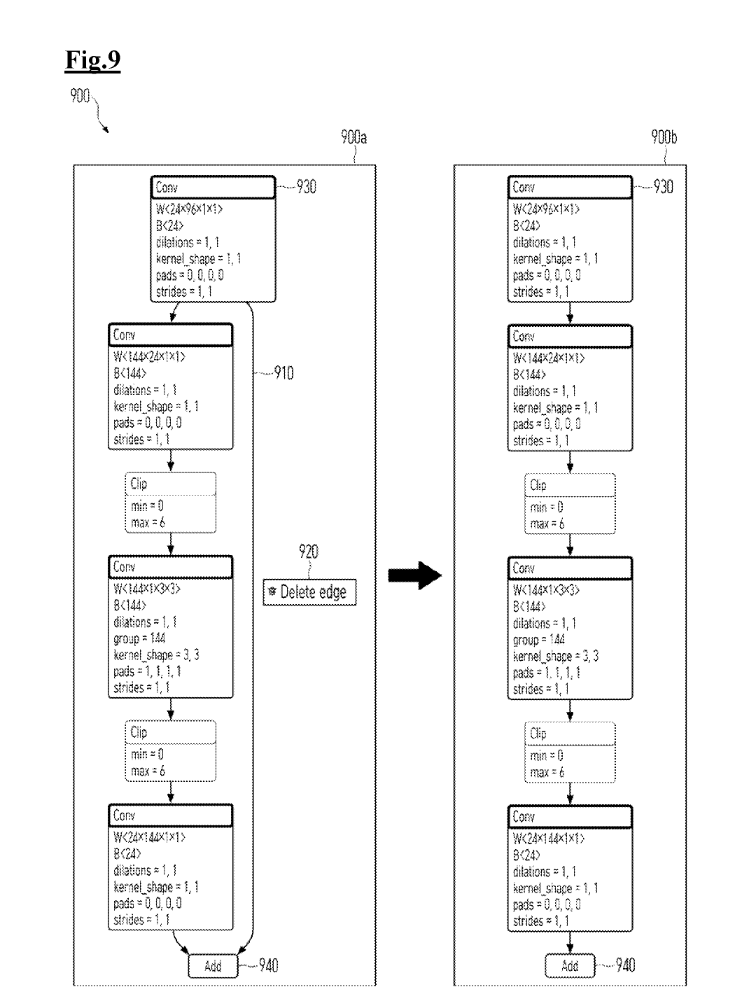

FIG. 9 exemplarily illustrates topology re-rendering of a user interface 900 according to a user change input according to an embodiment of the present disclosure.

FIG. 9 is an exemplary diagram illustrating a process of deleting an edge object step by step (900a and 900b) among re-rendering methods according to a topology change according to an embodiment of the present disclosure.

Referring to reference numeral 900a of FIG. 9, a topology 900 including a plurality of node objects (e.g., a Conv node 930 and an Add node 940, etc.) and edge objects connecting them is rendered on the user interface 900. The computing device 100 (e.g., user terminal) may receive a user selection input selecting an edge area occupied by a specific edge object 910 on the topology 900 from a user. In the example of FIG. 9, the selected edge object 910 corresponds to an edge directly connecting a first Conv node 930 and an Add node 940. When the user selection input is obtained, the computing device 100 may display a topology change option object 920 including an option indicating deletion of the edge object 910 (Delete edge) on the user interface 900 based on a correlation with the selected edge area. For example, as illustrated in FIG. 9, the topology change option object 920 may be displayed around the selected edge object 910.

Reference numeral 900b exemplarily shows a result of topology re-rendering in which edge deletion is reflected. When receiving a user change input selecting a Delete edge option on the topology change option object 920 from the user, the computing device 100 may re-render a topology 900b in which a change according to the user's change input is reflected. In the re-rendered topology 900b, it can be confirmed that the edge object 910 related to the selected area has been deleted according to the user's change request. Consequently, a data flow path directly connecting the first Conv node 930 and the Add node 940 is removed, and a connection structure of the topology may be changed accordingly. Like this, the present disclosure may provide the user interface 900 capable of easily editing a topology of an artificial intelligence model by allowing intuitive interaction for a user to directly select and delete an edge visually.

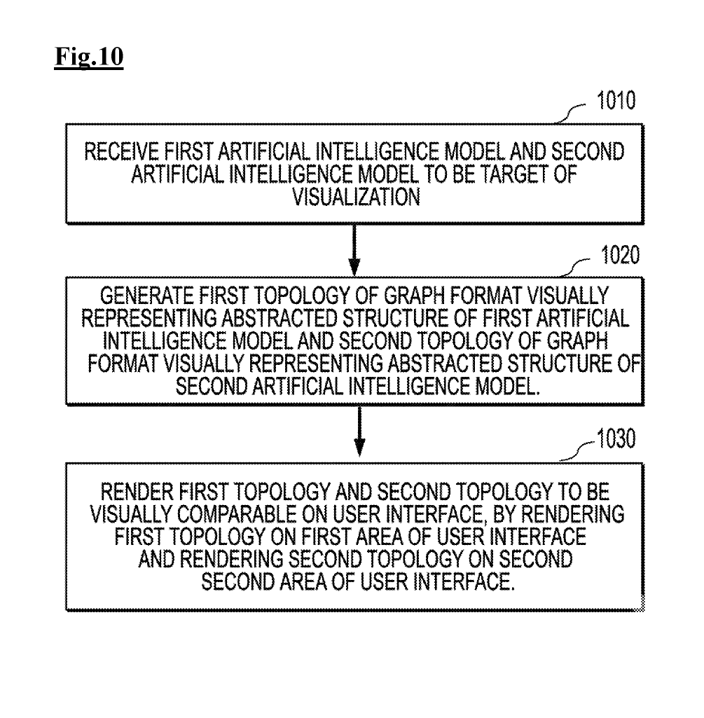

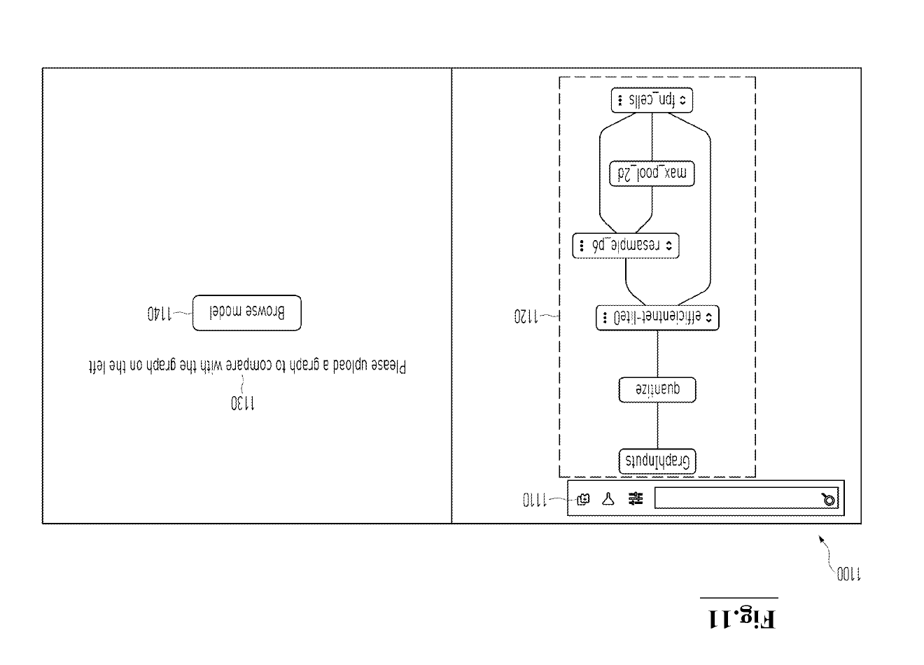

FIG. 10 illustrates an exemplary method for providing a user interface for visualization of an artificial intelligence model according to an embodiment of the present disclosure. FIG. 10 exemplarily shows a flowchart illustrating an overall operation of a method for comparing and visualizing a plurality of artificial intelligence models according to an embodiment of the present disclosure.

According to an implementation aspect, some steps in the flowchart in FIG. 10 may be omitted or replaced, and an embodiment in which additional steps are added to the flowchart may also be possible. The computing device 100 in FIG. 10 may correspond to a user terminal.

In an embodiment, the computing device 100 may receive a first artificial intelligence model and a second artificial intelligence model to be targets of visualization (1010).

Step 1010 may correspond to an initial data acquisition step for visually comparing a structural difference between two models. The first artificial intelligence model and the second artificial intelligence model are models to be targets of comparison, and may represent two models selected by a user and/or may represent an original model and a derived model in which modification or optimization is applied to the original model.

In an embodiment, according to various user scenarios, step 1010 may include the following examples. In one example, the computing device 100 may receive an original model as the first artificial intelligence model, and receive a model (e.g., a derived model) in which an optimization technique such as quantization or pruning is applied to the original model as the second artificial intelligence model to compare structural changes before and after optimization. In another example, the computing device 100 may receive two models having different architectures (e.g., receiving ResNet as the first artificial intelligence model and receiving EfficientNet as the second artificial intelligence model) to compare and analyze a topology difference between architectures of the models. In another example, the second artificial intelligence model may be a derived model generated based on a change by a user for the first artificial intelligence model previously visualized and edited by the user.

In an embodiment, the computing device 100 may generate a first topology of a graph format that visually represents an abstracted structure of the first artificial intelligence model and generate a second topology of a graph format that visually represents an abstracted structure of the second artificial intelligence model (1020).

For example, the graph format may refer to a structure including nodes representing operation units of an artificial intelligence model and edges connecting the nodes.

In an embodiment, the computing device 100 may generate a plurality of topologies of a graph format visually representing an abstracted structure of each of the received plurality of artificial intelligence models.

In an embodiment, a specific method for generating a topology of a graph format of the computing device 100 will be replaced with the above description.

In an additional embodiment, in a process of generating a topology, the computing device 100 may traverse nodes of models and compare node identification information (e.g., unique ID of a node), thereby identifying a differential node representing a structural difference between models.

In an embodiment, the computing device 100 may render the first topology and the second topology to be visually comparable on the user interface by rendering the first topology on a first area of the user interface and rendering the second topology on a second area of the user interface (1030).

For example, the first area and the second area are predetermined divided spaces on the user interface, and the first area may occupy a left area of the user interface and the second area may occupy a right area of the user interface.

The expression “rendering to be visually comparable” in the present disclosure may refer to organizing and providing visual information in a manner that assists a user to intuitively and efficiently perceive similarities and differences between two models, as well as simply displaying two or more model topologies side by side. This may refer to that the user interface actively processes and renders information related to topologies to achieve a specific purpose of comparison. Such comparison rendering may include all GUI technical treatments providing visual cues so that a user can discover structural differences between two models with minimal cognitive effort. This may be implemented through methods such as spatial arrangement, difference emphasis, and interactive linkage.

In a process of comparison rendering of topologies, the computing device 100 may traverse nodes of models and compare node identification information (e.g., unique ID of a node), thereby identifying a differential node representing a structural difference between models.

For example, the computing device 100 may traverse nodes of the second artificial intelligence model to generate the second topology, identify a node not existing in the first artificial intelligence model as an added node (e.g., a second differential node), and apply a second visual attribute (e.g., green highlight) indicating addition thereto. The computing device 100 may traverse nodes of the first artificial intelligence model, identify a node not existing in the second artificial intelligence model as a deleted node (e.g., a first differential node), and visually restore and add the corresponding node onto the second topology together with a first visual attribute (e.g., red highlight). The computing device 100 may generate and reconfigure a new connection relationship by traversing both the first and second artificial intelligence models so that an edge (e.g., connection relationship) of the added first differential node maintains a connection relationship before deletion. The computing device 100 may readjust a node location of the first topology (or the second topology) to align it with a common node location of the second topology (or the first topology) to facilitate visual comparison between two topologies.

For example, the computing device 100 may traverse the first artificial intelligence model, identify a node not present in the second artificial intelligence model as a deleted node (e.g., a first differential node), and display it on the first topology with a first visual attribute (e.g., red). In parallel (or serially), the computing device 100 may traverse the second artificial intelligence model, identify a node not present in the first artificial intelligence model as an added node (e.g., a second differential node), and display it on the second topology with a second visual attribute (e.g., green).

In a process of comparison rendering of topologies, the computing device 100 may identify a differential node by considering not only a node identifier or an edge identifier but also a history modified in a process of modifying or optimizing the first artificial intelligence model to the second artificial intelligence model. For example, when some nodes are deleted or added in a graph optimization and/or quantization process, a history reflecting which node is deleted, added, or changed is stored, and the computing device 100 may load the stored history in a model comparison process to identify deleted, added, or changed nodes.

The computing device 100 may identify a node commonly existing in models but having a changed attribute as a type of differential node. For example, when comparing models before and after quantization, if it is the same Conv node but a data type of a weight is changed, the computing device 100 may identify this as a node having a different attribute and include it in the differential node.

The differential node in the present disclosure may refer to a node in which a difference between artificial intelligence models exists. For example, the differential node may be used in a sense encompassing not only added and deleted nodes but also optimized (e.g., pruning, quantization, operator type change, operator fusion, etc.) nodes. For example, the differential node may represent a node representing a structural difference between artificial intelligence models and/or a node having a different attribute among nodes corresponding to each other in artificial intelligence models. For example, the differential node may be displayed in a manner that a shape or a color, etc. is distinguished from a common node upon rendering. For example, among differential nodes, different visual attributes may be assigned to a deleted differential node and an added differential node, and a visual attribute different from a common node may be assigned to each of such differential nodes. Being different in visual attribute may indicate that at least one of color and appearance (e.g., shape) is different.

The computing device 100 may implement re-rendering of topologies in a manner of identifying common nodes and differential nodes within a topology through comparison between a plurality of topologies and reconfiguring at least one topology based on an identification result. Reconfiguration of a topology may refer to a process of visually adding nodes or edges not existing in an original topology of either model to be compared, or creating a new visual structure optimized for a comparison purpose by changing an existing connection relationship. That is, reconfiguration of a topology may refer to rewriting visual blueprints for models based on identified differences so that a user can clearly and intuitively perceive differences between two models. For example, visually restoring and reconfiguring a deleted node, connecting edges according to a connection relationship of a deleted node, and/or creating a new virtual model structure by synthesizing information of two models may be included within a category of reconfiguration of a topology.

The computing device 100 renders the generated first topology on the first area of the user interface and the second topology on the second area, thereby displaying two topologies to be visually comparable, and such comparison rendering may include various rendering manners so that a user can intuitively perceive a difference between two models.

In an embodiment, the computing device 100 may perform rendering in a manner of automatically identifying differential nodes having a structural difference by comparing a plurality of topologies and applying a predefined visual attribute to the differential node. For example, when comparing a modified model (second topology) based on an original model (first topology), the computing device 100 may highlight and display a node deleted by existing only in the original model in red, and highlight and display a node newly added to the modified model in green. Through this, a technical effect that a user can immediately grasp which node is changed only by color without needing to compare two models one by one may be achieved.

In the present disclosure, an artificial intelligence model may be largely changed in two ways. The first way is a change through model editing, and such a change may be used in a sense encompassing node deletion, node addition, edge deletion, edge addition, and attribute change. The second is a change through model optimization, and such a change may be used in a sense encompassing graph optimization, quantization, and compression. Accordingly, a user change input may be used to intend a user input of a form encompassing such model editing and model optimization. For example, when the user change input relates to model editing, a node (or attribute value) selected or designated by a user may be deleted, added, and/or changed. For example, when the user change input relates to model optimization, a node (or attribute value) may be deleted, added, and/or changed as a model optimization tool of a server or a user terminal is applied to an artificial intelligence model (e.g., an intermediate representation structure) according to a model optimization request from a user.

In an embodiment, when a derived model in which a specific node is deleted due to a user change input for an original model exists, the computing device 100 may reconfigure the second topology by adding a node deleted due to the user change input and an edge related thereto onto a second topology corresponding to the derived model. By applying a visual attribute for identifying deletion to the deleted node on the second topology reconfigured in this way, visual comparison rendering between the second topology in which the user change input is reflected and the first topology corresponding to the original model may be implemented. The computing device 100 may correspond a display location of the first node (deleted node) on the first topology to a display location of the first node (deleted node) on the reconfigured second topology, and display such that a visual attribute of the first node on the first topology and a visual attribute of the first node on the reconfigured second topology are different from each other.

In an embodiment, when a derived model in which a first node is deleted and a second node is added due to a user change input for an original model exists, the computing device 100 may reconfigure the second topology by adding the first node deleted due to the user change input and a first edge related to the first node onto the second topology. The computing device 100 may perform comparison rendering for a plurality of models in a manner of applying a first visual attribute for identifying deletion to the first node, applying a second visual attribute for identifying addition to the second node added due to the user change input, and applying a third visual attribute to a common node commonly existing in the first artificial intelligence model and the second artificial intelligence model in a rendering process.

In an embodiment, according to an implementation aspect, implementation in which a deleted node is displayed on a topology of an original model and an added node is displayed on a topology of a derived model (or a changed model) may also be possible. For example, the computing device 100 may perform rendering to be visually comparable in a manner of displaying a first node to which a first visual attribute is applied on the first topology by applying the first visual attribute for identifying deletion to the first node deleted due to the user change input, and displaying a second node to which a second visual attribute is applied on the second topology by applying the second visual attribute for identifying addition to the second node added due to the user change input.

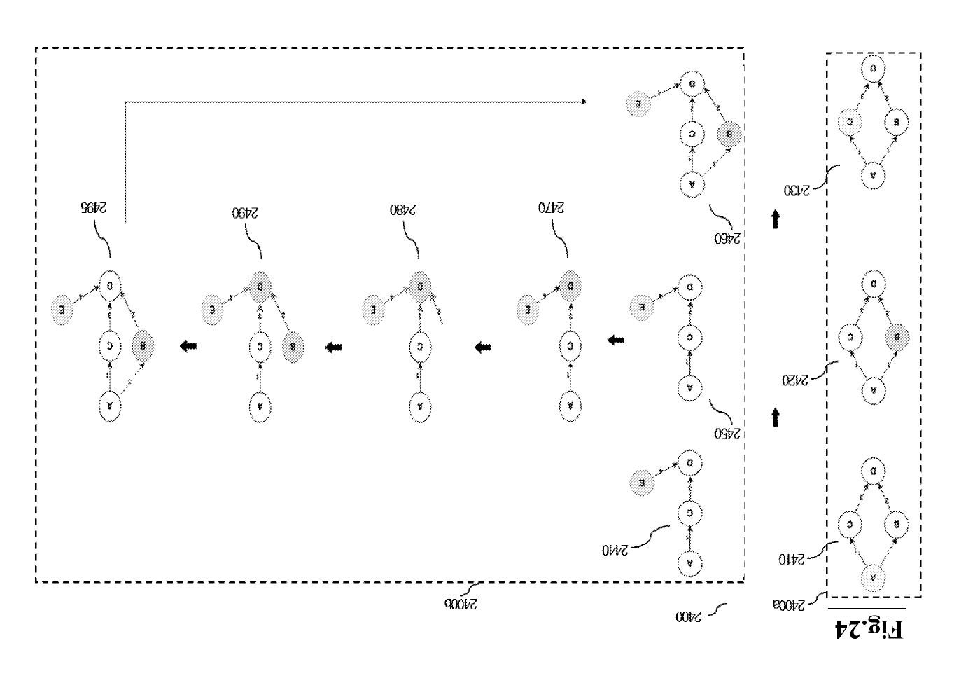

In an embodiment, the computing device 100 may compare a plurality of topologies using a virtual model structure. The virtual model structure in the present disclosure may refer to an integrated temporary data structure generated in a process of comparing a plurality of artificial intelligence models. The virtual model structure may serve as a standard for rendering a final comparison visualization result by synthesizing components (common nodes, added nodes, and deleted nodes) of a plurality of models and changed connection relationships in a consistent format. The virtual model structure may represent a data structure dynamically generated to include comparison results of a plurality of artificial intelligence models. The computing device 100 may set a matching manner for determining whether nodes of a plurality of models are identical to each other in a process of comparison. The matching manner may include a manner of comparing based on a unique identifier (ID) of each node, and comparing based on a name or an operator type of a node may also be possible according to an implementation aspect. The computing device 100 may identify an added node through traversal of the second artificial intelligence model, identify a deleted node through traversal of the first artificial intelligence model, reconfigure a connection relationship accordingly, and perform layout adjustment and visual comparison rendering based on such reconfiguration. For example, to implement comparison rendering for the first artificial intelligence model and the second artificial intelligence model, the computing device 100 may perform a first comparison step of determining whether a corresponding node exists in the first artificial intelligence model for each of nodes of the second artificial intelligence model by traversing nodes of the second artificial intelligence model. Then, the computing device 100 may add a common node, for which a corresponding node of the first artificial intelligence model exists among nodes of the second artificial intelligence model, to the virtual model structure based on a result of the first comparison step, and add a second differential node, for which a corresponding node of the first artificial intelligence model does not exist among nodes of the second artificial intelligence model, with a second visual attribute to the virtual model structure. Then, the computing device 100 may perform a second comparison step of identifying a first differential node, for which a corresponding node does not exist in the second artificial intelligence model among nodes of the first artificial intelligence model, by traversing nodes of the first artificial intelligence model. Then, the computing device 100 may identify a neighbor common node connected to an output of the identified first differential node in the first artificial intelligence model, add the first differential node with a first visual attribute to a location adjacent to the neighbor common node in the virtual model structure so as to maintain a connection relationship of the first topology, and generate a differential edge connecting the first differential node and the neighbor common node in the virtual model structure. Then, the computing device 100 may render the first topology and the second topology to be visually comparable on the user interface based on a completed virtual model structure. Additional examples for this embodiment will be described later in FIGS. 23 and 24.

In an embodiment, when a user change input for a specific node of one model is applied in a state where a plurality of topologies corresponding to a plurality of models are rendered, the computing device 100 may change a visual attribute of a corresponding node on a topology of another model to which the change input is not applied by reflecting a difference between models. For example, when a user change input deleting a first node of the second artificial intelligence model is received in a state where comparison rendering is implemented, the computing device 100 may perform re-rendering applying a visual attribute related to deletion to the first node in the first artificial intelligence model. The computing device 100 transmits change information related to the user change input to the server, and as the change information related to the user change input is transmitted to the server, a changed first artificial intelligence model corresponding to the re-rendered first topology may be generated at a server end.

In an embodiment, the computing device 100 may automatically readjust a layout such that nodes commonly existing in two topologies are arranged at the same (or corresponding) location on a screen. For example, when layouts of Model A and Model A' are aligned and rendered, most nodes may be displayed at corresponding or same locations on the user interface. If one node is added to Model A' compared to Model A, a newly added node is displayed at that location instead of an empty space, so that a technical effect that a user can immediately discover a structural mismatch between models may be achieved.

In an embodiment, the computing device 100 may render views of two topologies to operate in conjunction (e.g. cooperate) with each other, thereby increasing comparison convenience. For example, when a user input scrolling the first topology displayed on the first area is received from a user, the computing device 100 may allow corresponding parts to be displayed on a single screen by scrolling the second topology of the second area together. As another example, when a user selection input clicking a specific node on the first topology is received from a user, the computing device 100 may automatically scroll the second topology to place a node on the second topology corresponding to the selected node of the first topology in a center portion of the second area and highlight it. Through this, a technical effect that a user can easily track and compare states before and after change of a specific node even in a huge model may be achieved.

In an embodiment, the computing device 100 may provide a plurality of view modes for comparable rendering. The computing device 100 may determine a comparison rendering manner for a plurality of topologies based on a view mode according to a user's selection input among a plurality of predetermined view modes. For example, when the view mode is determined as a first view mode (e.g., Parallel View), the computing device 100 may display a deleted first differential node with a first visual attribute (e.g., red) on the first topology, and display an added second differential node with a second visual attribute (e.g., green) on the second topology. The computing device 100 may render two topologies in a parallel structure in this manner. For example, when the view mode is determined as a second view mode (e.g., Derived View), the computing device 100 may render the first topology as it is originally, and integrate and render both first and second differential nodes with respective visual attributes on the second topology. For example, when the view mode is determined as a third view mode (e.g., Aligned View), the computing device 100 may perform rendering in a manner of matching visual layouts by readjusting a node location in at least one topology such that common nodes of two topologies are arranged at locations corresponding to each other. For example, in the third view mode, a rendering manner in which differential nodes are placed on the second topology and layouts of common nodes are matched with each other may be used.

In an embodiment, the computing device 100 may allow interaction on two rendered topologies. For example, when a user input selecting a specific node on the first topology is detected from a user, the computing device 100 may automatically scroll the second topology to display a target node corresponding to the selected node in a center portion of a screen occupied by the second topology.

In an embodiment, the computing device 100 may quantitatively display a difference between two artificial intelligence models through the user interface. For example, the computing device 100 may display a similarity between the first artificial intelligence model and the second artificial intelligence model, the number of added nodes, and/or the number of deleted nodes in a text form based on a result of comparing node identifiers and edge identifiers of the first artificial intelligence model with node identifiers and edge identifiers of the second artificial intelligence model. For example, the computing device 100 may output identicalness of architectures between two models (identical or non-identical), identicalness of graph structures (identical or non-identical), a value quantitatively representing a similarity of nodes of topologies (e.g., 63.4% identical, etc.), the number of nodes of topology(ies), the number of added nodes, and/or the number of deleted nodes as data of a text form. For example, such data may be output on the user interface in a form of a pop-up window.

FIG. 11 illustrates an exemplary user interface 1100 for comparing a plurality of artificial intelligence models according to an embodiment of the present disclosure.

In order to compare a plurality of artificial intelligence models according to an embodiment of the present disclosure, an initial state of the user interface 1100 for receiving an input of a second artificial intelligence model in a state where a first artificial intelligence model is rendered is exemplarily shown. In this specification, two models are exemplified as targets of comparison rendering, but according to an implementation aspect, comparison rendering for three or more models may also be possible without departing from the scope of the present disclosure.

Referring to FIG. 11, the user interface 1100 may be divided into at least a first area and a second area so that two models can be visually compared. For example, a model comparison mode activation object 1110 for activating a model comparison mode may be displayed on an upper portion of the first area. In response to a user selection input on the model comparison mode activation object 1110, the computing device 100 may divide the user interface 1100 into the first area and the second area. When the user selection input on the model comparison mode activation object 1110 is received, a currently rendered topology may be output on the first area of the user interface 1100, and an input area for allowing an input for a new artificial intelligence model may be additionally displayed on the user interface 1100.

On the first area (left side of the drawing), a first topology 1120 of a graph format of the previously received first artificial intelligence model is rendered and displayed. The second area (right side of the drawing) may represent a space for receiving and rendering the second artificial intelligence model. In an initial creation state of the space, a guide text 1130 guiding to upload a second model to be compared and a model upload button object 1140 allowing a user to select a model file may be displayed on the second area.

Accordingly, the following input operation may be received from the user to visualize the second artificial intelligence model to be compared with the first artificial intelligence model 1120. First, a user input selecting the model upload button object 1140 (Browse model) displayed on the second area may be received from the user. When a model file is selected or input from the user, the computing device 100 (e.g., user terminal) may receive the second artificial intelligence model and generate a second topology representing an abstracted structure of the corresponding model. The computing device 100 may render the generated second topology on the second area instead of the existing guide text 1130 and upload button object 1140.

Through a series of processes described above, the user interface 1100 may switch or transition to a state where two models are visually comparable, by displaying the first topology of the first area and the second topology of the second area in parallel.

FIG. 12 illustrates an exemplary user interface 1200 providing a comparison result of a plurality of artificial intelligence models according to an embodiment of the present disclosure.

FIG. 12 is an exemplary diagram of the user interface 1200 rendering two topologies by comparing them according to an embodiment of the present invention. The user interface 1200 in FIG. 12 exemplarily shows, for example, a manner of displaying differential nodes to be visually distinguishable within a topology and a manner of controlling a scroll operation between two topologies.

Referring to FIG. 12, the user interface 1200 may include a first area 1200a displaying a first topology corresponding to a first artificial intelligence model, and a second area 1200b displaying a second topology corresponding to a second artificial intelligence model. In the example of FIG. 12, a situation where a node 1210a is maintained in the first topology, remaining nodes 1215a, 1220a, 1225a, and 1230a are deleted, and new nodes 1235 are added to the second topology is taken as an example.

The computing device 100 (e.g., user terminal) may identify differential nodes 1235, 1215a, 1215b, 1220a, 1220b, 1225a, 1225b, 1230a, and 1230b representing a structural difference or an attribute difference between two models and common nodes 1210a and 1210b existing in both models by comparing the first topology and the second topology. Thereafter, the computing device 100 may render so that the user can intuitively perceive the difference by applying a predefined visual attribute according to a type of the differential node. In addition, the computing device 100 may assign visual attributes distinguishable from each other to the differential node and the common node.

FIG. 12 shows an example of rendering in a manner of assigning visual attributes to differential nodes only in the second area 1200b among differential nodes and common nodes identified on the first topology and the second topology, and rendering nodes in the first area 1200a while maintaining visual attributes of the first topology as they are. For example, the computing device 100 may assign different visual attributes to deleted differential nodes 1215b, 1220b, 1225b and 1230b and an added differential node 1235 compared to the first topology among differential nodes 1235, 1215b, 1220b, 1225b, and 1230b of the second area 1200b.

In another embodiment, a manner of rendering so that all differential nodes of the first area 1200a and the second area 1200b have visual attributes different from common nodes is also implementable. For example, common nodes 1210a and 1210b (i.e., nodes commonly existing in the first model and the second model) on the first area 1200a and the second area 1200b may be displayed with, for example, a blue visual attribute, differential nodes in the first area 1200a may be displayed with a green or brown visual attribute according to characteristics of the node, deleted nodes among differential nodes in the second area 1200b may be displayed in red, and added nodes among differential nodes in the second area 1200b may be displayed in green.

An embodiment of the present disclosure may provide various scroll operations to increase convenience of a user exploring two topologies. The user interface 1200 may determine whether to perform scrolling of the first area 1200a, perform scrolling of the second area 1200b, or perform synchronized scrolling of the first area 1200a and the second area 1200b based on a start location of a scroll input. The user interface 1200 may set a correlation between the start location of the scroll input and the scroll operation. When the start location of scrolling is included in the first area 1200a, the user's scroll operation may affect the topology of the first area 1200a. When the start location of scrolling is included in the second area 1200b, the user's scroll operation may affect the topology of the second area 1200b. When a start of a scroll input is detected in a third area between the first area 1200a and the second area 1200b, a third scroll operation in which the first topology and the second topology are scrolled together may be performed according to the scroll input. Here, the third area may include any area between the first area 1200a and the second area 1200b. Here, the third area may include a surrounding area of a topology binding selection object 1200c. Through this, a synchronized scroll operation of both the first area 1200a and the second area 1200b may be implemented through a single scroll operation. This may be useful when comparing and exploring the same parts of two models.

In addition, the user interface 1200 may include the topology binding selection object 1200c determining whether to link scroll operations of two topologies. Based on whether the topology binding selection object 1200c is activated, it may be determined whether a synchronized scroll operation is performed or a scroll operation of an individual area is performed. The user may select a scroll manner through the topology binding selection object 1200c. When the topology binding selection object 1200c is selected, the corresponding object may be activated. When the topology binding selection object 1200c is selected again in an activated state, the corresponding object may be switched to a deactivated state. When topology binding is deactivated, or when receiving a scroll start input within the first area 1200a from the user, a first scroll operation scrolling only the first topology may be performed. Similarly, when a scroll input starts within the second area 1200b, a second scroll operation scrolling only the second topology may be performed. When a selection input for the topology binding selection object 1200c is received from the user, a binding scroll operation may be activated. When the topology binding selection object 1200c is activated, the user's scroll input may be recognized as a synchronized scroll operation for both the first area 1200a and the second area 1200b regardless of its start location.

As another embodiment, the user interface 1200 may perform a focusing operation through automatic scrolling. The user interface 1200 may provide a function of automatically adjusting a view of another topology based on a specific node. For example, when a user selection input selecting a specific node (e.g., 1210a) on the first topology is received from the user, the computing device 100 may output a fourth scroll operation automatically scrolling the second topology so that a target node 1210b corresponding to the node in the second topology is displayed at a specific location of the second area 1200b (e.g., a center portion based on a vertical reference of a screen of the second area). In the fourth scroll operation, if a node does not commonly exist in the first area and the second area, the fourth scroll operation may not be performed. This may be effective when quickly comparing before and after change of a specific node in two huge models.

In an additional embodiment, the computing device 100 may also allow a selection input for scrolling moving to a next differential node. For example, the computing device 100 may allow an input for performing scrolling from a previous differential node to a next differential node. The user interface 1200 may provide a user input function capable of sequentially moving between identified differential nodes so as to efficiently and quickly review differences between two models. For example, the user interface 1200 may include a differential node traversal selection object performing functions such as moving to a next differential node or moving to a previous differential node. For example, the user interface 1200 may implement movement between a previous differential node and a next differential node according to a predefined mouse input or a predefined keyboard shortcut for movement between differential nodes. The computing device 100 may detect a list of differential nodes identified in advance in a comparison process between topologies and a location of a node displayed on a current view of the user interface 1200. Based on the user's input of moving between differential nodes, the computing device 100 may determine a differential node of a next or previous order closest to a current location as a target node. The computing device 100 may perform an automatic scroll operation on the topology so that the target node is displayed at a predefined location (e.g., a center portion of a screen on which the topology is rendered). Additionally, as the scroll operation is completed, the computing device 100 may improve user concentration on a scroll movement result on the user interface 1200 by applying a temporary visual attribute (e.g., emphasis highlight display) to the moved target node. Additionally, when a plurality of topologies are set to a mode of synchronized scrolling, if movement between differential nodes is performed in one topology, another topology may also be scrolled together to a corresponding location.

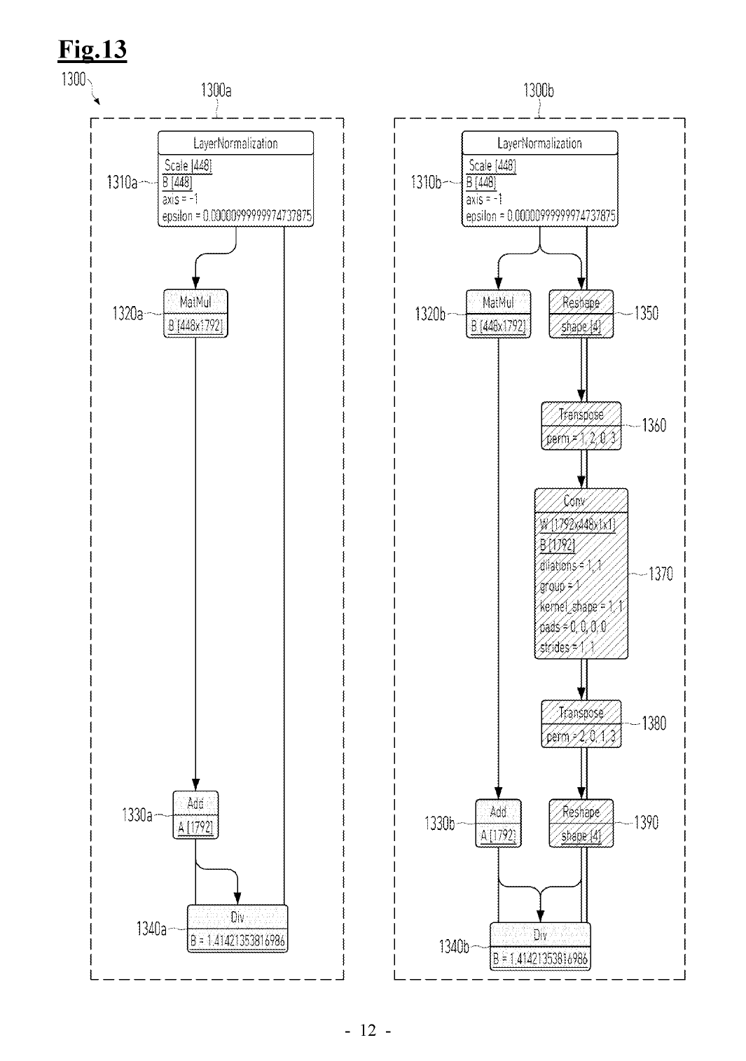

FIG. 13 illustrates an exemplary user interface 1300 providing a comparison result of a plurality of artificial intelligence models according to an embodiment of the present disclosure.

FIG. 13 is an exemplary diagram of the user interface 1300 rendering two topologies by comparing them according to an embodiment of the present disclosure, and particularly illustrates a rendering manner in a Derived View mode, that is, a second view mode.

Referring to FIG. 13, the user interface may include a first area 1300a in which a first topology of a first artificial intelligence model is rendered, and a second area 1300b in which a second topology of a second artificial intelligence model is rendered. This may be useful for intensively displaying changes of a derived model (e.g., the second model) in which a part of a corresponding model is changed based on an original model (e.g., the first model).

Specifically, in the example of FIG. 13, a MatMul node 1320a and an Add node 1330a of the first topology have been replaced with nodes of a complex structure leading to Reshape 1350 - Transpose 1360 - Conv 1370 - Transpose 1380 in the second topology. New nodes of such a replaced structure may be identified as differential nodes (e.g., second differential nodes). In addition, since the MatMul node 1320a and the Add node 1330a of the first topology have been deleted on the second topology, they may be identified as differential nodes (e.g., first differential nodes).

In an embodiment, the first topology displayed on the first area 1300a is rendered as it is to have a structure of the original model, so that it can be used as a clear reference point for comparison between models. On the other hand, the second topology displayed on the second area 1300b may be reconfigured such that identified differential nodes (e.g., added nodes and deleted nodes) are visualized to be integrated based on a comparison result between models.

A node 1310a of the first topology and a node 1310b of the second topology are common nodes representing a LayerNormalization operator. A node 1340a of the first topology and a node 1340b of the second topology are also common nodes representing a Div operator. Since these common nodes exist in both models as a state not changed upon creation of the derived model, they may be rendered with a visual attribute (e.g., the same color) corresponding to the common node.

Except for the common nodes 1310b and 1340b in the second topology, remaining nodes 1320b, 1330b, 1350, 1360, 1370, 1380, and 1390 all correspond to differential nodes. Among them, second differential nodes (added nodes) not existing in the first model but existing in the second model may correspond to reference numerals 1350, 1360, 1370, 1380, and 1390. Such second differential nodes may be rendered by applying a second visual attribute (e.g., green, etc.) indicating addition. Among differential nodes, first differential nodes existing in the first model but not existing in the second model may correspond to reference numerals 1320b and 1330b. Such first differential nodes may be rendered by applying a first visual attribute (e.g., red, etc.) indicating deletion.

In an embodiment of the present disclosure, change results of the first differential nodes (e.g., 1320a and 1330a) considered to be deleted by existing only in the first model may be all integrated and displayed on the second topology 1300b. If a specific node of the first model has been deleted in the second model, the corresponding node may be reconfigured and displayed on the second topology with the first visual attribute (e.g., red) indicating deletion. An embodiment of the present disclosure expresses all change history by concentrating it on the second topology, so that a technical effect that a user can clearly grasp which operators are added, deleted, or replaced based on the original model may be achieved.

According to an implementation aspect, an embodiment reflecting changes in both the first topology and the second topology and an embodiment reflecting changes only in the first topology may also be included within the scope of the present disclosure.

FIG. 14 illustrates an exemplary user interface 1400 in which a sub-node for a node of an artificial intelligence model is displayed according to an embodiment of the present disclosure.

FIG. 14 is an exemplary diagram illustrating a process of displaying sub-nodes constituting a selected node in a step by step manner (1400a, 1400b) in response to a selection input for a specific node on the user interface 1400 according to an embodiment of the present disclosure.

Referring to reference numeral 1400a of FIG. 14, a topology representing an abstracted structure of an artificial intelligence model is rendered on the user interface 1400. This topology includes a plurality of nodes 1410a and 1420a, and some of these nodes may themselves include a plurality of sub-nodes. For example, the node 1420 may be a module type node. In the illustrated example, a resample_p6 node 1420a corresponds to a module node abstracted and displayed at an upper level. In this state, a user can briefly and intuitively grasp an overall structure of the artificial intelligence model.

Reference numeral 1400b exemplarily shows expansion of a node 1420b and re-rendering accordingly. A user selection input selecting one area of a specific module-type node (e.g., resample_p6 node) 1420a within the rendered topology may be received from the user. The user selection input may be, for example, a different type of user selection input from a user selection input related to editing of a node. For example, the user selection input related to editing of a node may be exemplified as a mouse right-click, and the user selection input related to expansion of a node may be exemplified as a mouse left-click. In response to the user input, the computing device 100 (e.g., user terminal) may re-render the topology in a manner of outputting sub-nodes 1430 and 1440 as shown in reference numeral 1400b of FIG. 14. The selected node 1420a is displayed as an expanded node 1420b, and a plurality of sub-nodes 1430 and 1440 constituting the selected node may be displayed together inside the expanded node 1420b. Inside the expanded node 1420b, a conv_2d sub-node 1430 performing a 2D convolution operation and a max_pool_2d sub-node 1440 reducing a size of a feature map may be displayed.

In an embodiment, as shown in reference numeral 1400b, the computing device 100 may perform re-rendering while maintaining an existing connection structure. Upon re-rendering, the sub-nodes 1430 and 1440 may be displayed in a state where an existing connection structure between the selected node 1420a and a neighbor node 1410a is maintained. As a non-limiting example, according to an implementation aspect, an edge previously heading from an efficientnet-lite0 node 1410a to the resample_p6 node 1420a may be reconfigured to be connected from a neighbor node 1410b to a first sub-node (conv_2d, 1430) inside the expanded node 1420b in the re-rendered topology.

Through the user interface 1400 in FIG. 14, a user can first grasp an overall structure of a complex model and then select a specific module of interest to progressively explore a detailed structure in a drill-down manner, so that a technical effect that efficiency and convenience of artificial intelligence model analysis are greatly improved may be achieved.

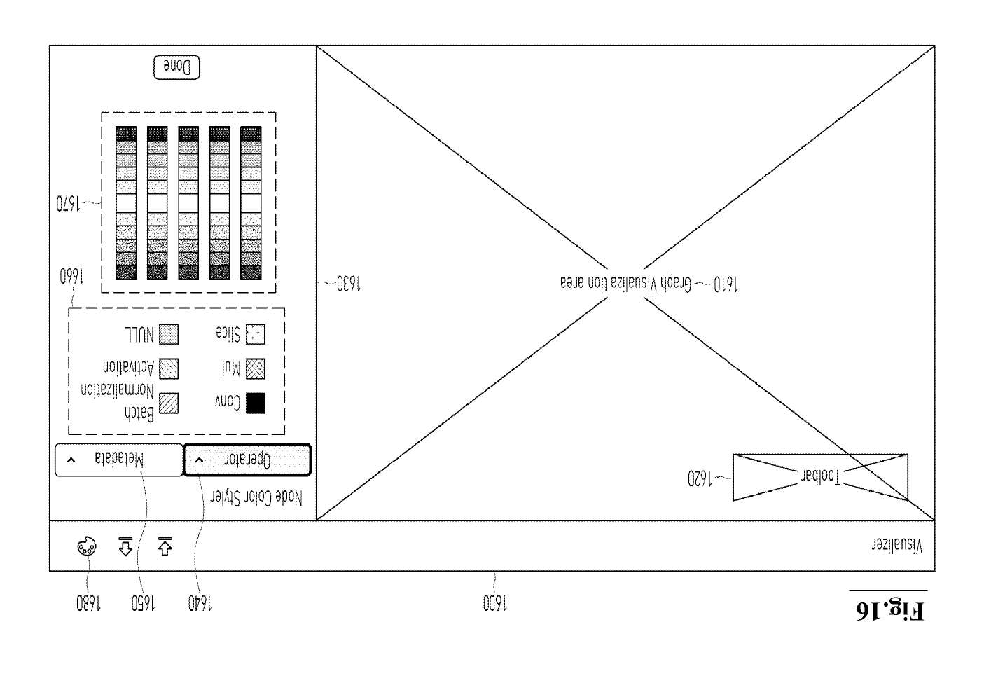

FIG. 15 exemplarily illustrates a user interface 1500 for visualization of an artificial intelligence model according to an embodiment of the present disclosure.

FIG. 15 illustrates a layout output on a single screen of the user interface 1500 according to an embodiment of the present invention. The user interface 1500 in an embodiment may be configured to allow a search function, a topology visualization function, and a detailed information display or editing function to operate in organic conjunction.

Referring to FIG. 15, the user interface 1500 may be divided into at least a first area, a second area, and a third area according to functions.

The first area is a topology visualization area, where a topology 1520 of a graph format of an artificial intelligence model is rendered. This topology 1520 may be composed of nodes representing a structure of the model and edges connecting them.

The second area may include a toolbar object 1501 including a search input object 1505, a display option object 1510, and an exposure option object 1515. The second area may further include a search result display object 1550 displaying a search result when a search input (e.g., Conv) on the search input object 1505 in the toolbar object 1501 is received. For example, the search result display object 1550 may have a layer-type window structure displayed over the first area on the user interface 1500. The search result display object 1550 may include an area listing search results and display objects for filtering or emphasizing specific types of data such as nodes, edges, and weights within the search results. Such a second area may provide an interface for finding or searching for a specific component within the topology. The search input object 1505 may allow a user to input a name or type of a node, edge, or weight that the user wants to find as text. An example of the user interface 1500 shows an example where a search term "Conv" is input. The display option object 1510 may be used to determine a display manner of components within the topology. The display option object 1510 may allow the user to limit and filter display targets to nodes, edges, or weights, etc. For example, the display option object 1510 may receive an input for limiting search results, and display the search results by limiting them according to such an input. For example, the display option object 1510 may allow the user to limit search targets to nodes, edges, or specific types thereof.

The third area may represent a detailed information display and modification area. The third area may display at least one of an attribute and metadata internalized in a node within the topology and allow a modification input for at least one of the attribute and the metadata. The third area may provide an interface displaying detailed information internalized in a node selected by the user within the topology and allowing a modification input therefor. For example, the third area may include an attributes panel 1530. The attributes panel 1530 may display attribute information (e.g., name, layer type, and shape) representing structural features of the selected node. The user may change such attribute values by selecting a modification icon 1560. The third area may include a metadata panel 1540. The metadata panel 1540 may represent additional information (e.g., performance information, quantization information, etc.) of the selected node. The metadata may display, for example, x_scale or x_zero_point which is quantization-related information. The user may change metadata values through a modification icon 1570.

The user interface 1500 according to an embodiment of the present disclosure may provide the enhanced user experience to a user through an integrated operation. Each area of the user interface 1500 may operate in conjunction with each other. For example, the computing device 100 (e.g., user terminal) may receive a search term input such as "Conv" on the search input object 1505 of the second area from the user. The user interface 1500 may list nodes corresponding to the input search term in a search result 1550 area, while displaying corresponding nodes 1510 and 1520 on the topology 1520 of the first area to be visually distinguished from other nodes by applying a predefined visual attribute such as a highlight. When receiving a user selection input selecting a specific item from a list of search results 1550 or directly selecting a highlighted node on the topology 1520 from the user, the computing device 100 may display detailed information on the selected node in the third area 1530 and/or 1540. Specifically, when receiving a user selection input selecting a specific item from a list of search results 1550 or directly selecting a highlighted node on the topology 1520 from the user, attribute values and metadata values of the corresponding node may be loaded and displayed on the attribute panel 1530 and the metadata panel 1540, respectively.

In an additional embodiment, the user interface 1500 may generate different outputs according to a type of user input for components within the topology 1520 within the first area. For example, when the user selection input is a first selection input such as a mouse right-click, a topology change option object may be displayed through the first area on the user interface 1500, and when the user selection input is a second selection input (e.g., mouse left-click), at least one of an attribute and metadata of a node corresponding to the second selection input may be displayed through the third area.

Through such an integrated interworking operation manner between areas within the user interface 1500, a technical effect that efficiency of model analysis and modification work is greatly improved may be achieved as the user can quickly search for a desired node while viewing the overall structure of the model, and immediately check and edit detailed information of the selected node.

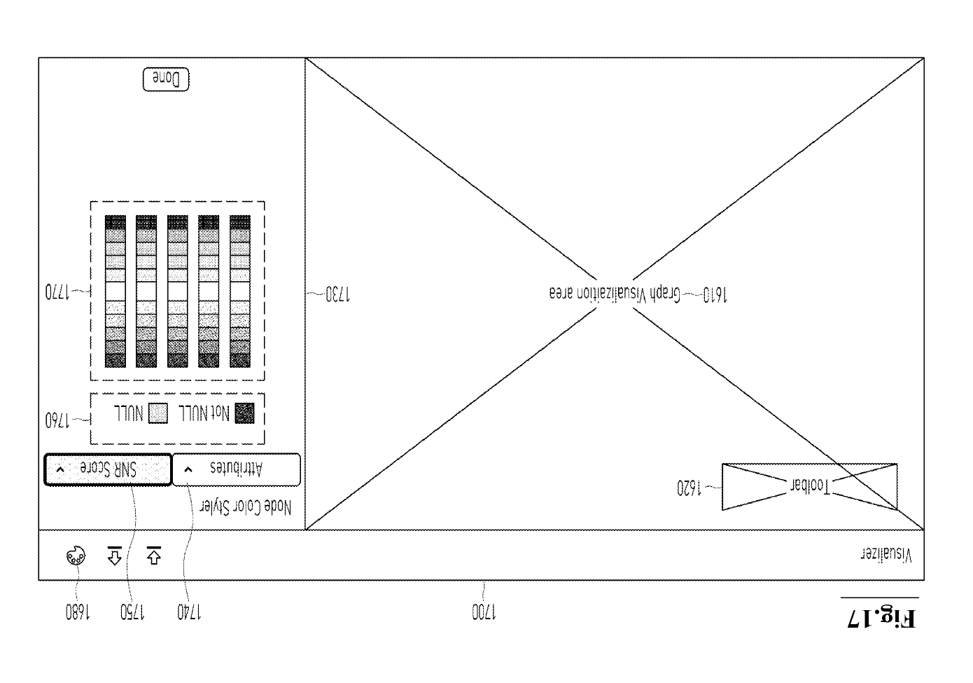

FIG. 16 exemplarily illustrates a user interface 1600 for determining a display manner related to a node of an artificial intelligence model according to an embodiment of the present disclosure.

Referring to FIG. 16, the user interface 1600 may include a graph visualization area 1610 in which a topology of an artificial intelligence model is rendered, and a toolbar object 1620 including various control functions. Here, the toolbar object 1620 may correspond to, for example, the toolbar object 701 of FIG. 7 and/or the toolbar object 1501 in FIG. 15. The user interface 1600 may further include a display manner selection window 1630 (Node Color Styler) for dynamically changing a display manner of nodes within the topology.

When receiving a user input selecting a display manner selection activation object 1680 on the user interface 1600 from a user, the computing device 100 (e.g., user terminal) may generate and output the display manner selection window 1630 as shown on the right side of the drawing. For example, a size of the graph visualization area 1610 may be reduced, and the display manner selection window 1630 may occupy an area corresponding to the reduced amount of the user interface 1600. For example, an embodiment of a manner in which a size of the graph visualization area 1610 is fixed and contents on the display manner selection window 1630 are generated is also possible. The user may select and apply various manners determining display colors of nodes within the topology through the display manner selection window 1630. The display manner selection window 1630 may include display manner selection objects 1640 and 1650 for the user to select a node display manner, a category legend 1660 according to the selected manner, and a color palette 1670 for designating a color.

The display manner selection window 1630 according to an embodiment of the present disclosure may display a major category (or a main category) of attributes (first node display manner) and metadata (second node display manner) to induce user's selection. The display manner selection window 1630 according to an embodiment of the present disclosure may include a first node display manner providing distinction according to structural features of nodes. A display manner selection object 1640 for selecting the first node display manner may be displayed as, for example, an attribute. The first node display manner may refer to a manner of distinguishing and displaying nodes according to structural features of the nodes within the topology. When a user selection input corresponding to an attribute is received on the display manner selection window 1630, the user interface 1600 may output in a manner of listing a number of options related to the attribute. A user input selecting a structural feature such as 'Operator' may be received from the user on such a list. For example, the display manner

selection object 1640 was displayed as an attribute, and in response to a user selection input for the display manner selection object 1640 representing an attribute, sub-objects such as operator type, Precision, Dilations, Kernel shape, Pads, and Strides may be dropped down and displayed in the display manner selection object 1640. In the example in FIG. 16, a result in which the user selects 'attribute' in the display manner selection object 1640 (i.e., an attribute is selected among attribute and metadata on the main classification), and subsequently selects 'operator type' on a middle category related to the attribute is exemplarily shown. For reference, when a display manner selection object 1740 corresponding to 'attribute' is selected and an operator 1640 is selected on an exemplary drawing in FIG. 17, the user interface 1600 as shown in FIG. 16 may be output.

In response to a user input leading to attribute and operator type for the display manner selection object 1640, the computing device 100 may list types of all operators existing in a current topology (e.g., Conv, Mul, Slice, and Batch Normalization, etc.) in a category legend 1660 area. The category legend 1660 may display a result of assigning predefined colors for each of types of operators. A user color selection input selecting each operator type on the category legend 1660 and assigning or changing a desired color using the color palette 1670 may be received from the user. When setting by the user is completed, by combining selection inputs on the color palette 1670 and the category legend 1660, the topology of the graph visualization area 1610 may be updated such that nodes having the same operator type are all rendered in the same color.

The user interface 1600 of the present disclosure may provide a function of grouping nodes within the topology according to structural features such as an operator type and assigning different colors to each through the first node display manner. Such a technical feature may have an effect of enabling a glance at distribution and patterns of major operators in a topology of a complex and huge artificial intelligence model. For example, by setting a Convolution (Conv) layer to purple and an Activation function to yellow, a user can immediately perceive in what pattern convolution operations and activation functions are repeated within the model. This may provide an enhanced user experience in quickly understanding and analyzing an overall architecture design idea of the model.

FIG. 17 exemplarily illustrates a user interface 1700 for determining a display manner related to a node of an artificial intelligence model according to an embodiment of the present disclosure.

The user interface 1700 of FIG. 17 exemplarily shows a display manner selection window 1730, that is, a 'Node Color Styler', which determines a display manner of a node according to or a category or presence or absence of a Metadata value. The display manner selection window 1730 displays major categories of attribute and metadata, thereby allowing a specific selection leading to a major category and a middle category (or minor category) from a user.

The display manner selection window 1730 according to an embodiment of the present disclosure may include a second node display manner providing distinction according to performance of nodes. The second node display manner may refer to a manner of distinguishing and displaying nodes according to performance of the nodes within the topology. The second node display manner may be determined by selecting a display manner selection object 1650 representing metadata in FIG. 16, and when the display manner selection object 1650 corresponding to metadata in FIG. 16 is selected, the computing device 100 may display Latency, SNR score, Target precision, Memory Usage, and Output tensor size in a form of a dropdown in FIG. 17. The user interface 1700 of FIG. 17 exemplarily shows a case where SNR Score 1750 is subsequently selected on a dropped-down list after the display manner selection object 1650 is selected as metadata. As an example, the dropdown manner may refer to a Graphical User Interface (GUI) manner in which a list of hidden sub-menus unfolds in a specific direction (e.g., downwards) in response to interaction of a button click, allowing a user to select desired options. An exemplary UI operation may be performed in a manner that a list of sub-menus thereof is displayed when selecting an attribute object and a metadata object in FIGS. 16 and 17.

In response to a user selection input selecting 'Metadata' in the display manner selection object 1650 from the user, the computing device 100 may activate an additional metadata selection object selecting which performance value to use as a criterion. The user interface 1700 shows an example for a case where specific metadata (e.g., SNR score) to be a criterion of this node performance value or performance change value is selected.

A major category of a display criterion such as 'Attributes' or 'Metadata' may be selected through first mode selection objects 1740 and 1650. Thereafter, after selection of the first mode selection objects 1740 and 1650 is completed, a specific item for determining a color, e.g., 'SNR score' which is a node performance value, may be selected through second mode selection objects 1750 and 1640 corresponding to a middle category or a minor category. The first mode selection objects 1740 and 1650 and corresponding second mode selection objects 1750 and 1640 may represent a hierarchical user input structure used to determine a criterion for display of a topology. When an SNR score is selected, the computing device 100 may determine a display color for a node based on a corresponding node performance value or performance change value internalized in each node. In an embodiment, a determination process of a display color may be performed using a color gradient 1770. That is, the display color may be determined such that the node performance value or performance change value has a positive correlation with saturation or luminance on the color gradient 1770. For example, a node with a high SNR score may be rendered in dark green, and a node with a low SNR score may be rendered in light green. Through this, a user can intuitively grasp a performance level of each node in a model only by a color of the node.

When a user input selecting 'SNR score' is received from the user, the computing device 100 may analyze all nodes within the topology rendered in the graph visualization area 1710 and automatically classify states of values for a corresponding item. In the example of FIG. 17, they are classified into two categories: a node where an 'SNR Score' value exists ('Not NULL') and a node where 'SNR score' value does not exist ('NULL') (1760). These classified categories may be displayed in a category legend 1760 area.

A user input selecting each category (e.g., 'Not NULL') in the category legend 1760 and designating a desired display color (e.g., blue) using the color palette 1770 may be obtained from the user. When color designation for a category is completed, the user can finally apply changes by pressing a 'Done' button.

Upon final application, the topology of the graph visualization area 1710 may be re-rendered according to the determined display manner. For example, all nodes having an SNR score may be displayed with their color changed to blue, and nodes without a corresponding value may be displayed with their color changed to red. Intensity of a blue color may be varied according to a quantitative value of the SNR score internalized in the node (e.g., may be varied to have a positive correlation).

The present disclosure may provide a function of displaying nodes to be distinguishable according to not only static structural features such as an operator type of a node, but also presence or absence (NULL or Not NULL) of a specific metadata value or a category of a specific attribute value. This may lead to a technical effect allowing a user to visually and quickly verify integrity and consistency of data in a model. For example, the computing device 100 immediately identifies a node where an SNR score does not exist (NULL) after a quantization process, so that a part where quantization failed or was omitted can be quickly found, which can be utilized as a powerful anomaly detection means. In addition, the present disclosure may provide a flexible and multilateral analysis environment according to user definition. The display manner selection window of the present disclosure is not limited to a few predefined criteria, but can dynamically analyze all attributes and metadata possessed by a model and use them as criteria for color display. Consequently, the user interface of the present disclosure may have a technical effect of providing a flexible and scalable visualization analysis platform capable of multilateral data analysis according to user needs beyond a standardized viewer.

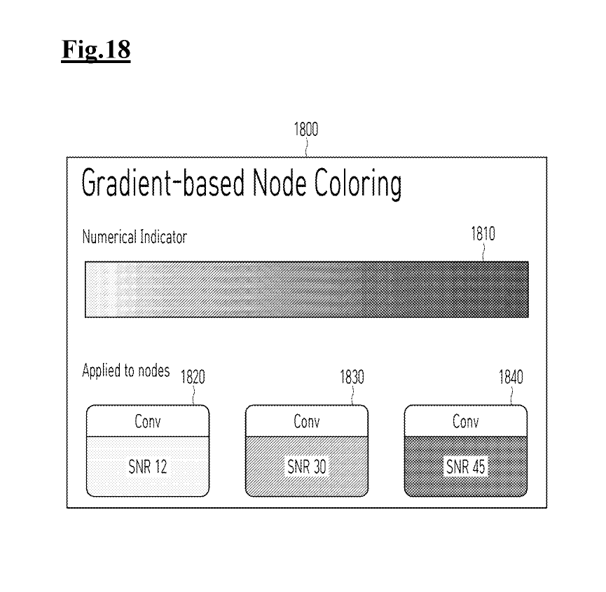

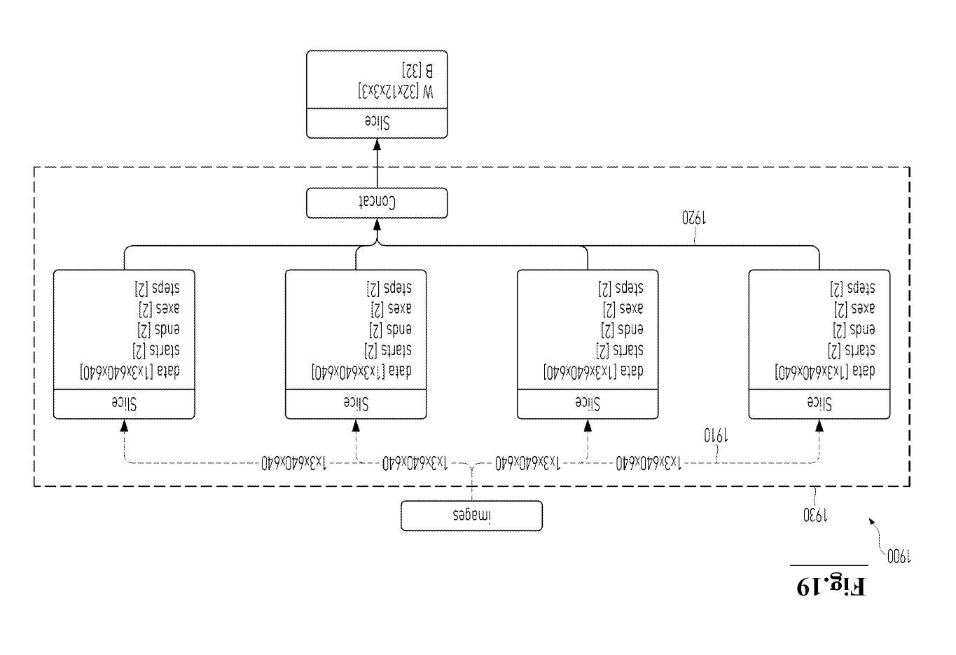

FIG. 18 is a diagram for understanding a color change related to a node of an artificial intelligence model according to an embodiment of the present disclosure.

As a non-limiting example, when selecting one area of the Node Color Styler in FIGS. 16 and 17, a user interface 1800 of FIG. 18 may be output. For example, when an SNR score is selected on the Node Color Styler in FIG. 17, the exemplary user interface 1800 of FIG. 18 may be output.

The computing device 100 (e.g., user terminal) may automatically and dynamically determine colors mapped to nodes of a topology based on a color type of metadata selected in FIG. 17 and a performance value (or performance change value) internalized in a node. A higher SNR score is displayed in a darker color, and through this, performance of nodes within the topology can be visually confirmed.

The computing device 100 may determine a display color of a node based on a performance value internalized in the node. Referring to FIG. 18, a gradient-based node coloring 1800 method may include a color gradient 1810 and a plurality of node objects 1820, 1830, and 1840 to which this gradient is applied.

The color gradient 1810 may refer to a visual display object serving as a criterion for mapping a numerical node performance value to a continuous color change. For example, when a performance value or a performance change value is low, it may be expressed in a light color, and when it is high, it may be expressed in a dark color. The node objects 1820, 1830, and 1840 are objects rendered on a topology, and each node object 1820, 1830, and 1840 may include a node performance value (SNR score in this example) representing its own performance as metadata.

A rendering step according to an embodiment of the present disclosure may determine a display color corresponding to each node based on a performance value internalized in the nodes, and automatically and dynamically render the node in the determined color. At this time, the display color may be determined such that the node performance value and saturation or luminance on the color gradient 1810 have a positive correlation. Since the node 1820 has the lowest SNR score (SNR 12), it may be rendered in a color of the lightest saturation corresponding to a start portion of the color gradient 1810. Since the node 1840 has the highest SNR score (SNR 45), it may be rendered in a color of the darkest saturation corresponding to an end portion of the color gradient 1810. Since the node 1830 has a median value (SNR 30), it may be rendered in a color corresponding to a middle portion of the gradient.

When a user change input is model optimization, the computing device 100 can effectively show a performance change according to optimization. In an embodiment where topologies of a plurality of models are compared and rendered, when node coloring according to reference numeral 1800 is applied, a technical effect that whether a derived model is superior in performance compared to an original model can be intuitively grasped based on a color of a node in units of nodes may be achieved.

Such a rendering manner illustrated in FIG. 18 may have an effect of converting complex numerical data into intuitive visual information that a user can grasp at a glance. A user can immediately perceive which node has high or low optimization quality just by looking at a color of each node, so that performance bottlenecks or problems of an artificial intelligence model can be quickly analyzed.

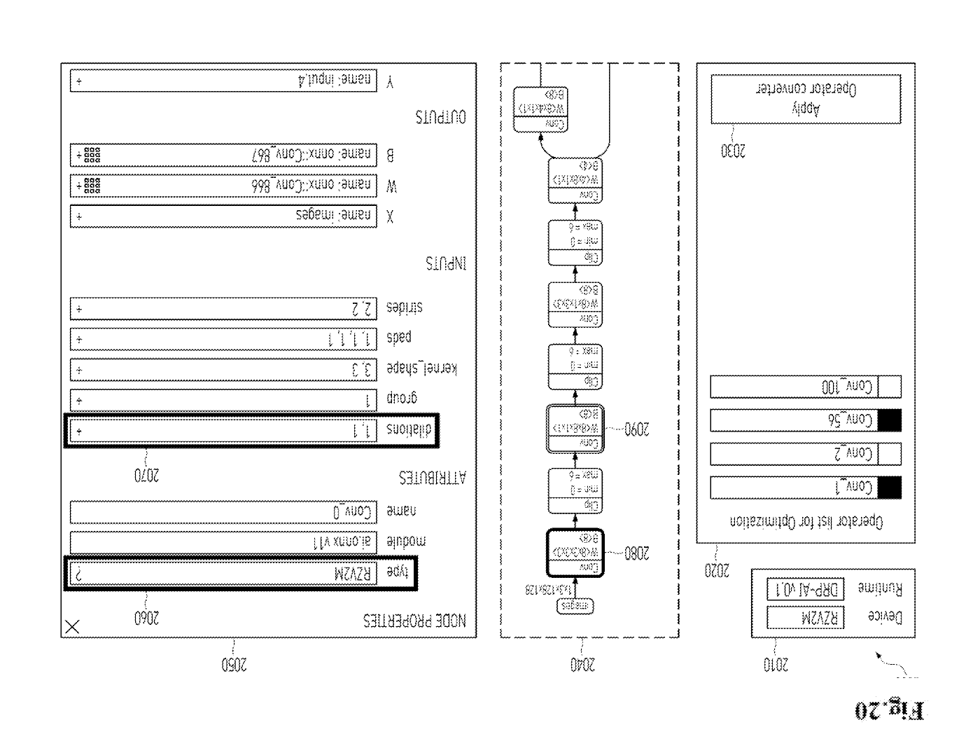

FIG. 19 exemplarily illustrates a user interface 1900 visualizing an artificial intelligence model using layer identification information for nodes of the artificial intelligence model according to an embodiment of the present disclosure.

The user interface 1900 represents a rendering manner that clearly displays a hierarchical relationship of nodes by integrating visual attributes of nodes belonging to the same layer within a rendered topology.

Referring to FIG. 19, a rendered topology 1900 may include a plurality of nodes and edges. In an embodiment, four slice node groups 1930 branched from an 'images' node are shown. For example, a slice operator may perform a function of extracting a specific part of an input tensor. Each of slice nodes of the slice node group 1930 may be rendered to include an indication representing a function or identification information of the node (e.g., Slice) and a display indicating a detailed configuration of the node (data, starts, ends, axes, and steps). These slice nodes may be connected to the images node through an edge 1910 and connected to a Concat node through an edge 1920.

The computing device 100 (e.g., user terminal) may determine a rendering manner based on layer identification information internalized in nodes within the topology. The layer identification information may include a name of a module to which a node belongs, a depth level on a graph, or group information defined by a user, etc. The layer identification information may be information internalized in or mapped to a node. The computing device 100 may analyze layer identification information of each node and determine that all four slice nodes belong to a layer corresponding to each other. Based on this, the computing device 100 may render the topology using the layer identification information to visually and hierarchically integrate nodes or edges.

As shown in FIG. 19, the computing device 100 may render by applying a common visual attribute (e.g., the same red color) to input edges 1910 connected to each of slice nodes belonging to the same layer. The computing device 100 may apply another common visual attribute (e.g., the same gray color and thickness) to output edges 1920 connected to an output of each of slice nodes. Accordingly, input edges 1910 and output edges 1920 can be rendered to be clearly visually distinguished within the node group 1930 belonging to the same layer. According to such a UI manner, layer information of nodes is reflected so that edges related to nodes can be visually integrated. For example, the computing device 100 may display not only colors of edges but also arrow locations and shapes of edges to correspond to each other by reflecting layer information.

In addition, the computing device 100 may implement visual integration of nodes in a topology rendering process. For example, the computing device 100 may render four slice nodes belonging to the same layer to be visually integrated by applying a common visual attribute (e.g.: the same green color) to each of them. For example, the computing device 100 may unify rendering locations of each of four slice nodes belonging to the same layer. For example, the computing device 100 may unify rendering locations of slice nodes belonging to the same layer on the user interface 1900 such that they have corresponding coordinate values on a Y-axis. Layouts of nodes of the same layer may be adjusted to be arranged on the same vertical or horizontal line on a screen to assist visual perception. In an additional embodiment, the computing device 100 may implement topology rendering in a manner of assigning a visual attribute corresponding to slice nodes also to a node (e.g., Concat node) having a hierarchical relationship similar to these slice nodes or a relationship requiring incorporation into the same layer. Like this, topology rendering may be implemented such that a group of nodes belonging to the same layer has a visual attribute distinguished from nodes belonging to other layers and is arranged on corresponding locations.

A technique according to an embodiment of the present disclosure can also visually emphasize readability and understanding of a hierarchical structure of an artificial intelligence model. In a complex artificial intelligence model, especially a model including many parallel structures, a technical effect that a user can grasp an overall architecture and hierarchical structure of the model at a glance by visually grouping and showing nodes and edges belonging to the same layer may be derived. This can assist in intuitively understanding a big picture of a design pattern and data flow of a model without individually analyzing functions of individual nodes.

In addition, the user interface 1900 according to an embodiment of the present disclosure may allow intuitive tracking of data flow. The computing device 100 can clearly visually distinguish which data flows into which hierarchical group by applying a common color or style to edges entering or leaving a specific layer. This allows a user to easily track and analyze a path of data passing through a specific layer among intricately entangled edges, which can lead to a technical effect of greatly improving efficiency of model debugging and analysis.

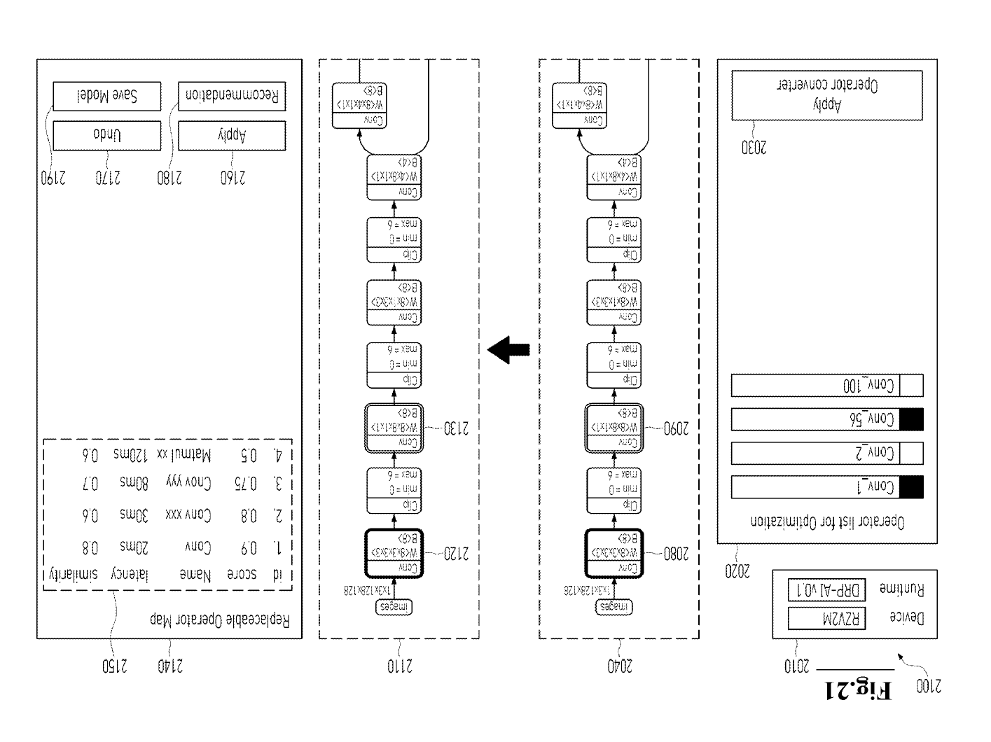

FIG. 20 exemplarily illustrates a user interface 2000 for converting an operator using platform information on which an artificial intelligence model is to be executed according to an embodiment of the present disclosure.

The user interface 2000 may provide an operator converter function optimizing an artificial intelligence model suitable for a specific hardware platform. Referring to FIG. 20, the user interface 2000 may be composed of a platform input area 2010, an operator list area 2020, a topology visualization area 2040, and a node detailed information area 2050. An operator and a node may be used interchangeably.

The computing device 100 may receive platform information on which the artificial intelligence model is to be executed from a user through the platform input area 2010. In the example in FIG. 20, 'RZ/V2M' is selected as a device, and 'DRP-AI v0.1' is selected as a runtime.

In an embodiment, the platform information may include information for identifying hardware, information for identifying a runtime, and/or information for identifying a compiler. The platform information may define an environment in which the artificial intelligence model and/or an optimized (changed) artificial intelligence model is to be executed. The platform information may include at least one of hardware on which the artificial intelligence model is to be executed, a compiler for connecting the artificial intelligence model to the hardware, and a runtime representing an environment of the hardware on which the artificial intelligence model is to be executed. For example, information on hardware included in the platform information 2010 may include information on, for example, a CPU, a GPU, an NPU, and an FPGA, etc. The information on hardware may refer to any form of information identifying hardware on which the artificial intelligence model can be executed. For example, the information on hardware may include information related to physical components of a system and characteristics, structure, performance, and compatibility thereof, etc. For example, the information on hardware may include at least one of identification information of the hardware, supportable framework information, supportable data type information, supportable operator information, or supportable granularity information. As another example, the information on hardware may include a hardware constraint. The hardware constraint may include at least one of whether to support each of data types of an operator, whether to support hardware operation acceleration of an operator, or whether to improve a speed for each of data types of an operator. For example, the data type may be a type of value usable when storing and processing data in hardware or a programming language and a representation method thereof. The data type may be a type of data classified according to a storage and operation method of data. For example, the data type may include an integer type, a floating-point type, a character type, etc. Hardware supports operations for specific data types, and each data type may have different memory size and representation range. For example, information on a compiler included in the platform information may refer to any form of information identifying an entity connecting the artificial intelligence model and the hardware. For example, a platform may be identified and/or managed in units of a combination of hardware and a compiler. For example, the platform may be identified and/or managed in units of a combination of hardware and a compiler within the computing device 100, and information on a related platform may be extracted or generated by the computing device 100 as the platform information is received.

When receiving the platform information, the computing device 100 may generate a list of nodes (e.g., operators) requiring optimization or converting on a rendered topology and display it through the operator list area 2020. The computing device 100 may perform re-rendering of the topology in a manner of assigning a distinguishable visual attribute to a node requiring optimization or conversion on the rendered topology while outputting the operator list.

When receiving the platform information, the computing device 100 may generate a list of nodes (e.g., operators) requiring optimization or converting in a process of rendering the topology and display it through the operator list area 2020. A distinguishable visual attribute may be given to a node requiring optimization or conversion in a topology rendering process. Nodes within the topology may be displayed with a distinguishable visual attribute (e.g., color) according to an analysis result.

In an embodiment, the operator list area 2020 may display a node selected by the user on the topology visualization area 2040. For example, when the user selects a specific node on the topology, the selected node may be added on the operator list area 2020, and the added node may also be displayed on the operator list area 2020 in a form inheriting a visual attribute of the node on the topology.

In an additional embodiment, the operator list area 2020 may be displayed to automatically include an unsupported node 2080 and an inefficient node 2090 displayed on the topology visualization area 2040.

The computing device 100 may implement visual linkage between the topology visualization area 2040 and the operator list area 2020 by unifying (e.g., red highlight) a visual attribute of the unsupported node 2080 among nodes within the topology visualization area 2040 and a visual attribute of an unsupported operator (Conv1, conv56, etc.) within the operator list area 2020. The computing device 100 may implement visual linkage between the topology visualization area 2040 and the operator list area 2020 by unifying (e.g., yellow) a visual attribute of the inefficient node 2090 among nodes within the topology visualization area 2040 and a visual attribute of an inefficient operator (Conv2, conv100, etc.) within the operator list area 2020.

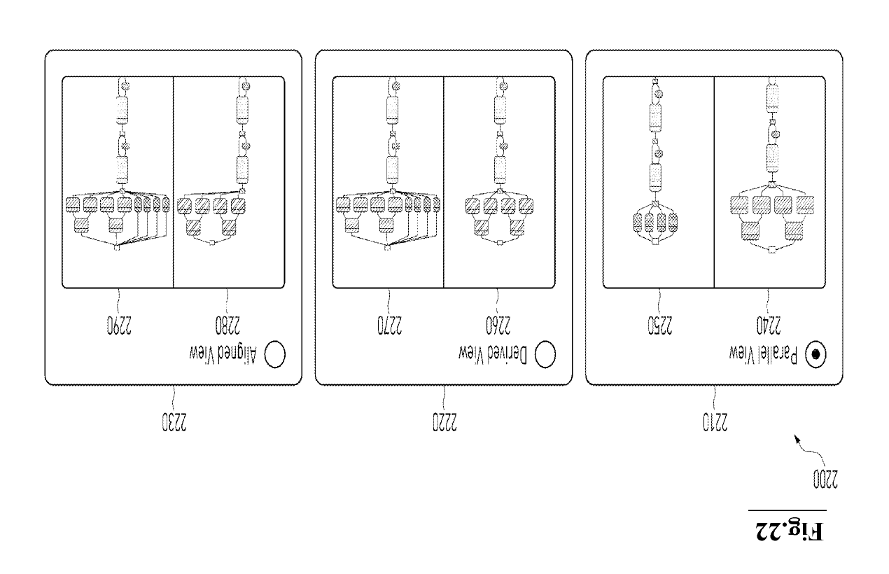

An optimization apply button 2030 may be displayed on the operator list area 2020 of the user interface 2000. As an example, when the optimization apply button 2030 is selected, the computing device 100 may output a list of candidate nodes representing replaceable nodes (operators) for a selected node (operator). The list of candidate nodes may include replaceable candidate nodes recommended to replace the unsupported node object or the inefficient node object. A detailed description of the list of candidate nodes will be described later in FIG. 21. For reference, a node in this specification may be used as an expression for encompassing an operation unit, an operator, or a layer of a model.

As another example, the optimization apply button 2030 may refer to a button for finally applying model conversion according to user interaction on the user interface 2000 to the model. When the optimization apply button 2030 is selected, the computing device 100 (e.g., user terminal) may transmit information for operator converting to the server, and converting of the artificial intelligence model may be performed by the server. The converted artificial intelligence model is received from the server to the computing device 100, and the computing device 100 may re-render the converted artificial intelligence model on the user interface 2000.

Like this, the user interface 2000 according to an embodiment of the present disclosure can operate in conjunction with optimization tools (e.g., converter, compressor, quantizer, and/or graph optimizer) of the artificial intelligence model in a backend, and accordingly, a technical effect that optimization, compatibility, and efficiency of the artificial intelligence model can be more easily achieved through visual interaction on the user interface 2000 may be secured.

The topology visualization area 2040 is an area where a topology of a graph format of the artificial intelligence model is rendered. Each of nodes within the topology visualization area 2040 may be distinguishably displayed with different visual attributes according to compatibility and efficiency in a target platform (e.g., the platform input in 2010). An unsupported node object 2080 not supported by target hardware may be rendered with a first visual attribute (e.g., red), and an inefficient node object 2090 supported by hardware but causing performance degradation when executed may be rendered with a second visual attribute (e.g., yellow). A normal node having no problem may be rendered with a third visual attribute (e.g., blue).

The node detailed information area 2050 may refer to an area displaying detailed information of a specific node when the user selects the corresponding node in the topology. This area may provide information by dividing it into node properties and attributes. Additionally, the node detailed information area 2050 may also include information on an input and information on an output of the node.

Node properties refers to upper-level information representing identity and affiliation of a node. For example, an operator type (type: Conv) of a node, an affiliated module (module: ai.onnx.v11), and a unique name (name: Conv_0), etc. correspond to this. node properties may be expressed as fixed information related to attributes of a node. Attributes refers to parameters defining a specific operation manner of a node operation. For example, a kernel size (kernel_shape), strides, and pads values, etc. of a Conv operator correspond to this. Attributes may be expressed as variable information related to attributes of a node.

In an embodiment, the computing device 100 may implement linkage between the node detailed information area 2050 and the topology visualization area 2040. Through such linkage, the topology visualization area 2040, the node detailed information area 2050, and the operator list area 2020 may be visually linked and unified. For example, when receiving a user input selecting the unsupported node 2080 on the topology visualization area 2040 from the user, the computing device 100 may visually display a cause determined as the unsupported node 2080. For example, the computing device 100 may determine a first cause element 2060 (e.g., Type (conv)) and a second cause element 2070 (e.g., Dilation (1, 1)) on the node detailed information area 2050 as causes determined as unsupported node, and assign a visual attribute (e.g., red highlight) corresponding to the visual attribute of the unsupported node to these elements 2060 and 2070. A cause of an inefficient node can also be visualized through the same manner as above. Through this, the user interface 2000 can intuitively present what is a node not supported by hardware, what is a node causing inefficiency in hardware on the artificial intelligence model, and which information among detailed information of the node causes such non-support and/or inefficiency.

In an additional embodiment, the computing device 100 may display an unsupported cause element for the unsupported node 2080 and an inefficient cause element for the inefficient node 2090 with distinguishable visual attributes on the node detailed information area 2050.

In an embodiment, when the user provides user input information identifying a platform on which the artificial intelligence model is to be executed in the platform input area 2010, the computing device 100 automatically analyzes node objects included in the topology 2040. Such analysis may be implemented through communication with the server or may be performed through an algorithm inside the computing device 100. According to an analysis result, the computing device 100 may classify each node into an unsupported node object 2080, an inefficient node object 2090, or a normal node. The computing device 100 may re-render the topology by assigning different visual attributes to each of the classified nodes, and re-render operators on the operator list area 2020 using visual attributes linked with a re-rendering manner of the topology. In addition, when receiving a user input selecting the unsupported node 2080 or the inefficient node 2090 through the user interface 2000, the computing device 100 may display a problem regarding the selected node through the node detailed information area 2050.

The user interface 2000 according to an embodiment of the present disclosure clearly distinguishes and displays unsupported/inefficient nodes by color on a model topology, thereby providing a technical effect of intuitively identifying which operator causes a problem in specific hardware. This may provide an effect of quickly finding a point requiring optimization without a complex profiling process for the artificial intelligence model.

FIG. 21 exemplarily illustrates a user interface 2100 for converting an operator using platform information on which an artificial intelligence model is to be executed according to an embodiment of the present disclosure.

In an embodiment, the user interface 2100 may be a user interface output in response to a user input requesting converting on the user interface 2000 in FIG. 20. For example, the user interface 2100 may be output according to a selection input for nodes desired to be converted and a selection input for the optimization apply button 2030 on the user interface 2000. The user interface 2100 may be used to replace an unsupported or inefficient node in an efficient manner to implement an operator converter function.

Referring to FIG. 21, the user interface 2100 includes a platform input area 2010, an optimization target operator list 2020, and an optimization apply button 2030, etc. In an embodiment, when the user selects nodes desired to be converted on the topology and selects the optimization apply button 2030, the computing device 100 may automatically output a list of candidate nodes 2140 (Replaceable operator map) recommended to replace the selected nodes. In this specification, the list of candidate nodes and the replaceable operator map may be used interchangeably with each other. The list of recommended replaceable candidate nodes 2140 may display identification information of each of candidate nodes, a similarity with an original node, and/or performance information (e.g., latency) of a candidate node (2150). Information 2150 within the list of candidate nodes 2140 may be displayed in a table form. For example, score represents a recommendation score calculated by synthesizing speed, accuracy similarity, etc., Name represents an operator name of a candidate node, latency represents expected performance information (e.g., delay time) when applying a corresponding candidate node, and similarity may represent a quantitative value representing functional similarity with an original node.

In an embodiment, performance information of a candidate node may be displayed to have different visual attributes according to a comparison result between performance of a node before replacement and performance of the candidate node. For example, when performance of the candidate node is lower than performance of the node before replacement or an increase in performance is less than a first threshold, the performance of the candidate node may be displayed in red. For example, when performance of the candidate node is higher than performance of the node before replacement but an increase in performance is less than a second threshold, the performance of the candidate node may be displayed in yellow. For example, when performance of the candidate node is higher than performance of the node before replacement by a second threshold or more, the performance of the candidate node may be displayed in green.

When receiving a user input selecting the unsupported node 2080 or the inefficient node 2090 through the user interface 2000, an embodiment in which the computing device 100 displays a list of replaceable candidate nodes recommended to replace a corresponding node is also implementable.

Information on the list of candidate nodes 2140 may be obtained in the computing device 100 (e.g., user terminal) through communication between the computing device 100 and the server.

When receiving an input determining a specific replacement node (e.g., an input selecting an Apply object 2160) in the list of candidate nodes 2140 from the user, the user interface 2100 may re-render a topology in which the unsupported node and/or the inefficient node is changed to the selected replacement node. Along with this, the computing device 100 may transmit related change information to the server, so that a process of converting the changed artificial intelligence model may be performed in the background. For example, the computing device 100 may receive a converting result from the server after re-rendering the changed topology. If the converting result is converting failure, the computing device 100 may roll back a re-rendered result. If the converting result is converting success, the computing device 100 may use the re-rendered result as it is or add node details (attribute, metadata, etc.) according to converting to the re-rendered result on the user interface 2100.

As a result of re-rendering, the computing device 100 may display a topology before converting 2040 and a topology after converting 2110 in a comparable manner. The computing device 100 may display the rendered topology before converting 2040 and the re-rendered topology 2110 according to execution of converting (or expected according to execution of converting) on a single screen. That is, an original topology 2040 before conversion and a topology 2110 after conversion re-rendered as a node is replaced according to user's selection may be shown. In a comparable rendering process, the computing device 100 may implement efficient comparison for two rendering results by unifying arrangement locations of nodes (e.g., unifying based on a X or Y-axis).

A converted node 2120 is a node in which an existing unsupported node 2080 is converted into an efficient node supportable on a target platform 2010 in the topology after conversion 2110, and may be rendered to have a visual attribute distinguishable from a node before conversion 2080 and an unconverted node 2130. The unconverted node 2130 represents another inefficient node to which conversion is not yet applied, and may be rendered to have the same visual attribute as a node 2090 of the topology before conversion 2040.

The user interface 2100 may include a plurality of control buttons 2160, 2170, 2180, and 2190. The control button 2160 is an object for receiving an input for requesting converting for a selected candidate node. The control button 2170 is an object for canceling previous conversion. The control button 2180 is an object for receiving an input for automatically converting a candidate node having the highest score. Also the control button 2190 may perform a function of finally saving a model to which changes are applied.

As described above, when the user provides a user input selecting a specific unsupported node object 2080 or inefficient node object 2090 in the topology 2040 or the operator list 2020 (or selects the optimization apply button 2030 thereafter), the computing device 100 may analyze hardware support operators capable of replacing the selected node and display the list of recommended replaceable candidate nodes 2140. For example, information 2150 in the list may be sorted in descending order based on a score value. The user interface 2100 may provide a manual selection mode and an automatic selection mode to the user. Manual selection may be made by directly selecting a desired candidate node on the list of candidate nodes 2140 and then selecting the control button 2160. Automatic selection may be made by selecting the control button 2180, and for example, a topmost candidate node having the highest score is automatically selected, and converting to the corresponding candidate node may be performed.

The user interface 2100 re-renders the topology 2110 in which the unsupported node 2080 is changed to the selected replacement node object 2120. Simultaneously, related change information is transmitted to the server, and a process in which the changed artificial intelligence model is converted at a backend end is performed in parallel. In this example, converting for the unsupported node 2080 is taken as an example, but it will be apparent to those skilled in the art that converting and re-rendering can also be performed in the same manner for the inefficient node 2090.

The user interface 2100 according to an embodiment of the present disclosure may provide a specific solution (list of replaceable candidate nodes) including quantitative data such as score, latency, and similarity, beyond simply notifying a problem. This may lead to a technical effect of inducing a developer to select the most efficient optimization plan based on data without relying on guess or repetitive experiments.

The user interface 2100 according to an embodiment of the present disclosure may achieve optimization workflow automation and time reduction. By providing a function of automatically applying an optimal alternative through the control button 2180, a complex operator conversion process can be simplified and automated. A technique of the present disclosure may achieve a technical effect of drastically reducing time and effort required to port a model to specific hardware as the entire process from analysis, recommendation, application, and final model generation for operators of an artificial intelligence model is performed integrally within one user interface 2100.

In addition, the user interface 2100 according to an embodiment of the present disclosure may secure stability for a generated and converted artificial intelligence model while maintaining functional accuracy. The computing device 100 provides a similarity with an original node together in the list of candidate nodes, thereby assisting a developer to select an optimal alternative by considering a balance between performance (e.g., latency) and functional accuracy (e.g., similarity). This may lead to a technical effect of minimizing a risk of accuracy degradation that may occur after conversion of an artificial intelligence model and securing stability of an optimized model.

Additionally, the user interface 2100 may efficiently identify intuitive optimization bottlenecks. The user interface 2100 clearly distinguishes and displays unsupported nodes and inefficient nodes by color on a model topology, so that a developer can intuitively identify which operator causes a problem in specific hardware. This provides a technical effect of quickly finding a point requiring optimization without a complex profiling process.

In addition, the user interface 2100 may improve an inefficient workflow excessively using computing resources in a modeling process by providing a workflow integrating analysis, modification, and verification. The user interface 2100 may allow a user to integrally perform an entire optimization process from hardware constraint analysis, problem node identification, alternative selection, to final model converting within one UI. This may lead to a technical effect of innovatively improving an existing inefficient workflow that had to work back and forth between fragmented tools.

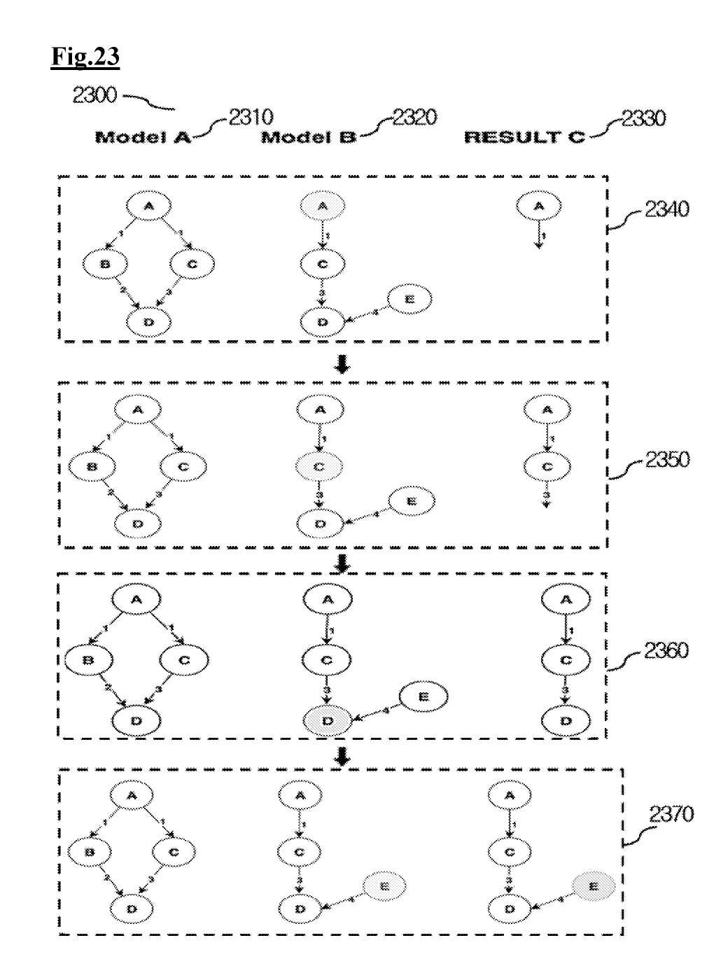

FIG. 22 illustrates an exemplary user interface 2200 rendering topologies in a comparable manner according to a view mode according to an embodiment of the present disclosure.

A user terminal according to an embodiment of the present disclosure may provide a plurality of visualization options (e.g., a plurality of view modes) so that a user can more clearly and efficiently perceive structural differences between two artificial intelligence models. The user can select an optimized view mode according to a similarity or a degree of change between two models, and accordingly, the first topology and the second topology may be comparison-rendered in different manners. Contents overlapping with the above description (e.g., features on visualization of differential nodes, etc.) in a comparison rendering process will be replaced with the above description.

In a process of performing comparison rendering for a plurality of models, the computing device 100 may provide a plurality of view modes to induce selection for a desired comparison rendering manner from a user and vary a comparison rendering manner according to a selected result.

In an embodiment, as shown in reference numeral 2210, the computing device 100 (e.g., user terminal) may implement comparison rendering for a plurality of artificial intelligence models using a parallel view mode 2210. A first view mode 2210 may be particularly useful when a structural difference between two models is large. In the first view mode 2210, a first topology 2240 and a second topology 2250 may be rendered side

by side in independent first and second areas of the user interface 2200, respectively. At this time, only a differential node deleted in the second model 2250 (e.g., derived model) may be displayed with a distinguishable visual attribute (e.g., red highlight) on the first topology 2240 (e.g., original model). Along with this, only a differential node added from the first model 2240 may be displayed with another visual attribute (e.g., green highlight) on the second topology 2250 (e.g., derived model). Through this, the user can clearly compare and analyze in parallel which elements are removed and added from a viewpoint of each model. The first view mode 2210 can clearly separate and show which node is changed from a viewpoint of each model when a structural difference between two models is large.

In an embodiment, as shown in reference numeral 2220, the computing device 100 (e.g., user terminal) may implement comparison rendering for a plurality of artificial intelligence models using a derived view mode 2220. A second view mode 2220 may be useful when a difference between two models is relatively small, such as comparing a derived model in which only a part is modified from an original model. In the second view mode 2220, a first topology 2260 may be rendered as an original structure without any change indication. On the other hand, deleted differential nodes and added differential nodes may be all integrated and rendered to be distinguished from common nodes on a second topology 2270. That is, since all changes between both models are concentrated and expressed on the second topology 2270, the user can track and understand at a glance what changes occurred in a modified model based on an original model.

In an embodiment, as shown in reference numeral 2230, the computing device 100 (e.g., user terminal) may implement comparison rendering for a plurality of artificial intelligence models using an aligned view mode 2230. A third view mode 2230 may be most effective when two models are almost similar but have small structural differences.

When the third view mode 2230 is selected, the computing device 100 (e.g., user terminal) performs a layout alignment algorithm readjusting coordinates on a screen of nodes included in at least one topology so that common nodes commonly existing in a first topology 2280 and a second topology 2290 are arranged at the same or corresponding visual locations (e.g., Y-axis location and/or X-axis location). Additionally, in the third view mode 2230, differential nodes may be displayed on the second topology 2290, and an original model may be rendered as it is on the first topology 2280. When the user selects the third view mode 2230 and a rendering manner is determined as the third view mode 2230, the computing device 100 may perform a step of unifying layouts such that common nodes of two topologies 2280 and 2290 are arranged at locations corresponding to each other. That is, the computing device 100 may align visual layouts of two topologies 2280 and 2290 by readjusting at least one node location and/or edge location of the first topology 2280 and the second topology 2290. Like this, by matching layouts of two topologies 2280 and 2290, the user can minimize eye movement when comparing two models side by side, and immediately discover a minutely added or deleted node between common structures.

Additionally, the computing device 100 may automatically analyze topologies of artificial intelligence models to be targets of comparison and automatically set a relationship between artificial intelligence models. For example, a relationship between models may be determined based on structural similarity between two models, the number of nodes, locations of similar nodes, and/or locations of similar edges. A mapping relationship between a relationship between models and a corresponding view mode may be set. Accordingly, based on the determined relationship, the computing device 100 may automatically perform comparison rendering according to a view mode optimized (mapped) to the determined relationship among a plurality of view modes. Additionally, based on the determined relationship, the computing device 100 may generate and display a UI object recommending a view mode mapped to the determined relationship among a plurality of view modes.

The present disclosure provides various view modes, thereby providing an optimized visual analysis environment according to a user's analysis purpose and a degree of difference between models beyond simple parallel comparison. Since a user can select an appropriate view mode depending on whether a difference between two models is large, small, or minute, a technical effect capable of reducing cognitive burden of the user in a comparison analysis process of models and maximizing efficiency of comparison analysis may be achieved.

FIGS. 23 and FIG. 24 present an exemplary methodology for performing comparison rendering according to an embodiment of the present disclosure.

FIGS. 23 and FIG. 24 illustrate a specific methodology for identifying a differential node and reconfiguring a topology by comparing two artificial intelligence models according to an embodiment of the present invention. Corresponding methodology may include a process of generating a virtual model structure optimized for a comparison purpose by systematically analyzing a structural difference between two models, and comparison-rendering a final topology based on this.

The virtual model structure 2330 in the present disclosure may refer to an integrated temporary data structure (or medium) generated in a process of comparing a first topology 2310 and a second topology 2320. The virtual model structure 2330 refers not to a copy of the first or second topology itself, but to a result of integrating all components identified through each step of a comparison algorithm into a consistent structure reflecting a comparison result. The virtual model structure 2330 may include a common node existing in both topologies, a second differential node identified as added by existing only in the second topology, a first differential node identified as deleted by existing only in the first topology, an edge connecting nodes, and/or a differential edge reconfigured to express a connection relationship before deletion of the first differential node. A completed virtual model structure has information related to a state (e.g., common, added, deleted) for each of nodes, and may perform a role of a direct blueprint for rendering a final comparison visualization result to a user based on this information. Each of nodes within the virtual model structure may include a visual attribute assigned according to a state of the node.

FIG. 23 illustrates a node traversal and matching process 2300 for comparison rendering of the computing device 100. For example, the matching process 2300 of FIG. 23 may include a first comparison step and topology reconfiguration accordingly. As illustrated in FIG. 23, the computing device 100 (e.g., user terminal) may receive a first artificial intelligence model 2310 (Model A) and a second artificial intelligence model 2320 (Model B) and generate a result 2330 (RESULT C) comparing them. The computing device 100 may generate a virtual model structure 2330 containing a result of comparing a first topology 2310 generated from the first artificial intelligence model and a second topology 2320 generated from the second artificial intelligence model. Prior to starting comparison, the computing device 100 may determine a matching manner (e.g.: based on ID, name, or operator type) for determining whether nodes of two models are identical to each other from a user input or based on automatically set information. According to the determined matching manner, the following comparison steps may be performed. A matching process between the first topology 2310 and the second topology 2320 may be performed according to a determined matching manner among a matching manner through an identifier of a node, a matching manner through a name of a node, and a matching manner based on an operator type of a node.

The computing device 100 may perform a first comparison step. An added node on the second topology 2320 may be identified through the first comparison step. The computing device 100 may perform the first comparison step to identify a node existing only in the second artificial intelligence model 2320. Referring to FIG. 23, in the first comparison step, the computing device 100 may traverse nodes included in the second topology 2320 of the second artificial intelligence model. The computing device 100 may traverse nodes according to an order from an input to an output of the second topology 2320. The computing device 100 may perform a matching process of determining whether a node corresponding to the first topology 2310 exists based on a node included in the second topology 2320.

In step 2340, the computing device 100 may identify a node A which is a start node of the second topology 2320 and perform a matching process of determining whether the identified node A exists in the first topology 2310. Since the node A exists in the first topology 2310, it is determined as matched, and the computing device 100 may include the node A in the virtual model structure 2330. According to such a matching process, the node A may be identified as a common node.

In step 2350, since a node C of the second topology 2320 exists in the first topology 2310, the node C may be identified as a common node and added (or updated) to the virtual model structure 2330.

In step 2360, since a node D connected to the node C of the second topology 2320 exists in the first topology 2310, the node D may be identified as a common node and added to the virtual model structure 2330.

On the other hand, in step 2370, since a node E of the second topology 2320 does not exist in the first topology 2310, the node E may be identified as an added node (e.g., a second differential node) as a result of the matching process. The computing device 100 may add the node E to the virtual model structure 2330 together with a second visual attribute (e.g., green highlight) indicating that the node E is a second differential node.

Additionally, when configuring the virtual model structure 2330, an edge identification number identical to an edge identification number of the second topology 2320 may be included in the virtual model structure 2330. Edge identification numbers on topologies 2310 and 2320 and the virtual model structure 2330 may be generated in a manner that the same edge identification number is assigned to an edge output through the same node in FIGS. 23 and 24.

As described above, in a comparison rendering process according to an embodiment of the present disclosure, the computing device 100 may perform a matching process with a node of the first topology 2310 (e.g., original model) by traversing based on a node of the second topology 2320 (e.g., derived model). According to a result of such a matching process, the computing device 100 may add nodes and edges to the virtual model structure 2330 and give visual attributes thereof.

FIG. 24 illustrates a node traversal and matching process 2400 for comparison rendering of the computing device 100. For example, the matching process 2400 may include a second comparison step and topology reconfiguration accordingly.

As illustrated in FIG. 24, the computing device 100 may perform the second comparison step to identify a node existing only in a first topology 2400a, and reconfigure a topology in a manner of reconfiguring a virtual model structure 2400b according to a result of the second comparison step.

The computing device 100 may traverse the first topology 2400a of the first artificial intelligence model. Such traversal may be performed according to a direction from a start node to an end node in the first topology 2400a. In a traversal process of the first topology 2400a, a first differential node existing only in the first topology 2400a and not existing in a second topology may be identified. The second comparison step may be performed through comparison between a node of the first topology 2400a and a node of the virtual model structure 2400b generated in the first comparison step.

In reference numeral 2410, the computing device 100 may identify a node A of the first topology 2400a and perform a matching process with nodes in the virtual model structure 2400b. Since the node A exists in the virtual model structure 2400b, it is determined that the node A is matched, and the computing device 100 may move to a next node in the first topology 2400a. Unlike the first comparison step, the second comparison step may move to the next node of the first topology 2400a without adding a matched node to the virtual model structure 2400b when a node is matched. Therefore, for a common node, no change occurs on the virtual model structure 2400b as shown in reference numeral 2440.

In reference numeral 2420, the computing device 100 may perform a matching process of comparing a node B included in the first topology 2400a and nodes (e.g., nodes A, C, D, and E) stored in the virtual model structure 2400b. As a result of the matching process, since the node B is not included in the virtual model structure 2400b, it may be identified as a first differential node (i.e., a node deleted in the derived model).

In reference numerals 2450, 2470, 2480, 2490, and 2495, the computing device 100 may reconfigure the virtual model structure 2400b to process the node B identified as the first differential node.

The computing device 100 may identify neighbor common node(s) connected to an output of the node B of the first topology 2400a in the virtual model structure 2400b corresponding to reference numeral 2450. In this example, a node corresponding to a node D receiving the output of the node B in the first topology 2400a may be determined within the virtual model structure 2400b. In this example, the node D receiving an output of a node C on the virtual model structure 2400b may be determined as a neighbor common node (2470). Through this process, a node receiving an output of a deleted node may be determined.

In reference numeral 2480, the computing device 100 may generate and add a new edge output to the determined node D on the virtual model structure 2400b together with existing edges (i.e., edge of C-D and edge of E-D) related to the determined node D. Such a new edge may be generated and added based on an edge (edge identification number 2) connected to the node D in the first topology 2400a.

In reference numeral 2490, the computing device 100 may add the deleted node B to the virtual model structure 2400b. For example, the computing device 100 may identify the deleted node B generating the edge identification number 2 from the first topology 2400a and add the identified node B to the virtual model structure 2400b. The node B may be connected to an input part of the new edge generated and added in reference numeral 2480. In this manner, the deleted node may be restored in the virtual model structure 2400b according to the second comparison step.

In reference numeral 2495, the computing device 100 may identify the node A (which was an input of the node B) on the virtual model structure 2400b and restore an edge connecting the node A and the node B on the virtual model structure 2400b to reconfigure a connection relationship before node deletion. For example, the edge between the node A and the node B may be displayed with a visual attribute different from other edges on the virtual model structure 2400b. The edge between the node A and the node B may be classified as a differential edge (i.e., an edge connecting a deleted node) on the virtual model structure 2400b and have a visual attribute different from other edges. As another example, the edge connecting the node A and the node B and an edge connecting the node A and the node C may be edges having the same identification information.

In reference numeral 2430, the computing device 100 traverses a node D which is a next node of the node B, and since the node D exists in the virtual model structure 2400b, it is identified as a common node. Therefore, as in reference numeral 2460, in this case, additional modification is not made to the virtual model structure 2400b.

Then, the computing device 100 identifies the node C of the first topology 2400a, and since the node C exists in the virtual model structure 2400b, it is identified as a common node. Therefore, as in reference numeral 2460, in this case, additional modification is not made to the virtual model structure 2400b.

The second comparison step is performed in the above manner, and reconfiguration of the virtual model structure 2400b may be completed according to a result of the second comparison step. Such a virtual model structure 2400b may be visualized as a second topology 2400b of the second artificial intelligence model to be compared with the first topology 2400a in a comparison rendering process.

As an additional embodiment, it is possible to adjust coordinate values of the virtual model structure 2400b to fit the first topology 2400a of the original model A to facilitate visualization according to comparison rendering.

The present disclosure may have an effect of guaranteeing accuracy of comparison by systematically identifying all added and deleted nodes without omission even in a complex model structure through a two-step traversal and matching algorithm sequentially traversing a first model and a second model. The present disclosure efficiently reconfigures a topology by identifying a neighbor common node and generating a differential edge using a virtual model structure, beyond simply presenting deleted nodes as a list. This enables visualization to be performed in a state in which structural contextual information is preserved, including the original position of a deleted node and how the data flow has been changed as a result thereof.

A final rendering result based on a completed virtual model structure according to an embodiment of the present disclosure can intuitively show all changes (addition, deletion, connection change) of two models in one integrated view. This may have an effect of maximizing debugging efficiency as a developer quickly verifies a result of a model optimization or conversion process and easily discovers unintended structural changes.

In an additional embodiment, a user interface according to an embodiment of the present disclosure may be compatible with a user interface for applying a model optimization tool. For example, an artificial intelligence model may be received on a model optimization user interface, and various experiments or operations related to optimization for the artificial intelligence model may be performed. A first experiment object may be generated as result data of such optimization. For example, a first experiment object representing an artificial intelligence model to which optimization according to a first recipe (e.g., optimization manner) is applied may be generated on the model optimization user interface.

The first experiment object may be received through a user interface according to an embodiment of the present disclosure (e.g., may be received in a manner such as model input). The user interface may render a topology of a model to which a received optimization experiment is applied, and various forms of user interaction may be performed on the rendered topology. An optimization manner of a model (e.g., change, deletion, addition of nodes in a model, change of compression manner of a model, change of quantization value, change of optimization manner, etc.) may be changed according to a user input on the user interface, and such a change may change the first recipe for the first experiment object, and accordingly, a temporary recipe may be generated. Such a temporary recipe may be updated according to an additional user input on the user interface. The temporary recipe may be transmitted to the model optimization user interface.

The model optimization user interface may generate a second experiment object for the artificial intelligence model using the transmitted temporary recipe. The model optimization user interface may apply the temporary recipe to the artificial intelligence model (i.e., applying a model optimization tool corresponding to the temporary recipe) to generate the second experiment object of the artificial intelligence model in which the temporary recipe is reflected.

In the above manner, a user interface according to an embodiment of the present disclosure may operate in conjunction with another user interface allowing various experiments related to optimization of a model. Through such an operation, a technical effect that overall model control from user's model experiment to model internal structure grasp and optimization can be efficiently implemented may be achieved.

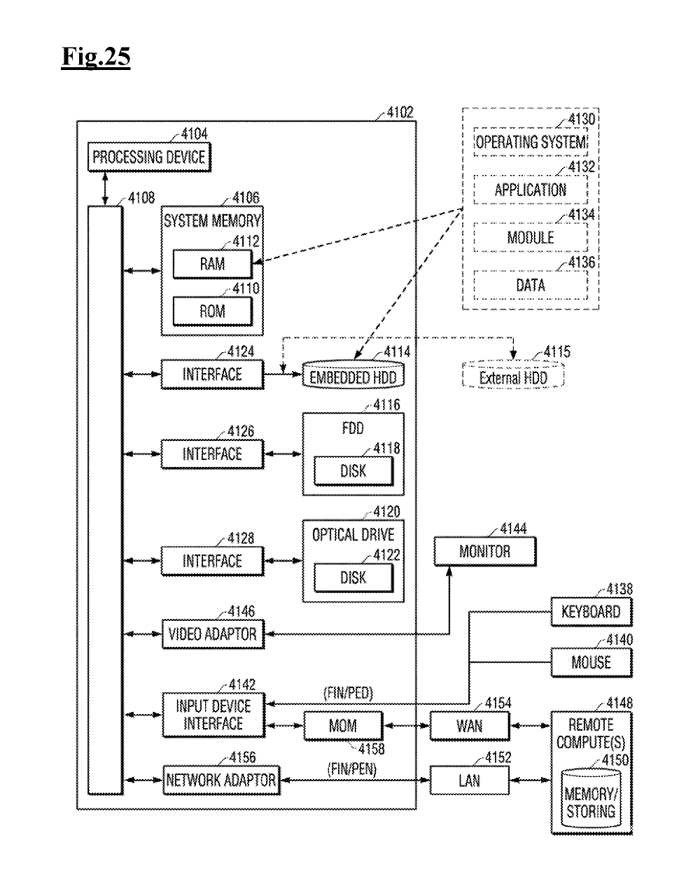

FIG. 25 is a simplified and general schematic diagram of an exemplary computing environment in which embodiments of the present disclosure may be implemented.

Although the present disclosure is generally described above as being implementable by the computing device 100, one of ordinary skill in the art will appreciate that the present disclosure may be implemented in combination with computer-executable instructions that can be executed on one or more computing devices and/or other program modules, and/or as a combination of hardware and software.

Generally, program modules include routines, programs, components, data structures, and the like that perform particular tasks or implement particular abstract data types. Further, it will be well appreciated by those skilled in the art that the methods presented by the present disclosure can be implemented by other computer system configurations including a personal computer, a handheld computing device, microprocessor-based or programmable home appliances, and others (the respective devices may operate in connection with one or more associated devices) as well as a single-processor or multi-processor computer system, a mini computer, and a main frame computer.

The embodiments described in the present disclosure may also be implemented in a distributed computing environment in which predetermined tasks are performed by remote processing devices connected through a communication network. In the distributed computing environment, the program module may be positioned in both local and remote memory storage devices.

The computing device generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

FIG. 25 illustrates an exemplary environment that implements various aspects of the present disclosure including a computer 4102 and the computer 4102 includes a processing device 4104, a system memory 4106, and a system bus 4108. The system bus 4108 connects system components including the system memory 4106 (not limited thereto) to the processing device 4104. The processing device 4104 may be a predetermined processor among various commercial processors. A dual processor and other multi-processor architectures may also be used as the processing device 4104.

The system bus 4108 may be any one of several types of bus structures which may be additionally interconnected to a local bus using any one of a memory bus, a peripheral device bus, and various commercial bus architectures. The system memory 4106 includes a read only memory (ROM) 4110 and a random access memory (RAM) 4112. A basic input/output system (BIOS) is stored in the non-volatile memories 4110 including the ROM, the EPROM, the EEPROM, and the like and the BIOS includes a basic routine that assists in transmitting information among components in the computer 4102 at a time such as in-starting. The RAM 4112 may also include a high-speed RAM including a static RAM for caching data, and the like.

The computer 4102 also includes an internal hard disk drive (HDD) 4114(e.g., EIDE, SATA)—which may alternatively be configured for external use within a suitable chassis (not shown)—a magnetic floppy disk drive (FDD) 4116(e.g., for reading from or writing to a mobile diskette 4118), and an optical disk drive 4120(e.g., for reading from or writing to a CD-ROM disk 4122 or other high-capacity optical media such as a DVD). The computer 4102 may also include an external hard disk drive (HDD) 4114 connected via ports such as USB, Thunderbolt, or eSATA. The hard disk drive 4114, magnetic disk drive 4116, and optical disk drive 4120 can each be connected to the system bus 4108 via a hard disk drive interface 4124, a magnetic disk drive interface 4126, and an optical drive interface 4128, respectively. The interface 4124 for external drive implementations includes at least one of, or both, USB (Universal Serial Bus) and IEEE 1394 interface technologies.

The drives and the computer readable media associated therewith provide non-volatile storage of the data, the data structure, the computer executable instruction, and others. In the case of the computer 4102, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 4130, one or more application programs 4132, other program module 4134, and program data 4136 may be stored in the drive and the RAM 4112. All or some of the operating system, the application, the module, and/or the data may also be cached in the RAM 4112. It will be well appreciated that the present disclosure may be implemented in operating systems which are commercially usable or a combination of the operating systems.

A user may input instructions and information in the computer 4102 through one or more wired/wireless input devices, for example, pointing devices such as a keyboard 4138 and a mouse 4140. Other input devices (not illustrated) may include a microphone, an IR remote controller, a joystick, a game pad, a stylus pen, a touch screen, and others. These and other input devices are often connected to the processing device 4104 through an input device interface 4142 connected to the system bus 4108, but may be connected by other interfaces including a parallel port, an IEEE 1394 serial port, a game port, a USB port, an IR interface, and others.

A monitor 4144 or other types of display devices are also connected to the system bus 4108 through interfaces such as a video adapter 4146, and the like. In addition to the monitor 4144, the computer generally includes a speaker, a printer, and other peripheral output devices (not illustrated).

The computer 4102 may operate in a networked environment by using a logical connection to one or more remote computers including remote computer(s) 4148 through wired and/or wireless communication. The remote computer(s) 4148 may be a workstation, a computing device computer, a router, a personal computer, a portable computer, a micro-processor based entertainment apparatus, a peer device, or other general network nodes and generally includes multiple components or all of the components described with respect to the computer 4102, but only a memory storage device 4150 is illustrated for brief description. The illustrated logical connection includes a wired/wireless connection to a local area network (LAN) 4152 and/or a larger network, for example, a wide area network (WAN) 4154. The LAN and WAN networking environments are general environments in offices and companies and facilitate an enterprise-wide computer network such as Intranet, and all of them may be connected to a worldwide computer network, for example, the Internet.

When the computer 4102 is used in the LAN networking environment, the computer 4102 is connected to a local network 4152 through a wired and/or wireless communication network interface or an adapter 4156. The adapter 4156 may facilitate the wired or wireless communication to the LAN 4152 and the LAN 4152 also includes a wireless access point installed therein in order to communicate with the wireless adapter 4156. When the computer 4102 is used in the WAN networking environment, the computer 4102 may include a modem 4158, is connected to a communication computing device on the WAN 4154, or has other means that configure communication through the WAN 4154 such as the Internet, etc. The modem 4158 which may be an internal or external and wired or wireless device is connected to the system bus 4108 through the serial port interface 4142. In the networked environment, the program modules described with respect to the computer 4102 or some thereof may be stored in the remote memory/storage device 4150. It will be well known that an illustrated network connection is exemplary and other means configuring a communication link among computers may be used.

The computer 4102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example,at a data rate of 11 Mbps (802.11a) or 54 Mbps (802.11b) in unlicensed 2.4 and 5GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

What is claimed is:

1. A method for visualizing an artificial intelligence model, performed by a server, the method comprising:
receiving an artificial intelligence model from a user terminal;
generating an intermediate representation structure by abstracting the artificial intelligence model;
converting the intermediate representation structure into structured text data for visualization of the artificial intelligence model using an attribute value included in the intermediate representation structure; and
transmitting the structured text data to the user terminal so that the user terminal renders a topology of a graph format for the artificial intelligence model.

2. The method of claim 1, wherein the converting the intermediate representation structure into the structured text data includes:
querying attribute values of the intermediate representation structure to extract an input of the artificial intelligence model, an output of the artificial intelligence model, nodes included in the artificial intelligence model, connection information between the nodes, and metadata included in the artificial intelligence model, from the intermediate representation structure; and
generating the structured text data by arranging the extracted information according to a predefined text data structure.

3. The method of claim 1, wherein the generating the intermediate representation structure includes:
generating the intermediate representation structure by abstracting the artificial intelligence model to include framework-independent nodes and tensors representing outputs of the nodes.

4. The method of claim 1, wherein the converting the intermediate representation structure into the structured text data includes:
generating the structured text data by changing a tensor included in the intermediate representation structure into an edge connecting nodes.

5. The method of claim 1, wherein the intermediate representation structure includes framework-independent nodes, a first tensor representing a parameter of the artificial intelligence model, and a second tensor representing an activation value of the nodes, and
the converting the intermediate representation structure into the structured text data includes: creating an edge connecting the nodes using the second tensor and the nodes, and converting the intermediate representation structure into the structured text data using the first tensor, the nodes, and the edge.

6. The method of claim 1, wherein the converting the intermediate representation structure into the structured text data includes:
extracting node identification information, input tensor identification information, output tensor identification information, and operator type information from each of a plurality of nodes by traversing each of the plurality of nodes included in the intermediate representation structure in a direction from an input to an output of the artificial intelligence model; and
generating the structured text data for each of the plurality of nodes by mapping the extracted information with a key of the structured text data using the extracted information as a value.

7. The method of claim 1, wherein the structured text data is reconfigured to be expressed as nodes and edges connecting the nodes, as a first schema of the structured text data is changed to a second schema for graph rendering, and
the topology of the graph format for the artificial intelligence model is rendered based on the reconfigured structured text data.

8. The method of claim 1, wherein the generating the intermediate representation structure includes:
generating a first intermediate representation structure by abstracting the artificial intelligence model; and
generating a second intermediate representation structure by modifying some nodes of the first intermediate representation structure, and
the converting the intermediate representation structure into the structured text data includes:
obtaining a node performance change value for nodes modified in the second intermediate representation structure by performing inference using the first intermediate representation structure and inference using the second intermediate representation structure; and
generating the structured text data including the node performance change value from the first intermediate representation structure or the second intermediate representation structure.

9. The method of claim 1, further comprising:
in response to receiving a change request for the artificial intelligence model from the user terminal, identifying a target of the change request within the artificial intelligence model using information included in the change request among a node identification number, a node name, a node operator type, an edge identification number, and an edge name, and changing the intermediate representation structure of the artificial intelligence model according to the change request;
changing the structured text data based on the changed intermediate representation structure; and
transmitting the changed structured text data to the user terminal.

10. A method for visualizing an artificial intelligence model, performed by a user terminal, the method comprising:
receiving structured text data corresponding to an artificial intelligence model from a server;
extracting nodes and edges from the structured text data;
reconfiguring the structured text data by changing a first schema of the structured text data into a second schema for graph rendering using the nodes and the edges; and
rendering a topology of a graph format for the artificial intelligence model using the reconfigured structured text data.

11. The method of claim 10, further comprising:
in response to receiving a user input including a change request for the rendered topology, re-rendering a changed topology corresponding to the change request without waiting for a response related to the change request from the server; and
in response to receiving a change failure response from the server, rolling back the changed topology to a topology before the change.

12. The method of claim 10, further comprising:
in response to receiving a user input including a change request for the rendered topology, re-rendering a changed topology corresponding to the change request without waiting for a response related to the change request from the server; and
when receiving a change success response from the server, integrating metadata and a tensor included in changed structured text data into at least one of a node and an edge of the re-rendered changed topology using the changed structured text data included in the change success response.

13. The method of claim 10, further comprising:
in response to receiving a user input including a change request for the rendered topology, transmitting change information related to the change request to the server and re-rendering a changed topology corresponding to the change request without waiting for a response related to the change request from the server, and
wherein a changed artificial intelligence model corresponding to the re-rendered topology is generated, as the change information related to the change request is transmitted to the server.

14. The method of claim 10, wherein the reconfiguring the structured text data includes:
converting the first schema including nodes, edges, tensors, and metadata arranged separately into the second schema expressed by nodes and edges, by integrating tensors and metadata in the structured text data into at least one of nodes and edges.

15. The method of claim 10, wherein the receiving the structured text data includes receiving first structured text data corresponding to a first artificial intelligence model and second structured text data corresponding to a second artificial intelligence model, and
the rendering the topology of the graph format includes:
identifying differential nodes representing a difference between a first topology of the first artificial intelligence model and a second topology of the second artificial intelligence model using identification information of nodes included in each of the first structured text data and the second structured text data; and
re-rendering at least one topology of the first topology and the second topology using the differential nodes, wherein as a predefined visual attribute is applied to the differential nodes, the differential nodes are re-rendered to be visually distinguished from common nodes commonly existing in the first topology and the second topology.

16. The method of claim 10, wherein the rendering the topology of the graph format for the artificial intelligence model includes:
determining a display color corresponding to the node based on a node performance value or a node performance change value internalized in the node within the topology; and
rendering the node within the topology in the determined display color.

17. The method of claim 10, wherein the rendering the topology of the graph format for the artificial intelligence model includes:
rendering the topology such that a first node and a second node are visually integrated by applying a common visual attribute to the first node and the second node belonging to a layer corresponding to each other within the topology based on layer identification information internalized in nodes within the topology; or
rendering the topology such that edges of the first node and the second node are visually integrated by applying a common visual attribute to edges connected to each of the first node and the second node belonging to a layer corresponding to each other within the topology based on layer identification information internalized in nodes within the topology.

18. The method of claim 10, further comprising:
receiving a user input including a change request for the rendered topology;
determining a type of the change request based on the user input; and
determining whether to interact with the server for re-rendering of the topology based on the type of the change request.

19. The method of claim 18, wherein the determining whether to interact with the server includes:
re-rendering a topology in which locations of the node and the edge are changed according to the change request without interaction with the server, when the type of the change request is determined as a first type in which nodes and edges are not changed,
determining transmission information to be transmitted to the server based on an operator corresponding to a node to be created, when the type of the change request is determined as a second type including creation of a node,
transmitting node identification information corresponding to a node to be deleted to the server, when the type of the change request is determined as a third type including deletion of a node, and
transmitting identification information on a start node and an end node corresponding to an edge to be created to the server, when the type of the change request is determined as a fourth type including creation of an edge.

20. A user terminal for visualizing an artificial intelligence model, the user terminal comprising:
at least one processor, wherein the processor performs:
receiving structured text data corresponding to an artificial intelligence model from a server;
extracting nodes and edges from the structured text data;
reconfiguring the structured text data by changing a first schema of the structured text data into a second schema for graph rendering using the nodes and the edges; and
rendering a topology of a graph format for the artificial intelligence model using the reconfigured structured text data.
